(19) United States
(12) Patent Application Publication
(10) Pub. No.: US 2024/0292411 A1
(43) Pub. Date: Aug. 29, 2024

(54) USER EQUIPMENTS, BASE STATIONS AND SIGNALING FOR UPLINK OF NARROW-BAND INTERNET OF THINGS OVER NON-TERRESTRIAL NETWORKS

(71) Applicant: SHARP KABUSHIKI KAISHA, Sakai City, Osaka (JP)

(72) Inventors: KAI YING, Vancouver, WA (US); ZHANPING YIN, Vancouver, WA (US)

(21) Appl. No.: 18/572,731

(22) PCT Filed: Jun. 14, 2022
(86) PCT No.: PCT/JP2022/023767

§ 371 Date: Dec. 20, 2023

Related U.S. Application Data
(60) Provisional application No. 63/217,237, filed on Jun. 30, 2021.

(51) Int. Cl. H04W 72/1268; H04L 1/00; H04L 1/1812; H04W 72/11; H04W 72/232; H04W 84/06

(52) U.S. Cl. CPC H04W 72/1268; H04L 1/0061; H04L 1/1812; H04W 72/11; H04W 72/232; H04W 84/06

(57) ABSTRACT

A user equipment (UE) is described. The UE includes receiving circuitry configured to receive signaling that includes a configuration for an Internet-of-Things (IoT) physical uplink shared channel (PUSCH) in a non-terrestrial network (NTN). The receiving circuitry is also configured to receive signaling that includes first information to indicate whether Hybrid Automatic Repeat Request (HARQ) feedback is disabled for the IoT PUSCH. The receiving circuitry is further configured to receive signaling that comprises second information to indicate a timing offset for the IoT PUSCH. The UE also includes transmitting circuitry configured to transmit the IoT PUSCH based on the configuration and the second information. The UE further includes a processor configured to flush a data buffer of the IoT PUSCH based on the first information.

### TECHNICAL FIELD

The present disclosure relates generally to communication systems. More specifically, the present disclosure relates to user equipments, base stations and signaling for scheduling of Narrow-Band Internet of Things (NB-IoT) over non-terrestrial networks (NTNs).

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a user equipment (UE), comprising: receiving circuitry configured to receive signaling that comprises a configuration for an Internet-of-Things (IoT) physical uplink shared channel (PUSCH) (NB-IoT PUSCH (NPUSCH)) in a non-terrestrial network (NTN); the receiving circuitry configured to receive signaling that comprises first information to indicate whether Hybrid Automatic Repeat Request (HARQ) feedback is disabled for the NB-IoT PUSCH (NPUSCH); the receiving circuitry configured to receive signaling that comprises second information to indicate a timing offset for the NB-IoT PUSCH (NPUSCH); transmitting circuitry configured to transmit the NB-IoT PUSCH (NPUSCH) based on the configuration and the second information; and a processor configured to flush a data buffer of the NB-IoT PUSCH (NPUSCH) based on the first information.

In one example, a base station (gNB), comprising: transmitting circuitry configured to transmit signaling that comprises a configuration for an Internet-of-Things (IoT) physical uplink shared channel (PUSCH) (NB-IoT PUSCH (NPUSCH)) in a non-terrestrial network (NTN); the transmitting circuitry configured to transmit signaling that comprises first information to indicate whether Hybrid Automatic Repeat Request (HARQ) feedback is disabled for the NB-IoT PUSCH (NPUSCH); the transmitting circuitry configured to transmit signaling that comprises second information to indicate a timing offset for the NB-IoT PUSCH (NPUSCH); receiving circuitry configured to receive the NB-IoT PUSCH (NPUSCH) based on the configuration and the second information; and the transmitting circuitry configured not to transmit a scheduling downlink control information (DCI) for a retransmission of the NB-IoT PUSCH (NPUSCH) based on the first information.

In one example, a method by a user equipment (UE), comprising: receiving signaling that comprises a configuration for an Internet-of-Things (IoT) physical uplink shared channel (PUSCH) (NB-IoT PUSCH (NPUSCH)) in a non-terrestrial network (NTN); receiving signaling that comprises first information to indicate whether Hybrid Automatic Repeat Request (HARQ) feedback is disabled for the NB-IoT PUSCH (NPUSCH); receiving signaling that comprises second information to indicate a timing offset for the NB-IoT PUSCH (NPUSCH); transmitting the NB-IoT PUSCH (NPUSCH) based on the configuration and the second information; and flushing a data buffer of the NB-IoT PUSCH (NPUSCH) based on the first information.

### BRIEF DESCRIPTION OF DRAWINGS

FIG. 1 is a block diagram illustrating one implementation of one or more base stations (gNBs) and one or more user equipments (UEs) for scheduling of non-terrestrial networks (NTNs).

FIG. 2 is a diagram illustrating an example of a resource grid for the downlink.

FIG. 3 is a diagram illustrating one example of a resource grid for the uplink.

FIG. 4 shows examples of several numerologies.

FIG. 5 shows examples of subframe structures for the numerologies that are shown in FIG. 4.

FIG. 6 shows examples of slots and sub-slots.

FIG. 7 shows examples of scheduling timelines.

FIG. 8 shows examples of DL control channel monitoring regions.

FIG. 9 shows examples of DL control channel which includes more than one control channel elements.

FIG. 10 shows examples of UL control channel structures.

FIG. 11 is a block diagram illustrating one implementation of a gNB.

FIG. 12 is a block diagram illustrating one implementation of a UE.

FIG. 13 illustrates various components that may be utilized in a UE.

FIG. 14 illustrates various components that may be utilized in a gNB.

FIG. 15 is a block diagram illustrating one implementation of a UE in which systems and methods for resource allocations of enhanced uplink transmissions may be implemented.

FIG. 16 is a block diagram illustrating one implementation of a gNB in which systems and methods for resource allocations of enhanced uplink transmissions may be implemented.

FIG. 17 is a flow diagram illustrating a method by a UE.

FIG. 18 is a flow diagram illustrating a method by gNB.

FIG. 19 is a flow diagram illustrating a method by a UE.

FIG. 20 is a flow diagram illustrating a method by gNB.

FIG. 21 is a block diagram illustrating an example of an NTN with a single satellite (or UAS platform).

FIG. 22 is a block diagram illustrating an example of an NTN with a constellation of satellites (or UAS platforms).

FIG. 23 is a flow diagram illustrating a method for uplink of narrow-band Internet-of-Things (IoT) over NTNs.

FIG. 24 is a flow diagram illustrating a method for uplink of narrow-band Internet-of-Things (IoT) over NTNs.

FIG. 25 is a flow diagram illustrating a method for downlink of narrow-band Internet-of-Things (IoT) over NTNs.

FIG. 26 is a flow diagram illustrating a method for downlink of narrow-band Internet-of-Things (IoT) over NTNs.

### DESCRIPTION OF EMBODIMENTS

A user equipment (UE) is described. The UE includes receiving circuitry configured to receive signaling that includes a configuration for an Internet-of-Things (IoT) physical uplink shared channel (PUSCH) in a non-terrestrial network (NTN). The receiving circuitry is also configured to receive signaling that includes first information to indicate whether Hybrid Automatic Repeat Request (HARQ) feedback is disabled for the IoT PUSCH. The receiving circuitry is further configured to receive signaling that includes second information to indicate a timing offset for the IoT PUSCH. The UE also includes transmitting circuitry configured to transmit the IoT PUSCH based on the configuration and the second information. The UE further includes a processor configured to flush a data buffer of the IoT PUSCH based on the first information.

The receiving circuitry may also be configured to receive a Physical Downlink Control Channel (PDCCH) carrying a downlink control information (DCI) with Cyclic Redundancy Check (CRC) scrambled by a Radio Network Temporary Identifier (RNTI) which is different from a Cell-RNTI (C-RNTI), a Configured Scheduling-RNTI (CS-RNTI), a Semi-Persistent Scheduling C-RNTI (SPS-C-RNTI), a System Information RNTI (SI-RNTI), a Preconfigured Uplink Resource RNTI (PUR-RNTI), a GERAN RNTI (G-RNTI), a Single Cell RNTI (SC-RNTI), a Paging RNTI (P-RNTI), and a Random Access RNTI (RA-RNTI).

A base station (gNB) is also described. The gNB includes transmitting circuitry configured to transmit signaling that includes a configuration for an IoT PUSCH in an NTN. The transmitting circuitry is also configured to transmit signaling that includes first information to indicate whether HARQ feedback is disabled for the IoT PUSCH. The transmitting circuitry is further configured to transmit signaling that includes second information to indicate a timing offset for the IoT PUSCH. The gNB also includes receiving circuitry configured to receive the IoT PUSCH based on the configuration and the second information. The transmitting circuitry is also configured not to transmit a scheduling DCI for a retransmission of the IoT PUSCH based on the first information.

A method by a UE is also described. The method includes receiving signaling that includes a configuration for a IoT PUSCH in a NTN. The method also includes receiving signaling that includes first information to indicate whether HARQ feedback is disabled for the IoT PUSCH. The method further includes receiving signaling that includes second information to indicate a timing offset for the IoT PUSCH. The method additionally includes transmitting the IoT PUSCH based on the configuration and the second information. The method also includes flushing a data buffer of the IoT PUSCH based on the first information.

A method by a gNB is also described. The method includes transmitting signaling that includes a configuration for an IoT PUSCH in a NTN. The method also includes transmitting signaling that includes first information to indicate whether HARQ feedback is disabled for the IoT PUSCH. The method further includes transmitting signaling that includes second information to indicate a timing offset for the IoT PUSCH. The method additionally includes receiving the IoT PUSCH based on the configuration and the second information. The method also includes not transmitting a scheduling DCI for a retransmission of the IoT PUSCH based on the first information.

Another user equipment (UE) is described. The UE includes receiving circuitry configured to receive signaling that includes a configuration for an Internet-of-Things (IoT) physical downlink shared channel (PDSCH) in a non-terrestrial network (NTN). The receiving circuitry is also configured to receive signaling that includes first information to indicate whether Hybrid Automatic Repeat Request (HARQ) feedback is disabled for the IoT PDSCH. The receiving circuitry is further configured to receive signaling that includes second information to indicate a timing offset for the IoT PDSCH and/or corresponding HARQ feedback. The receiving circuitry is also configured to receive the IoT PDSCH based on the configuration/or and the second information. The UE may also include transmitting circuitry configured to transmit the HARQ feedback based on the configuration and the first information and the second information. The UE further includes a processor configured to flush a data buffer of the IoT PDSCH based on the first information.

Another base station (gNB) is also described. The gNB includes transmitting circuitry configured to transmit signaling that includes a configuration for an IoT PDSCH in an NTN. The transmitting circuitry is also configured to transmit signaling that includes first information to indicate whether HARQ feedback is disabled for the IoT PDSCH. The transmitting circuitry is further configured to transmit signaling that includes second information to indicate a timing offset for the IoT PDSCH and/or corresponding HARQ feedback. The transmitting circuitry may be further configured to transmit the IoT PDSCH based on the configuration and/or the second information. The gNB may also include receiving circuitry configured to receive the HARQ feedback based on the configuration and the first information and the second information. The gNB may also include a processor configured to flush a data buffer of the IoT PDSCH based on the first information.

Another method by a UE is also described. The method includes receiving signaling that includes a configuration for a IoT PDSCH in a NTN. The method also includes receiving signaling that includes first information to indicate whether HARQ feedback is disabled for the IoT PDSCH. The method further includes receiving signaling that includes second information to indicate a timing offset for the IoT PDSCH and/or corresponding HARQ feedback. The method additionally includes receiving the IoT PDSCH based on the configuration and/or the second information. The method may further include transmitting the HARQ feedback based on the configuration and the first information and the second information. The method also includes flushing a data buffer of the IoT PDSCH based on the first information.

Another method by a gNB is also described. The method includes transmitting signaling that includes a configuration for an IoT PDSCH in an NTN. The method also includes transmitting signaling that includes first information to indicate whether HARQ feedback is disabled for the IoT PDSCH. The method further includes transmitting signaling that includes second information to indicate a timing offset for the IoT PDSCH and/or corresponding HARQ feedback. The method additionally includes transmitting the IoT PDSCH based on the configuration/or and the second information. The method may also receive the HARQ feedback based on the configuration and the first information and the second information. The method may further include flushing a data buffer of the IoT PDSCH based on the first information.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time, frequency and/or space resources to allow for enhanced mobile broadband (eMBB) communication and ultra-reliable low-latency communication (URLLC) services, as well as massive machine type communication (MMTC) like services. To meet a latency target and high reliability, mini-slot-based repetitions with flexible transmission occasions may be supported. Approaches for applying mini-slot-based repetitions are described herein. A new radio (NR) base station may be referred to as a gNB. A gNB may also be more generally referred to as a base station device.

One important objective of 5G is to enable connected industries. 5G connectivity can serve as a catalyst for the next wave of industrial transformation and digitalization, which improve flexibility, enhance productivity and efficiency, reduce maintenance cost, and improve operational safety. Devices in such environments may include, for example, pressure sensors, humidity sensors, thermometers, motion sensors, accelerometers, actuators, etc. It is desirable to connect these sensors and actuators to 5G networks and core. The massive industrial wireless sensor network (IWSN) use cases and requirements include not only URLLC services with very high requirements, but also relatively low-end services with the requirement of small device form factors, and/or being completely wireless with a battery life of several years. The requirements for these services that are higher than low power wide area (LPWA) (e.g., LTE-MTC and/or Narrowband Internet of Things (LTE-M/NB-IoT)) but lower than URLLC and eMBB.

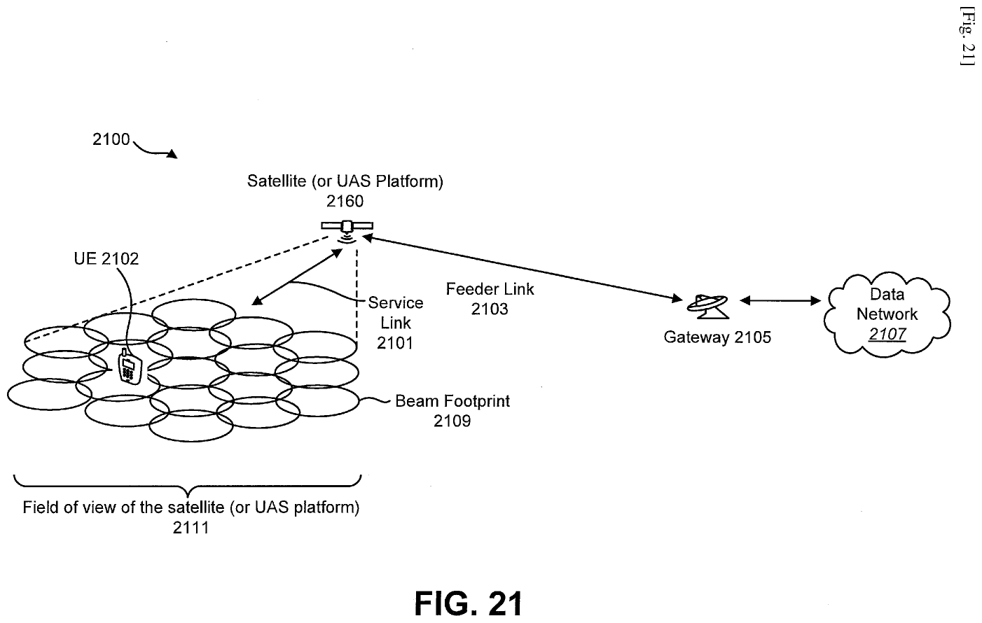

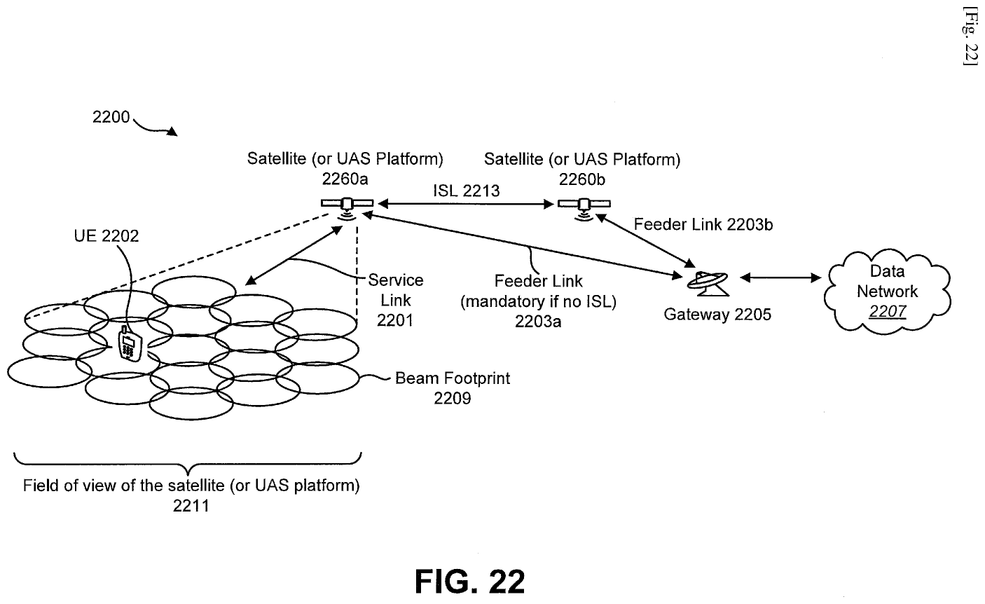

A non-terrestrial network (NTN) refers to a network, or segment of networks using radio frequency (RF) resources onboard a satellite (or UAS platform). The typical scenario of a non-terrestrial network providing access to user equipment is depicted in FIG. 21 and FIG. 22.

Non-Terrestrial Network typically features the following elements: one or several sat-gateways that connect the Non-Terrestrial Network to a public data network. For example, a Geostationary Earth Orbiting (GEO) satellite is fed by one or several sat-gateways which are deployed across the satellite targeted coverage (e.g., regional or even continental coverage). It may be assumed that UE in a cell are served by only one sat-gateway. A Non-GEO satellite served successively by one or several sat-gateways at a time. The system ensures service and feeder link continuity between the successive serving sat-gateways with sufficient time duration to proceed with mobility anchoring and hand-over.

Additionally, Non-Terrestrial Network typically features the following elements: a Feeder link or radio link between a sat-gateway and the satellite (or Unmanned Aircraft System (UAS) platform), a service link or radio link between the user equipment and the satellite (or UAS platform).

Additionally, Non-Terrestrial Network typically features the following elements: a satellite (or UAS platform) which may implement either a transparent or a regenerative (with onboard processing) payload. The satellite (or Unmanned Aircraft System (UAS) platform) may generate several beams over a given service area bounded by its field of view. The footprints of the beams are typically of elliptic shape. The field of view of a satellite (or UAS platform) depends on the onboard antenna diagram and min elevation angle. For a transparent payload, radio frequency filtering, frequency conversion and amplification may be applied. Hence, the waveform signal repeated by the payload is un-changed. For a regenerative payload, radio frequency filtering, frequency conversion and amplification as well as demodulation/decoding, switch and/or routing, coding/modulation may be applied. This is effectively equivalent to having all or part of base station functions (e.g., gNB) onboard the satellite (or UAS platform).

Additionally, Non-Terrestrial Network may optionally feature the following elements: Inter-satellite links (ISL) optionally in case of a constellation of satellites. This will require regenerative payloads onboard the satellites. ISL may operate in RF frequency or optical bands.

Additionally, Non-Terrestrial Network typically features the following elements: User Equipment may be served by the satellite (or UAS platform) within the targeted service area.

There may be different types of satellites (or UAS platforms): Low-Earth Orbit (LEO) satellite, Medium-Earth Orbit (MEO) satellite, Geostationary Earth Orbit (GEO) satellite, UAS platform (including HAPS) and High Elliptical Orbit (HEO) satellite. Detailed descriptions are shown in Table-1.

TABLE 1

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35786 | km | Notional station keeping | 200-3500 | km |
| Orbit (GEO) satellite | | | position fixed in terms of | | |
| UAS platform | 8-50 km (20 km | | elevation/azimuth with | 5-200 | km |
| (including HAPS) | for HAPS) | | respect to a given earth | | |
| | | | point | | |
| High Elliptical Orbit | 400-50000 | km | Elliptical around the earth | 200-3500 | km |

(HEO) satellite

Typically, GEO satellites and UAS are used to provide continental, regional or local service. A constellation of LEO and MEO may be used to provide services in both Northern and Southern hemispheres. In some cases, the constellation can even provide global coverage including polar regions. For the later, this requires appropriate orbit inclination, sufficient beams generated and inter-satellite links.

Non-terrestrial networks may provide access to user equipment in six reference scenarios including: Circular orbiting and notional station keeping platforms, highest round trip delay (RTD) constraint, highest Doppler constraint, a transparent and a regenerative payload, one ISL case and one without ISL (Regenerative payload is mandatory in the case of inter-satellite links), fixed or steerable beams resulting respectively in moving or fixed beam foot print on the ground.

This disclosure considers non-terrestrial networks for IoT service providing access to NB-IoT/eMTC user equipment in reference scenarios including at least: GEO and LEO orbiting scenarios, No inter-satellite link, Transparent payload, Fixed or steerable beams resulting respectively in moving or fixed beam footprint on the ground, Sub 6 GHz bands of interest. IoT NTN scenarios A, B, C and D may be included in the study as shown in Table-2 below:

TABLE 2

| NTN Configurations | Transparent satellite |
|---|---|
| GEO based non-terrestrial access network | Scenario A |
| LEO based non-terrestrial access network | Scenario B |
| generating steerable beams (altitude 1200 km and | |
| 600 km) | |
| LEO based non-terrestrial access network | Scenario C |
| generating fixed beams whose footprints move with | |
| the satellite (altitude 1200 km and 600 km) | |
| MEO based non-terrestrial access network | Scenario D |
| generating fixed beams whose footprints move with | |
| the satellite (altitude 10000 km) | |

IoT NTN connectivity via EPC may be supported. Alternatively or additionally, IoT NTN connectivity via 5GC may be supported.

GNSS capability in the UE may or may not be supported for both NB-IoT and eMTC devices. Simultaneous GNSS and NTN NB-IoT/eMTC operation may or may not be assumed. All cellular IoT features specified up to Rel-16 may be supported for IoT NTN. Both NB-IoT multi-carrier operation and NB-IoT single-carrier operation may supported for IoT NTN.

This disclosure introduces examples of a UE feature and parameter list with NTN support to serve the use cases mentioned above.

Some configurations of the systems and methods described herein teach approaches for NTN transmission and/or retransmission management to meet the constraints and requirements mentioned above.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

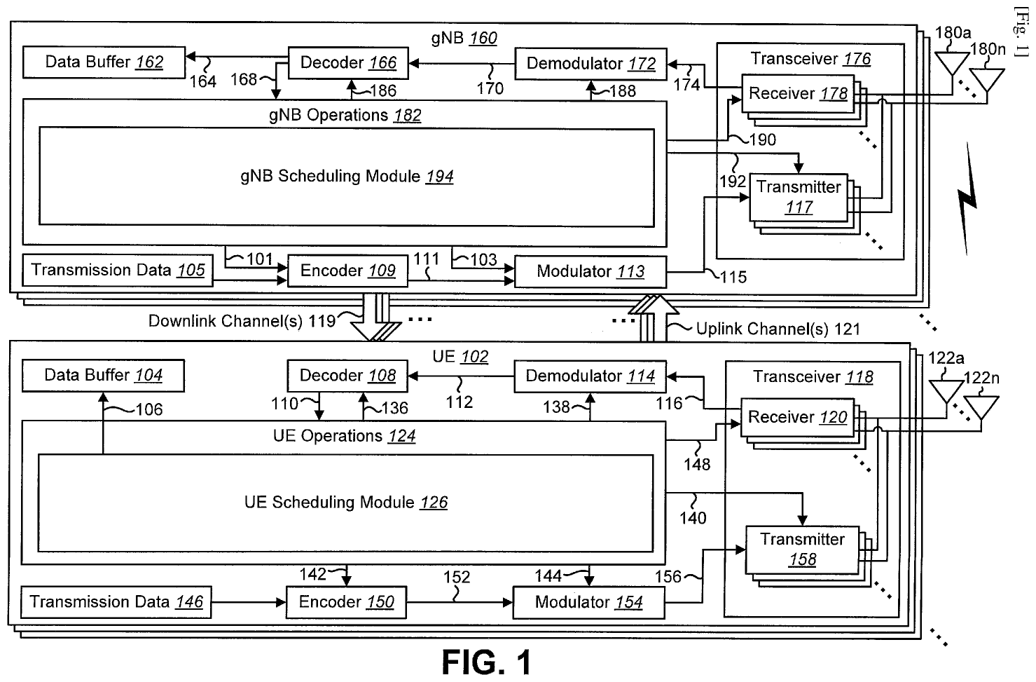

FIG. 1 is a block diagram illustrating one implementation of one or more base stations (gNBs) 160 and one or more user equipments (UEs) 102 for support of non-terrestrial networks (NTNs). The one or more UEs 102 communicate with one or more gNBs 160 using one or more antennas 122a-n. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

The UE 102 and the gNB 160 may use one or more channels 119, 121 to communicate with each other. For example, a UE 102 may transmit information or data to the gNB 160 using one or more uplink channels 121. Examples of uplink channels 121 include a PUCCH (Physical Uplink Control Channel) and a PUSCH (Physical Uplink Shared Channel), PRACH (Physical Random Access Channel), etc. For example, uplink channels 121 (e.g., PUSCH) may be used for transmitting UL data (i.e., Transport Block(s), MAC PDU, and/or UL-SCH (Uplink-Shared Channel)).

In some examples, UL data may include URLLC data. The URLLC data may be UL-SCH data. In some examples, URLLC-PUSCH (i.e., a different Physical Uplink Shared Channel from PUSCH) may be defined for transmitting the URLLC data. For the sake of simple description, the term “PUSCH” may mean any of (1) only PUSCH (e.g., regular PUSCH, non-URLLC-PUSCH, etc.), (2) PUSCH or URLLC-PUSCH, (3) PUSCH and URLLC-PUSCH, or (4) only URLLC-PUSCH (e.g., not regular PUSCH).

Also, for example, uplink channels 121 may be used for transmitting Hybrid Automatic Repeat Request-ACK (HARQ-ACK), Channel State Information (CSI), and/or Scheduling Request (SR). The HARQ-ACK may include information indicating a positive acknowledgment (ACK) or a negative acknowledgment (NACK) for DL data (i.e., Transport Block(s), Medium Access Control Protocol Data Unit (MAC PDU), and/or DL-SCH (Downlink-Shared Channel)).

The CSI may include information indicating a channel quality of downlink. The SR may be used for requesting UL-SCH (Uplink-Shared Channel) resources for new transmission and/or retransmission. For instance, the SR may be used for requesting UL resources for transmitting UL data.

The one or more gNBs 160 may also transmit information or data to the one or more UEs 102 using one or more downlink channels 119, for instance. Examples of downlink channels 119 include a PDCCH, a PDSCH, etc. Other kinds of channels may be used. The PDCCH may be used for transmitting Downlink Control Information (DCI).

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include a UE scheduling module 126.

The UE 102 may utilize the UE scheduling module 126 to perform one or more downlink receptions and/or one or more uplink transmissions. The downlink reception(s) may include reception of data, reception of downlink control information, and/or reception of downlink reference signals. The uplink transmissions include transmission of data, transmission of uplink control information, and/or transmission of uplink reference signals.

In a radio communication system, physical channels (e.g., uplink physical channels and/or downlink physical channels) may be defined. The physical channels (e.g., uplink physical channels and/or downlink physical channels) may be used for communicating (e.g., transmitting and/or receiving) information that is delivered from a higher layer.

For example, in uplink, a Physical Random Access Channel (PRACH) may be defined. In some approaches, the PRACH (and/or a random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., an uplink physical shared channel (PSCH) (e.g., PUSCH) resource).

In some examples, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK may be used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI may be used for indicating state of downlink channel (e.g., a downlink signal(s)). The SR may be used for requesting uplink data resources (e.g., Transport block(s), MAC PDU and/or Uplink Shared Channel (UL-SCH)).

The DL-SCH and/or the UL-SCH may be a transport channel or channels used in the MAC layer. One or more transport blocks (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

The channels mentioned in the disclosure for NB-IoT may be named as NB-IoT PDCCH (NPDCCH), NB-IoT PDSCH (NPDSCH), NB-IoT PUCCH (NPUCCH), NB-IoT PUSCH (NPUSCH), NB-IoT PRACH (NPRACH), etc.

NarrowBand-Internet of Things (NB-IoT) is a standards-based low power wide area (LPWA) technology developed to enable a wide range of new IoT devices and services. In some examples, NB-IoT improves the power consumption of user devices, system capacity and spectrum efficiency, especially in deep coverage.

In downlink, a NB-IoT physical downlink control channel (NPDCCH) may be defined. The NPDCCH may be used for transmitting downlink control information (DCI). In some examples, more than one DCI format may be defined for DCI transmission on the NPDCCH. For instance, fields may be defined in the DCI format(s), and the fields may be mapped to the information bits (e.g., DCI bits).

In some examples, a DCI format N1 that is used for scheduling of the PDSCH in the cell may be defined as a DCI format for the downlink. As described herein one or more Radio Network Temporary Identifiers (e.g., the Cell RNTI(s) (C-RNTI(s))), Configured Scheduling RNTI(s) (CS-RNTI(s)), System Information RNTI(s) (SI-RNTI(s)), Preconfigured Uplink Resource RNTI(s) (PUR-RNTI(s)), GERAN RNTI (G-RNTI) and/or Random Access RNTI(s) (RA-RNTI(s)) may be used to transmit the DCI format N1 (e.g., scramble CRC of DCI). For NB-IoT over NTN, a new RNTI (e.g., NTN-RNTI) may be introduced to transmit the DCI format N1 (e.g., scramble CRC of DCI). In some examples, the DCI format N1 may be monitored (e.g., transmitted, mapped) in a Common Search Space (CSS) and/or a UE Specific Search space (USS). In some examples, the DCI format N1 may be monitored (e.g., transmitted, mapped) in the CSS only. In some examples, the DCI format N1 may be monitored (e.g., transmitted, mapped) in the USS only.

DCI format N1 may be used for the scheduling of one NPDSCH codeword per TTI in one cell, random access procedure initiated by a NPDCCH order, notifying Single-Cell Multicast Control Channel (SC-MCCH) change, and operation on preconfigured UL resources. The DCI corresponding to a NPDCCH order is carried by NPDCCH.

For example, a DCI (DCI field) included in the DCI format N1 may be a frequency domain resource assignment (e.g., for the NPDSCH). Additionally or alternatively, the DCI (DCI field) included in the DCI format N1 may be a time domain resource assignment (for a NPDSCH, for instance). Additionally or alternatively, the DCI (DCI field) included in the DCI format N1 may be a modulation and coding scheme (for the NPDSCH, for instance). Additionally or alternatively, the DCI (DCI field) included in the DCI format N1 may be a new data indicator. Additionally or alternatively, the DCI (DCI field) included in the DCI format N1 may be a HARQ process number. Additionally or alternatively, the DCI (DCI field) included in the DCI format N1 may be Flag for format N0/format N1 differentiation. Additionally or alternatively, the DCI (DCI field) included in the DCI format N1 may be NPDCCH order indicator. Additionally or alternatively, the DCI (DCI field) included in the DCI format N1 may be Information for SC-MCCH change notification. Additionally or alternatively, the DCI (DCI field) included in the DCI format N1 may be Preamble format indicator. Additionally or alternatively, the DCI (DCI field) included in the DCI format N1 may be Starting number of NPRACH repetitions. Additionally or alternatively, the DCI (DCI field) included in the DCI format N1 may be Subcarrier indication of NPRACH. Additionally or alternatively, the DCI (DCI field) included in the DCI format N1 may be Carrier indication of NPRACH. Additionally or alternatively, the DCI (DCI field) included in the DCI format N1 may be Scheduling delay. Additionally or alternatively, the DCI (DCI field) included in the DCI format N1 may be Resource assignment. Additionally or alternatively, the DCI (DCI field) included in the DCI format N1 may be HARQ-ACK resource. Additionally or alternatively, the DCI (DCI field) included in the DCI format N1 may be DCI subframe repetition number. Additionally or alternatively, the DCI (DCI field) included in the DCI format N1 may be Repetition number. Additionally or alternatively, the DCI (DCI field) included in the DCI format N1 may be Number of scheduled TB for SC-MTCH. Additionally or alternatively, the DCI (DCI field) included in the DCI format N1 may be Number of scheduled TB for Unicast. Additionally or alternatively, the DCI (DCI field) included in the DCI format N1 may be Resource reservation. Listing 1 shows an example of DCI format N1.

Listing 1

The following information is transmitted by means of the DCI format N1:
If the format N1 CRC is scrambled by C-RNTI or RA-RNTI or PUR-RNTI:
Flag for format N0/format N1 differentiation - 1 bit, where value 0 indicates format
N0 and value 1 indicates format N1
NPDCCH order indicator - 1 bit
Else if the format N1 CRC is scrambled by a G-RNTI:
Information for SC-MCCH change notification - 2 bits as defined in clause 5.8a of
3GPP TS36.331
Format N1 is used for random access procedure initiated by a NPDCCH order only if
NPDCCH order indicator is set to ‘1’, format N1 CRC is scrambled with C-RNTI,
and all the remaining fields are set as follows:
Preamble format indicator - 1 bit, where value 0 indicates preamble format 0/1 and
value 1 indicates preamble format 2. This field is only present if
nprach-ParametersListFmt2 is configured and the UE indicates the
nprach-Format2 capability.
Starting number of NPRACH repetitions - 2 bits as defined in clause 16.3.2 of
3GPP TS 36.213
Subcarrier indication of NPRACH - 6 or 8 bits, this field is 8 bits only if Preamble
format indicator is present and set to 1, as defined in clause 16.3.2 of 3GPP TS
36.213
Carrier indication of NPRACH - 4 bits as defined in clause 16.3.2 of 3GPP TS
36.213. This field is only present if ul-ConfigList is configured and the UE
indicates the multiCarrier-NPRACH capability.
All the remaining bits in format N1 are set to one
Otherwise,
Scheduling delay - 3 bits as defined in clause 16.4.1 of 3GPP TS 36.213
Resource assignment - 3 bits as defined in clause 16.4.1.3 of 3GPP TS 36.213
Modulation and coding scheme - 4 bits as defined in clause 16.4.1.5 of 3GPP TS
36.213
Repetition number - 4 bits as defined in clause 16.4.1.3 of 3GPP TS 36.213
New data indicator - 1 bit. If multiple TB are scheduled, it functions as New data
indicator for the first TB.
HARQ-ACK resource - 4 bits as defined in clause 16.4.2 of 3GPP TS 36.213.
DCI subframe repetition number - 2 bits as defined in clause 16.6 in 3GPP TS
36.213
Number of scheduled TB for SC-MTCH - 3 bits, indicating from 1 to 8 TBs. This
field is only present if higher layer parameter sc-mtch-InfoListMultiTB-r16 is
enabled and the CRC of the DCI is scrambled by G-RNTI.
Number of scheduled TB for Unicast - 1 bit, where value 0 indicates a single TB is
scheduled and value 1 indicates multiple TB are scheduled. This field is only
present if higher layer parameter npdsch-MultiTB-Config is enabled and the
corresponding DCI is mapped onto the UE specific search space given by the
C-RNTI as defined in 3GPP TS 36.213
HARQ process number - 1 bit. This field is only present if 2 HARQ processes are
configured and the corresponding DCI format is mapped onto the UE specific
search space given by the C-RNTI as defined in 3GPP TS 36.213, or if Number of
scheduled TB for Unicast is present. If multiple TB are scheduled, it functions as
New data indicator for the second TB.
Resource reservation - 1 bit as defined in clause 16.4 of 3GPP TS 36.213. This
field is only present if higher layer parameter resourceReservationConfigDL is
configured and the DCI is mapped onto the UE-specific search space given by
C-RNTI as defined in [3].
When the format N1 CRC is scrambled with a RA-RNTI or a G-RNTI, then the
following fields among the fields above are reserved for RA-RNTI and not present
for G-RNTI:
New data indicator
HARQ-ACK resource
If the number of information bits in format N1 mapped onto the same search space is
less than that of format N0 and the format N1 CRC is not scrambled by G-RNTI,
zeros shall be appended to format N1 until the payload size equals that of format
N0.

Additionally or alternatively, a DCI format N2 is used for paging, direct indication, scheduling of one NPDSCH codeword carrying SC-MCCH in one cell, and notifying SC-MCCH change. As described herein one or more Radio Network Temporary Identifiers (e.g., the Cell RNTI(s) (C-RNTI(s))), Configured Scheduling RNTI(s) (CS-RNTI(s)), System Information RNTI(s) (SI-RNTI(s)), Preconfigured Uplink Resource RNTI(s) (PUR-RNTI(s)), GERAN RNTI (G-RNTI), Single Cell RNTI (SC-RNTI), Paging RNTI (P-RNTI) and/or Random Access RNTI(s) (RA-RNTI(s)) may be used to transmit the DCI format N2 (e.g., scramble CRC of DCI). For NB-IoT over NTN, a new RNTI (e.g., NTN-RNTI) may be introduced to transmit the DCI format N2 (e.g., scramble CRC of DCI). In some examples, the DCI format N2 may be monitored (e.g., transmitted, mapped) in a Common Search Space (CSS) and/or a UE Specific Search space (USS). In some examples, the DCI format N2 may be monitored (e.g., transmitted, mapped) in the CSS only. In some examples, the DCI format N2 may be monitored (e.g., transmitted, mapped) in the USS only.

For example, a DCI (DCI field) included in the DCI format N2 may be a frequency domain resource assignment (e.g., for the NPDSCH). Additionally or alternatively, the DCI (DCI field) included in the DCI format N2 may be a time domain resource assignment (for a NPDSCH, for instance). Additionally or alternatively, the DCI (DCI field) included in the DCI format N2 may be a modulation and coding scheme (for the NPDSCH, for instance). Additionally or alternatively, the DCI (DCI field) included in the DCI format N2 may be a new data indicator. Additionally or alternatively, the DCI (DCI field) included in the DCI format N2 may be a HARQ process number. Additionally or alternatively, the DCI (DCI field) included in the DCI format N2 may be Flag for paging/direct indication differentiation. Additionally or alternatively, the DCI (DCI field) included in the DCI format N1 may be NPDCCH order indicator. Additionally or alternatively, the DCI (DCI field) included in the DCI format N1 may be Information for SC-MCCH change notification. Additionally or alternatively, the DCI (DCI field) included in the DCI format N1 may be Preamble format indicator. Additionally or alternatively, the DCI (DCI field) included in the DCI format N1 may be Starting number of NPRACH repetitions. Additionally or alternatively, the DCI (DCI field) included in the DCI format N1 may be Subcarrier indication of NPRACH. Additionally or alternatively, the DCI (DCI field) included in the DCI format N1 may be Carrier indication of NPRACH. Additionally or alternatively, the DCI (DCI field) included in the DCI format N1 may be Scheduling delay. Additionally or alternatively, the DCI (DCI field) included in the DCI format N1 may be Resource assignment. Additionally or alternatively, the DCI (DCI field) included in the DCI format N1 may be HARQ-ACK resource. Additionally or alternatively, the DCI (DCI field) included in the DCI format N1 may be DCI subframe repetition number. Additionally or alternatively, the DCI (DCI field) included in the DCI format N1 may be Repetition number. Additionally or alternatively, the DCI (DCI field) included in the DCI format N1 may be Number of scheduled TB for SC-MTCH. Additionally or alternatively, the DCI (DCI field) included in the DCI format N1 may be Number of scheduled TB for Unicast. Additionally or alternatively, the DCI (DCI field) included in the DCI format N1 may be Resource reservation. Additionally or alternatively, the DCI (DCI field) included in the DCI format N1 may be Direct Indication information. Listing 2 shows an example of DCI format N2.

Listing 2

The following information is transmitted by means of the DCI format N2:
If the format N2 CRC is scrambled by P-RNTI:
Flag for paging/direct indication differentiation - 1 bit, with value 0 for direct
indication and value 1 for paging
Else if the format N2 CRC is scrambled by a SC-RNTI:
Information for SC-MCCH change notification - 1 bit as defined in clause 5.8a of
3GPP TS36.331
If the format N2 CRC is scrambled by P-RNTI and Flag-0:
Direct Indication information - 8 bits provide direct indication of system
information update and other fields, as defined in 3GPP TS36.331
Reserved information bits are added until the size is equal to that of format N2 with
Flag = 1
If the format N2 CRC is scrambled by P-RNTI and Flag = 1, or if the format N2
CRC is scrambled by SC-RNTI:
Resource assignment - 3 bits as defined in clause 16.4.1.3 of 3GPP TS 36.213
Modulation and coding scheme - 4 bits as defined in clause 16.4.1.5 of 3GPP TS
36.213
Repetition number - 4 bits as defined in clause 16.4.1.3 of 3GPP TS 36.213
DCI subframe repetition number - 3 bits as defined in clause 16.6 of 3GPP TS
36.213

Additionally or alternatively, a new DCI format (e.g., DCI format NIX) that is used for scheduling of one NPDSCH codeword per TTI in one cell, random access procedure initiated by a NPDCCH order, notifying SC-MCCH change, and operation on preconfigured UL resources may be defined as a DCI format for the downlink (over NTN). Additionally or alternatively, the C-RNTI, P-RNTI, PUR-RNTI, RA-RNTI, SI-RNTI, G-RNTI, SC-RNTI, the CS-RNTI and/or a new RNTI (e.g. NTN-RNTI) may be used to transmit the new DCI format (e.g., DCI format N1_X). Additionally or alternatively, the DCI format N1_X may be monitored/detected (e.g., transmitted and/or mapped) in the CSS and/or the USS.

Additionally or alternatively, a new DCI format (e.g., DCI format N2_X) that is used for paging, direct indication, scheduling of one NPDSCH codeword carrying SC-MCCH in one cell, and notifying SC-MCCH change may be defined as a DCI format for the downlink (over NTN). Additionally or alternatively, the C-RNTI, P-RNTI, PUR-RNTI, RA-RNTI, SI-RNTI, G-RNTI, SC-RNTI, CS-RNTI and/or a new RNTI (e.g. NTN-RNTI) may be used to transmit the new DCI format (e.g., DCI format N2_X). Additionally or alternatively, the DCI format N2_X may be monitored/detected (e.g., transmitted and/or mapped) in the CSS and/or the USS.

Additionally or alternatively, a DCI format N0 is used for the scheduling of NPUSCH and operation on preconfigured UL resources in one UL cell. As described herein one or more Radio Network Temporary Identifiers (e.g., the Cell RNTI(s) (C-RNTI(s))), Configured Scheduling RNTI(s) (CS-RNTI(s)), System Information RNTI(s) (SI-RNTI(s)), Preconfigured Uplink Resource RNTI(s) (PUR-RNTI(s)), GERAN RNTI (G-RNTI), Single Cell RNTI (SC-RNTI), Paging RNTI (P-RNTI) and/or Random Access RNTI(s) (RA-RNTI(s)) may be used to transmit the DCI format N0 (e.g., scramble CRC of DCI). For NB-IoT over NTN, a new RNTI (e.g., NTN-RNTI) may be introduced to transmit the DCI format N0 (e.g., scramble CRC of DCI). In some examples, the DCI format N0 may be monitored (e.g., transmitted, mapped) in a Common Search Space (CSS) and/or a UE Specific Search space (USS). In some examples, the DCI format N0 may be monitored (e.g., transmitted, mapped) in the CSS only. In some examples, the DCI format N0 may be monitored (e.g., transmitted, mapped) in the USS only.

For example, a DCI (DCI field) included in the DCI format N0 may be a frequency domain resource assignment (e.g., for the NPUSCH). Additionally or alternatively, the DCI (DCI field) included in the DCI format N0 may be a time domain resource assignment (for a NPUSCH, for instance). Additionally or alternatively, the DCI (DCI field) included in the DCI format N0 may be a modulation and coding scheme (for the NPUSCH, for instance). Additionally or alternatively, the DCI (DCI field) included in the DCI format N0 may be a new data indicator. Additionally or alternatively, the DCI (DCI field) included in the DCI format N0 may be a HARQ process number. Additionally or alternatively, the DCI (DCI field) included in the DCI format N0 may be Flag for format N0/format N1 differentiation. Additionally or alternatively, the DCI (DCI field) included in the DCI format N0 may be ACK or Fallback indicator. Additionally or alternatively, the DCI (DCI field) included in the DCI format N0 may be Information for NPUSCH repetition adjustment. Additionally or alternatively, the DCI (DCI field) included in the DCI format N0 may be Timing advance adjustment. Additionally or alternatively, the DCI (DCI field) included in the DCI format N0 may be Subcarrier indication. Additionally or alternatively, the DCI (DCI field) included in the DCI format N0 may be Subcarrier indication of NPRACH. Additionally or alternatively, the DCI (DCI field) included in the DCI format N0 may be Redundancy version. Additionally or alternatively, the DCI (DCI field) included in the DCI format NO may be Scheduling delay. Additionally or alternatively, the DCI (DCI field) included in the DCI format N0 may be Resource assignment. Additionally or alternatively, the DCI (DCI field) included in the DCI format N0 may be HARQ-ACK resource. Additionally or alternatively, the DCI (DCI field) included in the DCI format NO may be DCI subframe repetition number. Additionally or alternatively, the DCI (DCI field) included in the DCI format N0 may be Repetition number. Additionally or alternatively, the DCI (DCI field) included in the DCI format N0 may be DCI subframe repetition number. Additionally or alternatively, the DCI (DCI field) included in the DCI format N1 may be Number of scheduled TB for Unicast. Additionally or alternatively, the DCI (DCI field) included in the DCI format N1 may be Resource reservation. Listing 3 shows an example of DCI format N0.

Listing 3

The following information is transmitted by means of the DCI format N0:
Flag for format N0/format N1 differentiation - 1 bit, where value 0 indicates format
N0 and value 1 indicates format N1
Modulation and coding scheme - 4 bits as defined in clause 16.5.1.2 of 3GPP TS
36.213. This field is only present if format N0 CRC is scrambled by PUR-RNTI.
If format N0 CRC is scrambled by PUR-RNTI and Modulation and coding scheme is
set to ‘1110’, the remaining fields are set as follows:
ACK or Fallback indicator - 1 bit, where value 0 indicates ACK and value 1
indicates fallback as defined in clause 16.6.4 of 3GPP TS 36.213
NPUSCH repetition adjustment - 3 bits refer to I_{Rep} in Table 16.5.1.1-3 of 3GPP
TS 36.213
Timing advance adjustment - 6 bits as defined in clause 16.1.2 of 3GPP TS 36.213.
The field is only present if ACK or Fallback indicator is set to 0.
All the remaining bits in format N0 are set to one
Otherwise
Subcarrier indication - 6 bits as defined in clause 16.5.1.1 of 3GPP TS 36.213
Resource assignment - 3 bits as defined in clause 16.5.1.1 of 3GPP TS 36.213
Scheduling delay - 2 bits as defined in clause 16.5.1 of 3GPP TS 36.213
Modulation and coding scheme - 4 bits as defined in clause 16.5.1.2 of 3GPP TS
36.213. This field is not present if format N0 CRC is scrambled by PUR-RNTI.
Redundancy version - 1 bit as defined in clause 16.5.1.2 of 3GPP TS 36.213
Repetition number - 3 bits as defined in clause 16.5.1.1 of 3GPP TS 36.213
New data indicator - 1 bit. If multiple TB are scheduled, it functions as New data
indicator for the first TB.
DCI subframe repetition number - 2 bits as defined in clause 16.6 in 3GPP TS
36.213
Number of scheduled TB for Unicast - 1 bit, where value 0 indicates a single TB is
scheduled and value 1 indicates multiple TB are scheduled. This field is only
present if higher layer parameter npusch-MultiTB-Config is enabled and the
corresponding DCI is mapped onto the UE specific search space given by the
C-RNTI as defined in 3GPP TS 36.213. The field is set to 0 if the CRC of the DCI
is scrambled by SPS C-RNTI.
HARQ process number - 1 bit. This field is only present if 2 HARQ processes are
configured and the corresponding DCI format is mapped onto the UE specific
search space given by the C-RNTI as defined in 3GPP TS 36.213, or if Number of
scheduled TB for Unicast is present. If multiple TB are scheduled, it functions as
New data indicator for the second TB.
Resource reservation - 1 bit as defined in clause 16.5 of 3GPP TS 36.213. This
field is only present if higher layer parameter resourceReservationConfigUL is
configured and the DCI is mapped onto the UE-specific search space given by
C-RNTI as defined in 3GPP TS 36.213.
If the number of information bits in format N0 mapped onto the UE specific search
space given by the C-RNTI as defined in 3GPP TS 36.213 is less than that of
format N1 in the same search space, zeros shall be appended to format N0 until the
payload size equals that of format N1.

Additionally or alternatively, a new DCI format (e.g., DCI format N0_X) that is used for scheduling of NPUSCH and operation on preconfigured UL resources in one UL cell may be defined as a DCI format for the downlink (over NTN). Additionally or alternatively, the C-RNTI, P-RNTI, PUR-RNTI, RA-RNTI, SI-RNTI, G-RNTI, SC-RNTI, the CS-RNTI and/or a new RNTI (e.g. NTN-RNTI) may be used to transmit the new DCI format (e.g., DCI format N0_X). Additionally or alternatively, the DCI format N0_X may be monitored/detected (e.g., transmitted and/or mapped) in the CSS and/or the USS.

In some examples, as described above, a RNTI(s) (e.g., a Radio Network Temporary Identifier(s)) assigned to the UE 102 may be used for transmission of DCI (e.g., the DCI format(s), DL control channel(s) (e.g., the PDCCH(s)/NPDCCH(s))). For instance, the gNB 160 may transmit (by using the RRC message, for example) information used for configuring (e.g., assigning) the RNTI(s) to the UE 102.

For example, Cyclic Redundancy Check (CRC) parity bits (which may be referred to simply as CRC), which are generated based on DCI, may be attached to DCI, and, after attachment, the CRC parity bits may be scrambled by the RNTI(s). The UE 102 may attempt to decode (e.g., blind decode, monitor, detect) DCI to which the CRC parity bits scrambled by the RNTI(s) are attached. For example, the UE 102 may detect a DL control channel (e.g., the PDCCH, the DCI, the DCI format(s)) based on the blind decoding. For instance, the UE 102 may decode the DL control channel(s) with the CRC scrambled by the RNTI(s). In other words, the UE 102 may monitor the DL control channel(s) with the RNTI(s). For example, the UE 102 may detect the DCI format(s) with the RNTI(s).

In some examples, the RNTI(s) may include the C-RNTI(s) (Cell-RNTI(s)), the CS-RNTI(s) (Configured Scheduling C-RNTI(s)), the SI-RNTI(s) (System Information RNTI(s)), the RA-RNTI(s) (Random Access-RNTI(s)), the Preconfigured Uplink Resource RNTI(s) (PUR-RNTI(s)), the GERAN RNTI (G-RNTI), the Single Cell RNTI (SC-RNTI), the Paging RNTI (P-RNTI) and/or the Temporary C-RNTI(s). For example, the C-RNTI(s) may be a unique identification used for identifying a RRC connection and/or scheduling. Additionally or alternatively, the CS-RNTI(s) may be a unique identification used for scheduling of transmission based on a configured grant. Additionally or alternatively, the SI-RNTI may be used for identifying system information (SI) (e.g., an SI message) mapped on the BCCH and dynamically carried on DL-SCH. Additionally or alternatively, the SI-RNTI may be used for broadcasting of SI. Additionally or alternatively, the RA-RNTI may be an identification used for the random access procedure (e.g., Msg.2 transmission). Additionally or alternatively, the Temporary C-RNTI may be used for the random access procedure (e.g., scheduling of Msg.3 (re)transmission (e.g., Msg.3 PUSCH (re)transmission)).

Additionally or alternatively, a new RNTI (e.g., NTN-RNTI) may be introduced for NTN and its service(s). For example, in a case that the DCI format N1 and/or the DCI format N2 and/or the DCI format N1_X and/or the DCI format N2_X with CRC scrambled by NTN-RNTI is received (based on the detection of the DCI format N1 and/or the DCI format N2 and/or the DCI format N1_X and/or the DCI format N2_X, for example), the UE 102 may perform the NPDSCH reception for NTN transmission service(s). Additionally or alternatively, in a case that the DCI format N0 and/or the DCI format N0_X with CRC scrambled by NTN-RNTI is received (based on the detection of the DCI format N0 and/or the DCI format N0_X, for example), the UE 102 may perform the NPUSCH transmission for NTN transmission service(s).

Additionally or alternatively, separate RNTIs may be introduced for UL and DL. For example, a new RNTI (e.g., NTN-UL-RNTI) may be introduced for NTN UE(s) and its UL transmission service(s) while another new RNTI (e.g., NTN-DL-RNTI) may be introduced for NTN UE(s) and its DL transmission service(s). In a case that the DCI format N1 and/or the DCI format N2 and/or the DCI format N1_X and/or the DCI format N2_X with CRC scrambled by NTN-DL-RNTI is received (based on the detection of the DCI format N1 and/or the DCI format N2 and/or the DCI format N1_X and/or the DCI format N2_X, for example), the UE 102 may perform the NPDSCH reception for NTN transmission service(s). Additionally or alternatively, in a case that the DCI format N0 and/or the DCI format N0_X with CRC scrambled by NTN-UP-RNTI is received (based on the detection of the DCI format N0 and/or the DCI format N0_X, for example), the UE 102 may perform the NPUSCH transmission for NTN transmission service(s).

Additionally or alternatively, a physical downlink shared channel (PDSCH) and a physical uplink shared channel (PUSCH) may be defined. For example, in a case that the PDSCH (e.g., the PDSCH resource) is scheduled by using the DCI format(s), the UE 102 may receive the downlink data, on the scheduled PDSCH (e.g., the PDSCH resource). Additionally or alternatively, in a case that the PUSCH (e.g., the PUSCH resource) is scheduled by using the DCI format(s), the UE 102 transmits the uplink data on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., UL-SCH(s), an uplink transport block(s)). The PDSCH for NB-IoT may be also named as NPDSCH and the PUSCH for NB-IoT may be also named as NPUSCH.

In some examples, the PDSCH/NPDSCH and/or the PUSCH/NPUSCH may be used to transmit information of a higher layer (e.g., a radio resource control (RRC)) layer, and/or a MAC layer). For example, the PDSCH/NPDSCH (from the gNB 160 to the UE 102, for instance) and/or the PUSCH/NPUSCH (from the UE 102 to the gNB 160, for instance) may be used to transmit a RRC message (e.g., a RRC signal). Additionally or alternatively, the PDSCH/NPDSCH (from the gNB 160 to the UE 102, for instance) and/or the PUSCH/NPUSCH (from the UE 102 to the gNB 160, for instance) may be used to transmit a MAC control element (a MAC CE). In some examples, the RRC message and/or the MAC CE may be referred to as a higher layer signal.

In some approaches, a physical broadcast channel (PBCH) may be defined. For example, the PBCH may be used for broadcasting the master information block (MIB). In some examples, system information may be divided into the MIB and a number of system information block(s) (SIB(s)) (e.g., one or more SIBs). For example, the MIB may be used for carrying minimum system information. Additionally or alternatively, the SIB(s) may be used for carrying system information messages (e.g., each SIB can be used for carrying one or more system information messages).

In some approaches, in downlink, a Synchronization Signal (SS) may be defined. The SS may be used for acquiring time and/or frequency synchronization with a cell. Additionally or alternatively, the SS may be used for detecting a physical layer cell ID of the cell.

In the radio communication for uplink, UL reference signal(s) (RS(s)) may be used as uplink physical signal(s). Additionally or alternatively, in the radio communication for downlink, DL RS(s) may be used as downlink physical signal(s). In some examples, the uplink physical signal(s) and/or the downlink physical signal(s) may not be used to transmit information that is provided from the higher layer, but is used by a physical layer.

As used herein, when a signal includes or comprises elements, it means that the elements may be communicated in the same or in different instances of signaling.

In some examples, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

For NTN, due to the large round trip time (RTT) (e.g., 25.77 ms for LEO-600) and potential scheduling with larger SCS (e.g., SCS=30 KHz), the existing maximal supported HARQ process number is not sufficient for corresponding the DL/UL. Meanwhile, this value is also not feasible to enable the air to ground (ATG) operation in TDD mode. Thus, the maximal supported HARQ process number for NTN may be up to 4 (or higher, e.g., 6, 8).

After UE receives a DL transmission (e.g., a NPDSCH transmission), the UE may transmit a HARQ feedback (e.g., positive acknowledgement or negative acknowledgement) to indicate whether the DL transmission is received successfully or not. After gNB (base station) receives a UL transmission (e.g., a NPUSCH transmission), the gNB (base station) may transmit a HARQ feedback (e.g., positive acknowledgement or negative acknowledgement or a grant for a new UL transmission or a grant for a retransmission of the UL transmission) to indicate whether the UL transmission is received successfully or not. In addition, to overcome the large delay caused by HARQ feedback and/or possible retransmission, mechanism for disabling and/or enabling HARQ feedback may be supported for NTN. For example, enabling and/or disabling on HARQ feedback for downlink transmission should be at least configurable per HARQ process via UE specific RRC signaling.

Each HARQ process may be RRC configured whether HARQ feedback for downlink and/or uplink is disabled or enabled. In yet another design, one or more constraints may be applied to disable/enable HARQ feedback for a HARQ process(es) separately or jointly. For example, there may be a higher layer parameter maxnrofdisabledHARQ-Processes (e.g., provided by a dedicated or common RRC message) to indicate a maximum number of HARQ processes whose HARQ feedback can be disabled. There may be a higher layer parameter maxnrofenabledHARQ-Processes (e.g., provided by a dedicated or common RRC message) to indicate a maximum number of HARQ processes whose HARQ feedback can be enabled. There may be a higher layer parameter disabledHARQ-ProcessesID (e.g., provided by a dedicated or common RRC message) to indicate a HARQ process or a set of HARQ processes, whose HARQ feedback can be disabled. There may be a higher layer parameter enabledHARQ-ProcessesID (e.g., provided by a dedicated or common RRC message) to indicate a HARQ process or a set of HARQ processes, whose HARQ feedback can be enabled.

In addition, for long UL transmission on PUSCH and PRACH and/or long DL transmission on PDSCH, the satellite may be changed/switched during the long transmission(s), which may result in segmented transmissions with different time/frequency delays/shifts.

In addition, due to the large round trip time (RTT), timing relationships, e.g., NPDCCH to NPUSCH format 1, RAR grant to NPUSCH format 1, NPDSCH to HARQ-ACK on NPUSCH format 2, NPDCCH order to NPRACH, Timing advance command activation and other NB-IoT timing relationships, may need enhancements/handling.

Thus, the current DCI formats (e.g., DCI format N0, DCI format N1, DCI N2) may not be supportive and/or suitable. To support the segmented compensation/transmissions, enhanced timing relationships, the extension of maximal HARQ process number and/or mechanism for disabling/enabling HARQ feedback, either modifications of current DCI formats may be needed, or new DCI formats may be introduced.

The details of new DCI formats (e.g., DCI format N0_X, DCI format N1_X, DCI format N2_X,) and/or modifications of current DCI formats (e.g., DCI format N0, DCI format N1, DCI format N2) are described herein.

For NTN, the current DCI format (e.g., DCI format N0) may not be supportive and/or suitable. One or more DCI fields may be necessary to be updated/modified in DCI (e.g., flag for NTN/non-NTN differentiation, validity timer, segmented repetitions, HARQ/ACK enabler, NPUSCH repetition adjustment, Scheduling delay, antenna port(s), transmission configuration indication, rate matching indicator, SRS request, PRB bundling size indicator, carrier indicator, CSI request, ZP CSI-RS triggering, beta offset indicator, SRS resource indicator, repetition factor, priority indication, HARQ process number and so on). For example, the number of bits of HARQ process number filed in DCI format N0 is 1, and the maximum number of bits of configurable HARQ process number filed in DCI format N0 is 2. In this case, to indicate more than 2 HARQ processes, a new DCI format and/or current DCI format with modifications and/or enhancements may be introduced. Additionally, the number of bits of scheduling delay filed is 2, which may not to suitable to long RTT in NTN transmissions. Repetitions may be further adjusted due to segmented transmissions. Validity timer for synchronization may be used to guarantee the accuracy of parameters/information. In these cases, a new DCI format and/or current DCI format with modifications and/or enhancements may be introduced.

In an implementation, a new DCI format (e.g., DCI format N0_X, specifications (e.g., 3GPP standards, or any other standards for IoT and/or NTN) may use a different name) may be introduced. DCI format N0_X may be used for the scheduling of NPUSCH and operation on preconfigured UL resources in one UL cell. The following information may be transmitted by means of the DCI format N0_X.

DCI format N0_X may include an identifier for DCI formats (a DCI field to identify DCI formats). The value of this field may be set to a predefined and/or defaulted value (e.g., 0 or 1), indicating a new/different DCI format (comparing to DCI format N0 and/or DCI format N1 and/or DCI format N2) for NTN.

DCI format N0_X may include an identifier for UL/DL DCI formats (a DCI field to identify UL/DL DCI formats). The value of this field may be set to a predefined and/or defaulted value (e.g., 0 or 1), indicating an UL DCI format.

DCI format N0_X may include an identifier for disabling/enabling segmentation (a DCI field to indicate whether segmentation is enabled or disabled). The value of this field may be set to a predefined and/or defaulted value (e.g., 0 or 1), indicating a segmentation of long transmissions/repetitions happens or not. The repetitions may be split into two (or more) segmented transmissions due to the switch of service satellites and/or validity timer expiration. This field may indicate whether segmentation will happen during the long transmissions/repetitions or not. If this field is absent or this field indicates no segmentations, some DCI fields related to segmentation described below (e.g., first segmented repetition number, second segmented repetition number, fraction factor) may not be applied/configured/provided.

DCI format N0_X may include a validity timer (a DCI field to identify a timer). The repetitions may be split into two (or more) segmented transmissions (e.g., first segmented repetitions and second segmented repetitions) due to the switch of service satellites and/or validity timer expiration. This DCI field may indicate a time window/period when information/parameters are valid and/or unchanged. The validity timer may indicate a start time, end time and/or a duration (e.g., the time window/period is determined by the start time and the end time provided by the DCI filed, or the time window/period is determined by the start time and the duration the DCI filed, or the DCI filed only indicates an end time). The validity timer may be measured/given in unit of slot, subframe, frame, sub-slot, mini-slot, ms, second, and so on. A set of validity timers may be provided/configured by a RRC message/signaling and this filed indicated one from th set. The number of bits in this bit field may be 0-2 bits or larger. The number of bits in this bit field may be fixed in a specification or in a standard (“in spec”) (e.g., 3GPP standards, or any other standards for IoT and/or NTN). The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of validity timer. For example, if dynamic indication of validity time is not enabled and/or segmentation is not enabled/applied, configured and/or supported, the number of bits in this field is 0 or this bit field is absent in DCI. If dynamic indication of validity timer is enabled, configured and/or supported, and/or the number of validity timer in the configured and/or predefined set is 4 (e.g., {1 s, 2 s, 4 s, 8 s}, {512 slots, 1024 slots, 2048 slots, 4096 slots}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N0_X and this field provides validity timer, UE performs the first segmented repetitions (and/or the second segmented repetitions) according to information from this field (e.g., last slot/subframe used for the first segmented repetitions is indicated/derived by/from the DCI field, validity timer; start slot/subframe used for the second segmented repetitions is indicated/derived by/from the DCI field, validity timer) and information/parameters provided/configured for the first segmented repetitions, e.g., current information/parameters (provided by L1 signaling, e.g., PDCCH, and/or L2 signaling, e.g., MAC CE, and/or higher layer configuration, e.g., RRC message) for transmissions before satellite switching and/or validity timer expiration (or information/parameters provided/configured for the second segmented repetitions, e.g., updated information/parameters (provided by L1 signaling, e.g., PDCCH, and/or L2 signaling, e.g., MAC CE, and/or higher layer configuration, e.g., RRC message) for transmissions after satellite switching and/or validity timer expiration).

DCI format N0_X may include an identifier for disabling/enabling HARQ feedback. The value of this field may be set to a predefined and/or defaulted value (e.g., 0 or 1), indicating a disabling of HARQ feedback or enabling of HARQ feedback.

DCI format N0_X may include modulation and coding scheme (MCS) field. The bitwidth of the MCS filed may be 5 bits or a reduced size (e.g., 1, 2, 3, 4 bits) or a larger size (e.g., 6 bits). The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured MCS table (e.g., higher layer parameter mcs-Table). Any of the high layer parameters used to determine the number of bits in this field may be commonly configured for DCI format N0_X and other DCI formats, or separately configured for DCI format N0_X. In other words, parameter(s) configured for other DCI format(s) (e.g., DCI format N0) field size determination may be also used to determine the number of bits in the corresponding bit field for DCI format N0_X, or parameter(s) used to determine the number of bits in the corresponding bit field for DCI format N0_X may be configured separately. Existing MCS tables for current DCI formats (e.g., DCI format N0) may be reused/provided for DCI format N0_X, e.g., qam256 table, qam64 table or qam64LowSE table. A new MCS table may be configured/provided for DCI format N0_X separately, e.g., a new MCS table with 16 (or less than 16) rows or a new MCS table with 16 (or more than 16) rows. In yet another implementation, a truncated existing MCS table(s) may be used/configured/provided for DCI format N0_X. Namely, some of rows in the existing MCS table(s) for current DCI formats (e.g., DCI format N0) may be configured/provided for DCI format N0_X. The selection of MCS table may be determined by a mechanism for disabling/enabling HARQ feedback. For example, if HARQ feedback is disabled for a HARQ process(es) (by RRC configuration), the new MCS table (or qam256 table, qam64 table or qam64LowSE table) is used/assumed for the scheduling DCI format (current DCI format or new DCI format) of the corresponding HARQ process(es).

DCI format N0_X may include antenna ports. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by configured waveform (e.g., whether transform precoder is enabled or not). The number of bits in this bit field may be determined by the satellite type and/or network type (i.e. TN or NTN). The number of bits in this bit field may be determined by a mechanism for disabling/enabling HARQ feedback. The number of bits in this bit field may be determined by DMRS type, rank, codebook and/or any other related high layer parameters. Any of the high layer parameters used to determine the number of bits in this field may be commonly configured for DCI format N0_X and other DCI formats, or separately configured for DCI format N0_X. In other words, parameter(s) configured for other DCI format(s) field size determination may be also used to determine the number of bits in the corresponding bit field for DCI format N0_X, or parameter(s) used to determine the number of bits in the corresponding bit field for DCI format N0_X may be configured separately.

DCI format N0_X may include a transmission configuration indication. The number of bits in this bit field may be 0-3 bits. The number of bits in this bit field may be fixed in a specification or standard. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of multiple transmission configurations (e.g., how many transmission configurations are configured by RRC message(s)). For example, if multiple configurations are not enabled, the number of bits in this field is 0 or this bit field is absent in DCI. If the number of transmission configuration is 8, the number of bits in this field may be 3. If multiple transmission configurations for NTN are enabled and/or configured, only DCI format N0_X may be used to activate and/or deactivate corresponding configured grant(s). Enabling/disabling on HARQ feedback for CG transmission may be configurable per CG configuration via UE specific RRC signaling.

DCI format N0_X may include an SRS request. The number of bits in this bit field may be 0-2 bits. The number of bits in this bit field may be fixed in a specification or standard. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured carrier (e.g., whether SUL is configured or not). The number of bits in this bit field may be determined by a configured table (e.g., a table provided by RRC message and/or SI) and/or predefined table (e.g., a fixed table used by UE and network) and/or any other related high layer parameters. Any of the high layer parameters used to determine the number of bits in this field may be commonly configured for DCI format N0_X and other DCI formats, or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. The field size may be a fixed value (e.g., 1, 2) defined in the spec. The field size may also be determined by other higher layer parameters.

DCI format N0_X may include a carrier indication (DCI field to indicated which carrier is used). The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of carriers (e.g., how many carriers are configured by RRC message and/or SI), e.g. [log₂(number of carriers)]. For example, if multiple carriers are not enabled and/or configured, the number of bits in this field is 0 or this bit field is absent in DCI. If the number of carriers is larger than 4 (e.g., 6), the number of bits in this field may be 3 (e.g. [log₂(6)],). Any of the high layer parameters used to determine the number of bits in this field may be commonly configured for DCI format N0_X and other DCI formats, or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be a value (e.g., 0, 1, 2 or 3 bits) determined by higher layer parameter (e.g., CarrierIndicatorSize-ForDCIFormatN0_X).

DCI format N0_X may include a subcarrier indication (DCI field to indicated which subcarrier(s) is used). The number of bits in this bit field may be 0-6 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of subcarriers (e.g., how many sub-carriers are configured by RRC message and/or SI). For example, if multiple sub-carriers are not enabled and/or configured, the number of bits in this field is 0 or this bit field is absent in DCI. Any of the high layer parameters used to determine the number of bits in this field may be commonly configured for DCI format N0_X and other DCI formats, or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be a value (e.g., 0, 1, 2, 3, 4, 5, 6 bits) determined by higher layer parameter (e.g., SubcarrierIndicatorSize-ForDCIFormatN0_X).

DCI format 0_X may include a CSI request. The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by CSI configuration. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined table, and/or any other related high layer parameters. Any of the high layer parameters used to determine the number of bits in this field may be commonly configured for DCI format N0_X and other DCI formats, or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be value (e.g., 0, 1, 2, 3, 4, 5, or 6 bits) determined by higher layer parameter (reportTriggerSize-ForDCIFormatN0_X).

DCI format N0_X may include a beta_offset indicator. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by beta_offset configuration type (e.g., whether beta_offset is semi-static or dynamic). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined table, and/or any other related high layer parameters. Any of the high layer parameters used to determine the number of bits in this field may be commonly configured for DCI format N0_X and other DCI formats, or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be determined by configured beta offset (e.g., semi-static or dynamic) and or configured number of offset indexes. The field size may be 0 bit if the higher layer parameter betaOffsets=semiStatic; otherwise 1 bit if 2 offset indexes are configured by higher layer parameter (e.g., dynamic-ForDCIFormat0_3) and 2 bits if 4 offset indexes are configured by higher layer parameter (e.g., dynamicForDCIFormatN0_X). The field size may be 0 bit if HARQ feedback is disabled as mentioned above. For example, if HARQ feedback is disabled for a HARQ process(es) (by RRC configuration), the beta_offset indicator field may be absent or 0 bit for the scheduling DCI format (current DCI format or new DCI format) of the corresponding HARQ process(es).

DCI format N0_X may include an SRS resource indicator. The number of bits in this bit field may be 0-4 bits. The number of bits in this bit field may be fixed in spec. The number of bits in this bit field may be determined by higher layer (e.g., RRC configuration, an explicit high layer parameter). The number of bits in this bit field may be determined by the number of configured SRS resources in the SRS resource set. The number of bits in this bit field may be determined by the maximum number of supported layers for the PUSCH, codebook and/or any other related high layer parameters. The number of bits in this bit field may be determined by the satellite type and/or network type (i.e. TN or NTN). The number of bits in this bit field may be determined by a mechanism for disabling/enabling HARQ feedback. Any of the high layer parameters used to determine the number of bits in this field may be commonly configured for DCI format N0_X and other DCI formats, or separately configured for DCI format N0_X. In other words, parameter(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be determined by the number of configured SRS resources in the SRS resource set configured by higher layer parameter (e.g., srs-ResourceSetToAddModList-ForDCIFormatN0_X), codebook (e.g., higher layer parameter usage of value ‘codeBook’ or ‘nonCodeBook’), number of layers (e.g., maxMIMO-Layers-ForDCIFormatN0_X), SRS resource set (e.g., srs-ResourceSetToAddModList-ForDCIFormatN0_X).

DCI format N0_X may include a repetition factor (repetition number). The number of bits in this bit field may be 0-2 bits or more bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors. For example, if dynamic indication of repetition factor is not enabled, configured and/or supported, the number of bits in this field is 0 or this bit field is absent in DCI. If dynamic indication of repetition factor is enabled, configured and/or supported, and/or the number of repetition factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es).

DCI format N0_X may include a NPUSCH repetition adjustment. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors. For example, if dynamic indication of repetition number/factor is not enabled, configured and/or supported, the number of bits in this field is 0 or this bit field is absent in DCI. If dynamic indication of repetition number/factor is enabled, configured and/or supported, and/or the number of repetition number/factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). This field may provide an updated repetition number in case that information/parameters for the transmissions may be changed. In case that UE detects the DCI format N0_X and this field provides NPUSCH repetition adjustment, UE performs the repetitions according to information from this field.

DCI format N0_X may include a DCI subframe repetition number. The number of bits in this bit field may be 0-2 bits or larger. This field may indicate repetitions of NPDCCH/DCI. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition number/factors. For example, if dynamic indication of repetition number/factor is not enabled, configured and/or supported, the number of bits in this field is 0 or this bit field is absent in DCI. If dynamic indication of repetition number/factor is enabled, configured and/or supported, and/or the number of repetition number/factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of repetition factors, or a repetition factor) is used/assumed for the scheduling DCI format (current DCI format or new DCI format) of the corresponding HARQ process(es).

DCI format N0_X may include a first segmented repetition number (DCI format to indicate a number of first segmented repetitions). The repetitions may be splitted into two (or more) segmented transmissions (e.g., first segmented repetitions and second segmented repetitions) due to the switch of service satellites and/or validity timer expiration. This DCI field may indicate the number of the first segmented repetitions. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors/numbers. For example, if dynamic indication of segmented repetition number is not enabled and/or segmentation is not enabled/applied, configured and/or supported, the number of bits in this field is 0 or this bit field is absent in DCI. If dynamic indication of segmented repetition number is enabled, configured and/or supported, and/or the number of segmented repetition factors/number in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N0_X and this field provides first segmented repetition number, UE performs the first segmented repetitions according to information from this field (e.g., the number of the first segmented repetitions is given by the DCI field, first segmented repetition number) and information/parameters provided/configured for the first segmented repetitions, e.g., current information/parameters (provided by L1 signaling, e.g., PDCCH, and/or L2 signaling, e.g., MAC CE, and/or higher layer configuration, e.g., RRC message) for transmissions before satellite switching and/or validity timer expiration.

DCI format N0_X may include a second segmented repetition number (DCI format to indicate a number of second segmented repetitions). The repetitions may be splitted into two (or more) segmented transmissions (e.g., first segmented repetitions and second segmented repetitions) due to the switch of service satellites and/or validity timer expiration. This DCI field may indicate the number of the second segmented repetitions. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors/numbers. For example, if dynamic indication of segmented repetition number is not enabled and/or segmentation is not enabled/applied, configured and/or supported, the number of bits in this field is 0 or this bit field is absent in DCI. If dynamic indication of segmented repetition number is enabled, configured and/or supported, and/or the number of segmented repetition factors/number in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. A selection(s) of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In yet another design, this field may not be presented/configured/provided, and the second segmented repetition number is determined by the repetition factor (repetition number), e.g., DCI field mentioned above, and the first segmented repetition number, e.g. the second segmented repetition number equals the repetition factor (repetition number) minus the first segmented repetition number. In case that UE detects the DCI format N0_X and this field provides second segmented repetition number, or UE calculates second segmented repetition number as mentioned above, the UE performs the second segmented repetitions according to information from this field (or derived from the repetition factor (repetition number) and the first segmented repetition number) and information/parameters provided/configured for the second segmented repetitions, e.g., updated information/parameters (provided by L1 signaling, e.g., PDCCH, and/or L2 signaling, e.g., MAC CE, and/or higher layer configuration, e.g., RRC message) for transmissions after satellite switching and/or validity timer expiration.

DCI format N0_X may include a fraction factor. The repetitions may be splitted into two (or more) segmented transmissions due to the switch of service satellites and/or validity timer expiration. This DCI field may indicate a fraction of repetitions (e.g., a percentage or a subset of the repetitions), e.g., the first segmented repetitions (or second segmented repetitions). The number of the first (or second) segmented repetitions may be calculated based on the repetition factor/number and the fraction factor. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of fraction factors. For example, if dynamic indication of fraction factor and/or segmented repetition number is not enabled and/or segmentation is not enabled/applied, configured and/or supported, the number of bits in this field is 0 or this bit field is absent in DCI. If dynamic indication of fraction factor and/or segmented repetition number is enabled, configured and/or supported, and/or the number of fraction factors in the configured and/or predefined set is 4 (e.g., {⅛, ¼, ½, ¾}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N0_X and this field provides fraction fractor, UE performs the first segmented repetitions (and/or the second segmented repetitions) according to information from this field and information/parameters provided/configured for the first segmented repetitions, e.g., current information/parameters before satellite switching and/or validity timer expiration (or information/parameters provided/configured for the second segmented repetitions, e.g., updated information/parameters after satellite switching and/or validity timer expiration).

DCI format N0_X may include a priority indication. The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of priority levels and or the number of configured and/or predefined priority levels. For example, if PUSCH prioritization is not enabled, configured and/or supported, the number of bits in this field is 0 or this bit field is absent in DCI. If the number of configured and/or predefined PUSCH priority levels is 4 (e.g., {0, 1, 2, 3}), the number of bits in this field may be 2. Any of the high layer parameters, sets and/or tables used to determine the number of bits in this field may be commonly configured for DCI format N0_X and other DCI formats, or separately configured for DCI format N0_X. In other words, parameter(s), table(s) and/or set(s) configured for other DCI format(s) field size determination may be also used to determine the number of bits in the corresponding bit field for DCI format N0_X, or parameter(s), table(s) and/or set(s) used to determine the number of bits in the corresponding bit field for DCI format N0_X may be configured separately. For example, the field size may be 0 bit if higher layer parameter (e.g., PriorityIndicator-ForDCIFormatN0_X) is not configured; otherwise the field size may be a value (e.g., 1 bit) provided by the higher layer parameter (e.g., PriorityIndicator-ForDCIFormatN0_X). The priority indication may be used to indicate whether HARQ feedback is enabled or disabled for a HARQ process. For example, if 1-bit priority indication field indicates 0 (or 1), the HARQ feedback is enabled for the corresponding HARQ process; if 1-bit priority indication field indicates 1 (or 0), the HARQ feedback is disabled for the corresponding HARQ process. The field size may be 0 bit if HARQ feedback is disabled as mentioned above. For example, if HARQ feedback is disabled for a HARQ process(es) (by RRC configuration), the priority indication filed may be absent or 0 bit for the scheduling DCI format (current DCI format or new DCI format) of the corresponding HARQ process(es). In yet another design, the field size may be 0 bit if HARQ feedback is enabled as mentioned above. For example, if HARQ feedback is enabled for a HARQ process(es) (by RRC configuration), the priority indication filed may be absent or 0 bit for the scheduling DCI format (current DCI format or new DCI format) of the corresponding HARQ process(es). Bit(s) or part of bits of the priority indication field for the scheduling DCI format (current DCI format or new DCI format) may be reused/reinterpreted to indicated HARQ process number with the HARQ process number field, e.g., 1 bit of priority indication field and 1 bit of HARQ process field can be used to indicate up to 4 HARQ processes.

DCI format N0_X may include a new data indicator (NDI). The number of bits in this bit field may be 1 bit or other number of bits. The number of bits in this bit field may be fixed in spec. The number of bits in this bit field may be determined by higher layer (e.g., RRC configuration, an explicit high layer parameter) or fixed in the spec. The number of bits in this bit field may be determined by the satellite type and/or network type (i.e. TN or NTN). The number of bits in this bit field may be determined by a mechanism for disabling/enabling HARQ feedback. The field size may be 0 bit if HARQ feedback is disabled as mentioned above. For example, if HARQ feedback is disabled for a HARQ process(es) (by RRC configuration), the NDI filed may be absent or 0 bit for the scheduling DCI format (current DCI format or new DCI format) of the corresponding HARQ process(es). Bit(s) or part of bits of the NDI field for the scheduling DCI format (current DCI format or new DCI format) may be reused/reinterpreted to indicated HARQ process number with the HARQ process number field, e.g., 1 bit of NDI field and 1 bit of HARQ process field can be used to indicate up to 4 HARQ processes.

DCI format N0_X may include a redundancy version (RV). The number of bits in this bit field may be 1, 2 bits or other number of bits. The number of bits in this bit field may be fixed in spec. The number of bits in this bit field may be determined by higher layer (e.g., RRC configuration, an explicit high layer parameter) or fixed in the spec. The number of bits in this bit field may be determined by the satellite type and/or network type (i.e. TN or NTN). The number of bits in this bit field may be determined by a mechanism for disabling/enabling HARQ feedback. The field size may be 0 bit if HARQ feedback is disabled as mentioned above. For example, if HARQ feedback is disabled for a HARQ process(es) (by RRC configuration), the RV filed may be absent or 0 bit for the scheduling DCI format (current DCI format or new DCI format) of the corresponding HARQ process(es). Bit(s) or part of bits of the RV field for the scheduling DCI format (current DCI format or new DCI format) may be reused/reinterpreted to indicated HARQ process number with the HARQ process number field, e.g., 1 bit of RV field and 1 bit of HARQ process field can be used to indicate up to 4 HARQ processes. In case that RV field is not used to indicate the RV of corresponding/scheduled PUSCH transmission(s), a predefined/fixed/default RV or RV sequence is used by the corresponding/scheduled PUSCH transmission(s).

DCI format N0_X may include a frequency domain resource assignment. The number of bits in this bit field may be 0-6 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of RBGs, resource allocation type, granularity by high layer (e.g., RRC configuration). Any of the high layer parameters (e.g., configured number of RBGs, resource allocation type, granularity) used to determine the number of bits in this field may be commonly configured for DCI format N0_X and other DCI formats, or separately configured for DCI format N0_X. In other words, parameter(s) (e.g., number of RBGs, resource allocation type, granularity) configured for other DCI format(s) field size determination may be also applied to the corresponding bit field for DCI format N0_X, or parameter(s) and/or table(s) used to determine the number of bits in the corresponding bit field for DCI format N0_X may be configured separately. For example, the bitwidth for this field is determined by higher layer parameters number of RBGs, resource allocation type, granularity (e.g., ResourceAllocationType1-granularity-ForDCIFormatN0_X). The selection of parameter(s) and/or table(s) for frequency domain resource assignment may be determined by a mechanism for disabling/enabling HARQ feedback. For example, if HARQ feedback is disabled for a HARQ process(es) (by RRC configuration), an NTN frequency domain resource assignment table/set/parameter (e.g., a fine or coarse granularity) is used/assumed for the scheduling DCI format (current DCI format or new DCI format) of the corresponding HARQ process(es).
DCI format N0_X may include a time domain resource assignment. The number of bits in this bit field may be 0-6 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of entries in the time domain resource assignment table configured by high layer (e.g., RRC configuration) or a defaulted time domain resource assignment table. Any of the high layer parameters (e.g., configured time domain resource assignment table, defaulted and/or predefined time domain resource assignment table) used to determine the number of bits in this field may be commonly configured for DCI format N0_X and other DCI formats, or separately configured for DCI format N0_X. In other words, parameter(s) (e.g., time domain resource assignment table configured by high layer) configured for other DCI format(s) field size determination may be also applied to the corresponding bit field for DCI format N0_X, or parameter(s) and/or table(s) used to determine the number of bits in the corresponding bit field for DCI format N0_X may be configured separately. For example, The bitwidth for this field is determined as ┌log₂(I)┐ bits, where I is the number of entries in the dedicated higher layer parameter (e.g., PUSCH-TimeDomainResourceAllocationList-ForDCIformatN0_X) if the dedicated higher layer parameter is configured, or I is the number of entries in the common higher layer parameter (e.g., PUSCH-TimeDomainResourceAllocationList) if the common higher layer parameter (e.g., PUSCH-TimeDomainResourceAllocationList) is configured and the dedicated higher layer parameter (e.g., PUSCH-TimeDomainResourceAllocationList-ForDCIformatN0_X) is not configured; otherwise I is the number of entries in the default table. The selection of parameter(s), table(s) and/or set(s) for time domain resource assignment may be determined by a mechanism for disabling/enabling HARQ feedback. For example, if HARQ feedback is disabled for a HARQ process(es) (by RRC configuration), a new table (e.g., PUSCH-TimeDomainResourceAllocationList-ForDCIformatN0_X) is used/assumed for the scheduling DCI format (current DCI format or new DCI format) of the corresponding HARQ process(es).
   DCI format N0_X may include a resource assignment. The number of bits in this bit field may be 0-6 bits. This field may indicate time domain resource and/or frequency domain resource. A set of time domain resources and/or frequency domain resources may be provided/configured by a RRC message/signaling and this DCI field may indicated one of the resource from the set. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of RBGs, resource allocation type, granularity by high layer (e.g., RRC configuration). Any of the high layer parameters (e.g., configured number of RBGs, resource allocation type, granularity) used to determine the number of bits in this field may be commonly configured for DCI format N0_X and other DCI formats, or separately configured for DCI format N0_X. In other words, parameter(s) (e.g., number of RBGs, resource allocation type, granularity) configured for other DCI format(s) field size determination may be also applied to the corresponding bit field for DCI format N0_X, or parameter(s) and/or table(s) used to determine the number of bits in the corresponding bit field for DCI format N0_X may be configured separately. For example, the bitwidth for this field is determined by higher layer parameters number of RBGs, resource allocation type, granularity (e.g., ResourceAllocationType1-granularity-ForDCIFormatN0_X). The selection of parameter(s) and/or table(s) for frequency domain resource assignment may be determined by a mechanism for disabling/enabling HARQ feedback. For example, if HARQ feedback is disabled for a HARQ process(es) (by RRC configuration), an NTN frequency domain resource assignment table/set/parameter (e.g., a fine or coarse granularity) is used/assumed for the scheduling DCI format (current DCI format or new DCI format) of the corresponding HARQ process(es).

DCI format N0_X may include a HARQ process number. The number of bits in this bit field may be 0-5 bits, or 6 bits (in case that up to 64 HARQ processes are supported), 7 bits (in case that up to 128 HARQ processes are supported), or larger number of bits. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of HARQ processes (or HARQ processes with enabled HARQ feedback, or HARQ processes with disabled HARQ feedback). For example, if the number of HARQ processes (or HARQ processes with enabled HARQ feedback, or HARQ processes with disabled HARQ feedback) is larger than 4, the number of bits in this field may be 3. Any of the high layer parameters used to determine the number of bits in this field may be commonly configured for DCI format N0_X and other DCI formats, or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be a value (e.g., 0, 1, 2, 3, 4, 5 bits, or 6, 7 bits, or larger number of bits) determined by higher layer parameter (e.g., ProcessNumberSizeForDCI-ForDCIFormatN0_X).

DCI format N0_X may include downlink assignment index (DAI). The number of bits in this bit field may be 0-4 bits. The number of bits in this bit field may be determined by higher layer (e.g., RRC configuration, an explicit high layer parameter). The number of bits in this bit field may be determined by configured waveform (e.g., whether transform precoder is enabled or not). The number of bits in this bit field may be determined by the satellite type and/or network type (i.e. TN or NTN). The number of bits in this bit field may be determined by a mechanism for disabling/enabling HARQ feedback. The number of bits in this bit field may be determined by DMRS type, HARQ-ACK codebook (e.g., whether it is semi-static HARQ-ACK codebook or dynamic HARQ-ACK codebook, whether the dynamic HARQ-ACK codebook is with two HARQ-ACK sub-codebooks), rank, codebook and/or any other related high layer parameters. Any of the high layer parameters used to determine the number of bits in this field may be commonly configured for DCI format N0_X and other DCI formats, or separately configured for DCI format N_X. In other words, parameter(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field may be 0 bit if a higher layer parameter (e.g., downlinkAssignmentlndexForDCI-FormatN0-X) is not configured. If the higher layer parameter (e.g., AntennaPorts-Field-Presence-ForDCIFormatN0_X) is configured, the field size may be a value (e.g., 1, 2, 4) defined in the spec, or determined by other higher layer parameters, e.g., transform precoder enabler, DMRS type, HARQ-ACK codebook (e.g., whether it is semi-static HARQ-ACK codebook or dynamic HARQ-ACK codebook, whether the dynamic HARQ-ACK codebook is with two HARQ-ACK sub-codebooks), max length, codebook, mapping type (e.g., dmrs-UplinkForPUSCH-MappingTypeA-ForDCIFormatN0_X and/or dmrs-UplinkForPUSCH-MappingTypeB-ForDCIFormatN0_X). Bit(s) or part of bits of the DAI field for the scheduling DCI format (current DCI format or new DCI format) may be reused/reinterpreted to indicated HARQ process number with the HARQ process number field, e.g., 1 bit of DAI field and 1 bit of HARQ process field can be used to indicate up to 4 HARQ processes.

DCI format N0_X may include a ACK or Fallback indicator. The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. If HARQ feedback is disabled, this field may be absent or field size is 0 bit. If this field is configured/fixed/provided as 1 bit, 1 bit, value 0 indicates ACK and value 1 indicates fallback.

DCI format N0_X may include a Timing advance adjustment. The number of bits in this bit field may be 0-6 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. The field may be only present if ACK or Fallback indicator is set to 0.
DCI format N0_X may include a Scheduling delay. The number of bits in this bit field may be 0-5 bits, or more bits to overcome the large RTT in NTN. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of scheduling delays, e.g. ┌log₂(number of scheduling delays)┐. For example, if the number of scheduling delays is larger than 4 (e.g. 5), the number of bits in this field may be 3 (e.g., ┌log₂(5)┐). Any of the high layer parameters used to determine the number of bits in this field may be commonly configured for DCI format N0_X and other DCI formats (e.g. DCI format N0), or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be a value (e.g., 0, 1, 2, 3, 4, 5 bits, or 6, 7 bits, or larger number of bits) determined by higher layer parameter (e.g., ScheculingDelaySizeForDCI-ForDCIFormatN0_X).
   DCI format N0_X may include a Scheduling delay offset. The number of bits in this bit field may be 0-5 bits, or more bits to overcome the large RTT in NTN. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of scheduling delays. For example, if the number of scheduling delays is larger than 4, the number of bits in this field may be 3. Any of the high layer parameters used to determine the number of bits in this field may be commonly configured for DCI format N0_X and other DCI formats (e.g. DCI format N0), or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. For example, the field size may be a value (e.g., 0, 1, 2, 3, 4, 5 bits, or 6, 7 bits, or larger number of bits) determined by higher layer parameter (e.g., ScheculingDelayOffsetSizeForDCI-ForDCIFormatN0_X). The scheduling delay offset and the scheduling delay may be combined to determine the start time of NPUSCH transmission. In case that UE detects the DCI format N0_X and this field provides scheduling delay, UE performs the first scheduled NPUSCH transmission(s) according to information from this field and the scheduling delay.

DCI format N0_X may include a Resource reservation. The number of bits in this bit field may be 0-6 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N0_X and other DCI formats (e.g. DCI format N0), or separately configured for DCI format N0_X. In other words, parameter(s) and/or table(s) configured for other DCI format(s) field size determination may be also used to determine the number of bits in the corresponding bit field for DCI format N0_X, or parameter(s) used to determine the number of bits in the corresponding bit field for DCI format N0_X may be configured separately. The field may be only present if ACK or Fallback indicator is set to 0. This field may only be present if higher layer parameter resourceReservationConfigUL is configured and the DCI is mapped onto the UE-specific search space given by C-RNTI.

In yet another implementation, a new DCI format may not be introduced, but modifications and/or enhancements of current DCI format(s) may be used to schedule PUSCH for NTN. Reinterpretation of field(s) in current DCI format (e.g., DCI format 0_0 or DCI format 0_1, or DCI format 0_2) may be applied to provide necessary information to schedule PUSCH for NTN.

Bit(s) or subset of bits of one or more bit fields (e.g., flag for NTN/non-NTN differentiation, validity timer, segmented repetitions, HARQ/ACK enabler, NPUSCH repetition adjustment, Scheduling delay, Scheduling delay offset, antenna port(s), transmission configuration indication, rate matching indicator, SRS request, PRB bundling size indicator, carrier indicator, CSI request, ZP CSI-RS triggering, beta offset indicator, SRS resource indicator, repetition factor, priority indication, HARQ process number and so on) in DCI format N0 (or DCI format N1 or DCI format N2) may be reinterpreted/reused as a different bit field(s) (e.g., flag for NTN/non-NTN differentiation, validity timer, segmented repetitions, HARQ/ACK enabler, NPUSCH repetition adjustment, Scheduling delay, antenna port(s), transmission configuration indication, rate matching indicator, SRS request, PRB bundling size indicator, carrier indicator, CSI request, ZP CSI-RS triggering, beta offset indicator, SRS resource indicator, repetition factor, priority indication, HARQ process number, first segmented repetition number, second segmented repetition number, fraction factor, delay offset, Scheduling delay offset, and so on.) if the reinterpretation is RRC configured, indicated explicitly or implicitly.

Existing DCI formats (e.g., DCI format N0, DCI format N1, DCI format N2) may be used to schedule PUSCH for NTN. The field size of each field in the existing DCI format(s) may be determined by separate RRC parameter dedicated for NTN as mentioned above (DCI field determination for DCI format N0_X). The DCI format N0_X described above may be renamed from the existing DCI format (e.g., DCI format N0, DCI format N1, DCI format N2) or alias of the existing DCI format (e.g., DCI format N0, DCI format N1, DCI format N2).

If existing DCI formats (e.g., DCI format N0, DCI format N1, DCI format N2) are used to schedule PUSCH for NTN, procedures/methods/mechanism for determination of DCI fields mentioned above (for new DCI format) may be applied to the existing DCI formats.

For NTN, the current DCI format (e.g., DCI format N1, DCI format N2) may not be supportive/suitable. One or more DCI fields may be necessary to be updated/modified in DCI (e.g., flag for NTN/non-NTN differentiation, validity timer, segmented repetitions, HARQ/ACK enabler, NPUSCH repetition adjustment, Scheduling delay, scheduling delay offset, antenna port(s), transmission configuration indication, rate matching indicator, SRS request, PRB bundling size indicator, carrier indicator, CSI request, ZP CSI-RS triggering, beta offset indicator, SRS resource indicator, repetition factor, priority indication, HARQ process number and so on). The number of bits of HARQ process number filed in DCI format N1 is 4. In this case, to indicate more than 16 HARQ processes, a new DCI format and/or current DCI format with modifications and/or enhancements may be introduced. The number of bits of Scheduling delay filed in DCI format N1 is 3. In this case, to indicate more than 8 scheduling delays to overcome the large RTT in NTN, a new DCI format and/or current DCI format with modifications and/or enhancements may be introduced. In addition, repetitions may be splitted into two (or more) segmented transmissions due to the switch of service satellites and/or validity timer expiration. a new DCI format and/or current DCI format with modifications and/or enhancements may be needed.

For downlink, to support NTN, similarly, a new DCI format and/or current DCI format with modifications and/or enhancements may be also introduced. The DL DCI may use the same and/or a common structure and/or implementation as the UL DCI mentioned above, or the DL DCI may be implemented separately.

In an implementation, a new DCI format (e.g., DCI format N1_X, specifications may use a different name) may be introduced. DCI format N1_X may be used for the scheduling of one NPDSCH codeword per TTI in one cell, random access procedure initiated by a NPDCCH order, notifying SC-MCCH change, and operation on preconfigured UL resources. The following information may be transmitted by means of the DCI format N1_X.

DCI format N1_X may include an identifier for DCI formats. The value of this field may be set to a predefined and/or defaulted value (e.g., 0 or 1), indicating a new/different DCI format (comparing to DCI format N0 and/or DCI format N1 and/or DCI format N2) for NTN.

DCI format N1_X may include an identifier for UL/DL DCI formats. The value of this field may be set to a predefined and/or defaulted value (e.g., 0 or 1), indicating an DL DCI format.

DCI format N1_X may include an identifier for NPDCCH order (e.g., NPDCCH order indicator). The value of this field may be set to a predefined and/or defaulted value (e.g., 0 or 1), indicating an NPDCCH order.

DCI format N1_X may include an identifier for disabling/enabling segmentation. The value of this field may be set to a predefined and/or defaulted value (e.g., 0 or 1), indicating a segmentation of long transmissions/repetitions happens or not. The repetitions may be splitted into two (or more) segmented transmissions due to the switch of service satellites and/or validity timer expiration. This field may indicate whether segmentation will happen during the long transmissions/repetitions or not. If this field is absent or this field indicates no segmentations, some DCI fields related to segmentation described below (e.g., first segmented repetition number, second segmented repetition number, fraction factor) may not be applied/configured/provided.

DCI format N1_X may include a validity timer (a DCI field to identify a timer). The repetitions/transmission(s) may be splitted into two (or more) segmented transmissions (e.g., first segmented repetitions and second segmented repetitions) due to the switch of service satellites and/or validity timer expiration. This DCI field may indicate a time window/period when information/parameters are valid and/or unchanged. The validity timer may indicate a start time, end time and/or a duration (e.g., the time window/period is determined by the start time and the end time provided by the DCI filed, or the time window/period is determined by the start time and the duration the DCI filed, or the DCI filed only indicates an end time). The validity timer may be measured/given in unit of slot, subframe, frame, sub-slot, mini-slot, ms, second, and so on. A set of validity timers may be provided/configured by a RRC message/signalling and this filed indicated one from the set. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of validity timer. For example, if dynamic indication of validity time is not enabled and/or segmentation is not enabled/applied, configured and/or supported, the number of bits in this field is 0 or this bit field is absent in DCI. If dynamic indication of validity timer is enabled, configured and/or supported, and/or the number of validity timer in the configured and/or predefined set is 4 (e.g., {1 s, 2 s, 4 s, 8 s}, {512 slots, 1024 slots, 2048 slots, 4096 slots}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N1_X and this field provides validity timer, UE performs the first segmented repetitions (and/or the second segmented repetitions) receptions according to information from this field (e.g., last slot/subframe used for the first segmented repetitions is indicated/derived by/from the DCI field, validity timer; start slot/subframe used for the second segmented repetitions is indicated/derived by/from the DCI field, validity timer) and information/parameters provided/configured for the first segmented repetitions, e.g., current information/parameters (provided by L1 signaling, e.g., PDCCH, and/or L2 signaling, e.g., MAC CE, and/or higher layer configuration, e.g., RRC message) for transmissions before satellite switching and/or validity timer expiration (or information/parameters provided/configured for the second segmented repetitions, e.g., updated information/parameters (provided by L1 signaling, e.g., PDCCH, and/or L2 signaling, e.g., MAC CE, and/or higher layer configuration, e.g., RRC message) for transmissions after satellite switching and/or validity timer expiration).

DCI format N1_X may include an identifier for disabling/enabling HARQ feedback. The value of this field may be set to a predefined and/or defaulted value (e.g., 0 or 1), indicating a disabling of HARQ feedback or enabling of HARQ feedback.

DCI format N1_X may include modulation and coding scheme (MCS) field. The bitwidth of the MCS filed may be 5 bits or a reduced size (e.g., 1, 2, 3, 4 bits) or a larger size (e.g., 6 bits). The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured MCS table (e.g., higher layer parameter mcs-Table). Any of the high layer parameters used to determine the number of bits in this field may be commonly configured for DCI format N1_X and other DCI formats, or separately configured for DCI format N1_X. In other words, parameter(s) configured for other DCI format(s) (e.g., DCI format N0 and/or DCI format N1 and/or DCI format N2) field size determination may be also used to determine the number of bits in the corresponding bit field for DCI format N1_X, or parameter(s) used to determine the number of bits in the corresponding bit field for DCI format N1_X may be configured separately. Existing MCS tables for current DCI formats (e.g., DCI format N0, DCI format N1, DCI format N2) may be reused/provided for DCI format N1_X, e.g., qam256 table, qam64 table or qam64LowSE table. A new MCS table may be configured/provided for DCI format N1_X separately, e.g., a new MCS table with 16 (or less than 16) rows or a new MCS table with 16 (or more than 16) rows. In yet another implementation, a truncated existing MCS table(s) may be used/configured/provided for DCI format N1_X. Namely, some of rows in the existing MCS table(s) for current DCI formats may be configured/provided for DCI format N1_X. The selection of MCS table may be determined by a mechanism for disabling/enabling HARQ feedback. For example, if HARQ feedback is disabled for a HARQ process(es) (by RRC configuration), the new MCS table (or qam256 table, qam64 table or qam64LowSE table) is used/assumed for the scheduling DCI format (current DCI format or new DCI format) of the corresponding HARQ process(es).

DCI format N1_X may include antenna ports. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by configured waveform (e.g., whether transform precoder is enabled or not). The number of bits in this bit field may be determined by the satellite type and/or network type (i.e. TN or NTN). The number of bits in this bit field may be determined by a mechanism for disabling/enabling HARQ feedback. The number of bits in this bit field may be determined by DMRS type, rank, codebook and/or any other related high layer parameters. Any of the high layer parameters used to determine the number of bits in this field may be commonly configured for DCI format N1_X and other DCI formats, or separately configured for DCI format N1_X. In other words, parameter(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field may be 0 bit if a higher layer parameter (e.g., AntennaPorts-FieldPresence-ForDCIFormatN1_X) is not configured. If the higher layer parameter (e.g., AntennaPorts-FieldPresence-ForDCIFormatN1_X) is configured, the field size may be a fixed value (e.g., 1, 2) defined in the spec, or determined by other higher layer parameters, e.g., transform precoder enabler, DMRS type, max length, codebook, mapping type (e.g., dmrs-DownlinkForPDSCH-MappingTypeA-ForDCIFormatN1_X and/or dmrsDownlinkForPDSCH-MappingTypeB-ForDCIFormatN1_X).

DCI format N1_X may include a transmission configuration indication. The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of multiple transmission configurations. For example, if multiple configurations of DL semi-persistent scheduling (SPS) are not enabled, the number of bits in this field is 0 or this bit field is absent in DCI. If the number of transmission configuration is 8, the number of bits in this field may be 3. If multiple transmission configurations are enabled and/or configured, only DCI format N1_X may be used to activate and/or deactivate corresponding SPS. Enabling/disabling on HARQ feedback for SPS transmission may be configurable per SPS configuration via UE specific RRC signaling.

DCI format N1_X may include an SRS request. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured carrier (e.g., whether SUL is configured or not). The number of bits in this bit field may be determined by a configured and/or predefined table and/or any other related high layer parameters. Any of the high layer parameters used to determine the number of bits in this field may be commonly configured for DCI format N1_X and other DCI formats, or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, For example, the field may be 0 bit if a higher layer parameter (e.g., SRSRequest-ForDCIFormatN1_X) is not configured. If the higher layer parameter (e.g., SRSRequest-ForDCIFormatN1_X) is configured, the field size may be provided/determined by the higher layer parameter (e.g., SRSRequest-ForDCIFormatN1_X). The field size may be a fixed value (e.g., 1, 2) defined in the spec. The field size may also be determined by other higher layer parameters, e.g., supplement uplink (e.g., supplementaryUplink in ServingCellConfig).

DCI format N1_X may include a carrier indication. The number of bits in this bit field may be 0-4 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of carriers. For example, if multiple carriers are not enabled and/or configured, the number of bits in this field is 0 or this bit field is absent in DCI. If the number of carriers is larger than 4, the number of bits in this field may be 3. Any of the high layer parameters used to determine the number of bits in this field may be commonly configured for DCI format N1_X and other DCI formats, or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2 or 3 bits) determined by higher layer parameter (e.g., CarrierIndicatorSize-ForDCIFormatN1_X).

DCI format N1_X may include a subcarrier indication. The number of bits in this bit field may be 0-6 (8) bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of subcarriers. For example, if multiple subcarriers are not enabled and/or configured, the number of bits in this field is 0 or this bit field is absent in DCI. Any of the high layer parameters used to determine the number of bits in this field may be commonly configured for DCI format N1_X and other DCI formats, or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5, 6, 7, 8 bits) determined by higher layer parameter (e.g., SubcarrierIndicatorSize-ForDCIFormatN1_X).

DCI format N1_X may include a carrier indication of NPRACH. The number of bits in this bit field may be 0-4 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of carriers. For example, if multiple carriers are not enabled and/or configured, the number of bits in this field is 0 or this bit field is absent in DCI. If the number of carriers is larger than 4, the number of bits in this field may be 3. Any of the high layer parameters used to determine the number of bits in this field may be commonly configured for DCI format N1_X and other DCI formats, or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2 or 3 bits) determined by higher layer parameter (e.g., CarrierIndicatorSize-ForDCIFormatN1_X). In case that NPDCCH order indicator indicates a PDCCH order (e.g. is set to ‘1’), this field may be used to indicate carrier of NPRACH.

DCI format N1_X may include a subcarrier indication of NPRACH. The number of bits in this bit field may be 0-6 (8) bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of subcarriers. For example, if multiple subcarriers are not enabled and/or configured, the number of bits in this field is 0 or this bit field is absent in DCI. Any of the high layer parameters used to determine the number of bits in this field may be commonly configured for DCI format N1_X and other DCI formats, or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5, 6, 7, 8 bits) determined by higher layer parameter (e.g., SubcarrierIndicatorSize-ForDCIFormatN1_X). In case that NPDCCH order indicator indicates a PDCCH order (e.g. is set to ‘1’), this field may be used to indicate sub-carrier of NPRACH.

DCI format N1_X may include a Preamble format indicator. This field may be 0-2 bits. In case that NPDCCH order indicator indicates a PDCCH order (e.g. is set to ‘1’), this field may be used to indicate the preamble format.

DCI format N1_X may include a rate matching indicator. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured rate matching pattern group(s) and/or any related high layer parameters. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. For example, the field size may be 0, 1, or 2 bits according to higher layer parameters rateMatchPatternGroup1-ForDCIFormatN1_X and rateMatchPatternGroup2-ForDCIFormatN1_X, where the MSB is used to indicate rateMatchPatternGroup1-ForDCIFormatN1_X and the LSB is used to indicate rateMatchPatternGroup2-ForDCIFormatN1_X when there are two groups.

DCI format N1_X may include a PRB bundling size indicator. The number of bits in this bit field may be 0-1 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured PRB bundling type (e.g., whether PRB bundling is configured or not, whether PRB bundling type is configured as static or dynamic). If PRB bundling is not configured or is set as static, the number of bits in this field is 0 or this bit field is absent in DCI. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. For example, the field size may be 0 bit if the higher layer parameter PRB bundling type (e.g., prb-BundlingType-ForDCIFormatN1_X) is not configured or is set to ‘static’, or 1 bit if the higher layer parameter PRB bundling type (e.g., prbBundlingType-ForDCIFormatN1_X) is set to ‘dynamic’.
DCI format N1_X may include ZP CSI-RS triggering. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of ZP CSI-RS resource sets configured in the higher layer parameter and/or any other related high layer parameters. Any of the high layer parameters used to determine the number of bits in this field may be commonly configured for DCI format N1_X and other DCI formats, or separately configured for DCI format N1_X. In other words, parameter(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the bitwidth for this field is determined as ┌log₂(n_{ZP}+1)┐ bits, where n_{ZP} is the number of aperiodic ZP CSI-RS resource sets configured by higher layer parameter aperiodic-ZP-CSI-RS-ResourceSetsToAddModList-ForDCIFormatN1_X. The field size may be 0 bit if HARQ feedback is disabled as mentioned above. For example, if HARQ feedback is disabled for a HARQ process(es) (by RRC configuration), the ZP CSI-RS triggering filed may be absent or 0 bit for the scheduling DCI format (current DCI format or new DCI format) of the corresponding HARQ process(es).
   DCI format N1_X may include a repetition factor (repetition number). The number of bits in this bit field may be 0-4 bits. (repetition number) The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors. For example, if dynamic indication of repetition factor is not enabled, configured and/or supported, the number of bits in this field is 0 or this bit field is absent in DCI. If dynamic indication of repetition factor is enabled, configured and/or supported, and/or the number of repetition factors in the configured and/or predefined set is 4 (e.g., {1, 2, 4, 8}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es).

DCI format N1_X may include a NPDSCH repetition adjustment. The number of bits in this bit field may be 0-4 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors. For example, if dynamic indication of repetition number/factor is not enabled, configured and/or supported, the number of bits in this field is 0 or this bit field is absent in DCI. If dynamic indication of repetition number/factor is enabled, configured and/or supported, and/or the number of repetition number/factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). This field may provide a updated repetition number when information/parameters for the transmissions may be changed. In case that UE detects the DCI format N1_X and this field provides NPDSCH repetition adjustment, UE performs the repetitions receptions according to information from this field.

DCI format N1_X may include a DCI subframe repetition number. The number of bits in this bit field may be 0-2 bits or larger. This field may indicate repetitions of NPDCCH/DCI. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition number/factors. For example, if dynamic indication of repetition number/factor is not enabled, configured and/or supported, the number of bits in this field is 0 or this bit field is absent in DCI. If dynamic indication of repetition number/factor is enabled, configured and/or supported, and/or the number of repetition number/factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es).

DCI format N1_X may include a first segmented repetition number (DCI format to indicate a number of first segmented repetitions). The repetitions may be splitted into two (or more) segmented transmissions (e.g., first segmented repetitions and second segmented repetitions) due to the switch of service satellites and/or validity timer expiration. This DCI field may indicate the number of the first segmented repetitions. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors/numbers. For example, if dynamic indication of segmented repetition number is not enabled and/or segmentation is not enabled/applied, configured and/or supported, the number of bits in this field is 0 or this bit field is absent in DCI. If dynamic indication of segmented repetition number is enabled, configured and/or supported, and/or the number of segmented repetition factors/number in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N1_X and this field provides first segmented repetition number, UE performs the first segmented repetitions receptions according to information from this field (e.g., the number of the first segmented repetitions is given by the DCI field, first segmented repetition number) and information/parameters provided/configured for the first segmented repetitions, e.g., current information/parameters (provided by L1 signaling, e.g., PDCCH, and/or L2 signaling, e.g., MAC CE, and/or higher layer configuration, e.g., RRC message) for transmissions before satellite switching and/or validity timer expiration.

DCI format N1_X may include a second segmented repetition number (DCI format to indicate a number of second segmented repetitions). The repetitions may be splitted into two (or more) segmented transmissions (e.g., first segmented repetitions and second segmented repetitions) due to the switch of service satellites and/or validity timer expiration. This DCI field may indicate the number of the second segmented repetitions. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors/numbers. For example, if dynamic indication of segmented repetition number is not enabled and/or segmentation is not enabled/applied, configured and/or supported, the number of bits in this field is 0 or this bit field is absent in DCI. If dynamic indication of segmented repetition number is enabled, configured and/or supported, and/or the number of segmented repetition factors/number in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In yet another design, this field may not be presented/configured/provided, and the second segmented repetition number is determined by the repetition factor-(repetition number) and the first segmented repetition number, e.g. the second segmented repetition number equals the repetition factor (repetition number) minus the first segmented repetition number. In case that UE detects the DCI format N1_X and this field provides second segmented repetition number, or UE calculates second segmented repetition number as mentioned above, the UE performs the second segmented repetitions receptions according to information from this field (or derived from the repetition factor (repetition number) and the first segmented repetition number) and information/parameters provided/configured for the second segmented repetitions, e.g., updated information/parameters (provided by L1 signaling, e.g., PDCCH, and/or L2 signaling, e.g., MAC CE, and/or higher layer configuration, e.g., RRC message) for transmissions after satellite switching and/or validity timer expiration.

DCI format N1_X may include a fraction factor. The repetitions may be splitted into two (or more) segmented transmissions due to the switch of service satellites and/or validity timer expiration. This DCI field may indicate a fraction of repetitions (e.g., a percentage or a subset of the repetitions), e.g., the first segmented repetitions (or second segmented repetitions). The number of the first (or second) segmented repetitions may be calculated based on the repetition factor and the fraction factor. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of fraction factors. For example, if dynamic indication of fraction factor and/or segmented repetition number is not enabled and/or segmentation is not enabled/applied, configured and/or supported, the number of bits in this field is 0 or this bit field is absent in DCI. If dynamic indication of fraction factor and/or segmentation is enabled, configured and/or supported, and/or the number of fraction factors in the configured and/or predefined set is 4 (e.g., {⅛, ¼, ½, ¾}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N1_X and this field provides fraction fractor, UE performs the first segmented repetitions (and/or the second segmented repetitions) receptions according to information from this field and information/parameters provided/configured for the first segmented repetitions, e.g., current information/parameters before satellite switching and/or validity timer expiration (or information/parameters provided/configured for the second segmented repetitions, e.g., updated information/parameters after satellite switching and/or validity timer expiration).

DCI format N1_X may include a priority indication. The number of bits in this bit field may be 0-3 bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of priority levels and or the number of configured and/or predefined priority levels. For example, if PDSCH prioritization is not enabled, configured and/or supported, the number of bits in this field is 0 or this bit field is absent in DCI. If the number of configured and/or predefined PDSCH priority levels is 4 (e.g., {0, 1, 2, 3}), the number of bits in this field may be 2. Any of the high layer parameters, sets and/or tables used to determine the number of bits in this field may be commonly configured for DCI format N1_X and other DCI formats, or separately configured for DCI format N1_X. In other words, parameter(s), table(s) and/or set(s) configured for other DCI format(s) field size determination may be also used to determine the number of bits in the corresponding bit field for DCI format N1_X, or parameter(s), table(s) and/or set(s) used to determine the number of bits in the corresponding bit field for DCI format N1_X may be configured separately. For example, the field size may be 0 bit if higher layer parameter (e.g., PriorityIndicatorForDCIFormatN1_X) is not configured; otherwise the field size may be a value (e.g., 1 bit) provided by the higher layer parameter (e.g., PriorityIndicator-ForDCIFormatN1_X). The priority indication may be used to indicate whether HARQ feedback is enabled or disabled for a HARQ process. For example, if 1-bit priority indication field indicates 0 (or 1), the HARQ feedback is enabled for the corresponding HARQ process; if 1-bit priority indication field indicates 1 (or 0), the HARQ feedback is disabled for the corresponding HARQ process. The field size may be 0 bit if HARQ feedback is disabled as mentioned above. For example, if HARQ feedback is disabled for a HARQ process(es) (by RRC configuration), the priority indication filed may be absent or 0 bit for the scheduling DCI format (current DCI format or new DCI format) of the corresponding HARQ process(es). In yet another design, the field size may be 0 bit if HARQ feedback is enabled as mentioned above. For example, if HARQ feedback is enabled for a HARQ process(es) (by RRC configuration), the priority indication filed may be absent or 0 bit for the scheduling DCI format (current DCI format or new DCI format) of the corresponding HARQ process(es). Bit(s) or part of bits of the priority indication field for the scheduling DCI format (current DCI format or new DCI format) may be reused/reinterpreted to indicated HARQ process number with the HARQ process number field, e.g., 1 bit of priority indication field and 1 bit of HARQ process field can be used to indicate up to 4 HARQ processes.

DCI format N1_X may include a new data indicator (NDI). The number of bits in this bit field may be 1 bit or other number of bits. The number of bits in this bit field may be determined by higher layer (e.g., RRC configuration, an explicit high layer parameter) or fixed in the spec. The number of bits in this bit field may be determined by the satellite type and/or network type (i.e. TN or NTN). The number of bits in this bit field may be determined by a mechanism for disabling/enabling HARQ feedback. The field size may be 0 bit if HARQ feedback is disabled as mentioned above. For example, if HARQ feedback is disabled for a HARQ process(es) (by RRC configuration), the NDI filed may be absent or 0 bit for the scheduling DCI format (current DCI format or new DCI format) of the corresponding HARQ process(es). Bit(s) or part of bits of the NDI field for the scheduling DCI format (current DCI format or new DCI format) may be reused/reinterpreted to indicated HARQ process number with the HARQ process number field, e.g., 1 bit of NDI field and 1 bit of HARQ process field can be used to indicate up to 4 HARQ processes.

DCI format N1_X may include a redundancy version (RV). The number of bits in this bit field may be 2 bits or other number of bits. The number of bits in this bit field may be determined by higher layer (e.g., RRC configuration, an explicit high layer parameter) or fixed in the spec. The number of bits in this bit field may be determined by the satellite type and/or network type (i.e. TN or NTN). The number of bits in this bit field may be determined by a mechanism for disabling/enabling HARQ feedback. The field size may be 0 bit if HARQ feedback is disabled as mentioned above. For example, if HARQ feedback is disabled for a HARQ process(es) (by RRC configuration), the RV filed may be absent or 0 bit for the scheduling DCI format (current DCI format or new DCI format) of the corresponding HARQ process(es). Bit(s) or part of bits of the RV field for the scheduling DCI format (current DCI format or new DCI format) may be reused/reinterpreted to indicated HARQ process number with the HARQ process number field, e.g., 1 bit of RV field and 1 bit of HARQ process field can be used to indicate up to 4 HARQ processes. In case that RV field is not used to indicate the RV of corresponding/scheduled NPDSCH transmission(s), a predefined/fixed/default RV or RV sequence is used by the corresponding/scheduled NPDSCH transmission(s).

DCI format N1_X may include a frequency domain resource assignment. The number of bits in this bit field may be 0-6 bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of RBGs, resource allocation type, granularity by high layer (e.g., RRC configuration). Any of the high layer parameters (e.g., configured number of RBGs, resource allocation type, granularity) used to determine the number of bits in this field may be commonly configured for DCI format N1_X and other DCI formats, or separately configured for DCI format N1_X. In other words, parameter(s) (e.g., number of RBGs, resource allocation type, granularity) configured for other DCI format(s) field size determination may be also applied to the corresponding bit field for DCI format N1_X, or parameter(s) and/or table(s) used to determine the number of bits in the corresponding bit field for DCI format N1_X may be configured separately. For example, The bitwidth for this field is determined by higher layer parameters number of RBGs, resource allocation type, granularity (e.g., ResourceAllocationType1-granularity-ForDCIFormatN1_X). The selection of parameter(s) and/or table(s) for frequency domain resource assignment may be determined by a mechanism for disabling/enabling HARQ feedback. For example, if HARQ feedback is disabled for a HARQ process(es) (by RRC configuration), an NTN frequency domain resource assignment table/set/parameter (e.g., a fine or coarse granularity) is used/assumed for the scheduling DCI format (current DCI format or new DCI format) of the corresponding HARQ process(es).
DCI format N1_X may include a time domain resource assignment. The number of bits in this bit field may be 0-6 bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of entries in the time domain resource assignment table configured by high layer (e.g., RRC configuration) or a defaulted time domain resource assignment table. Any of the high layer parameters (e.g., configured time domain resource assignment table, defaulted and/or predefined time domain resource assignment table) used to determine the number of bits in this field may be commonly configured for DCI format N1_X and other DCI formats, or separately configured for DCI format N1_X. In other words, parameter(s) (e.g., time domain resource assignment table configured by high layer) configured for other DCI format(s) field size determination may be also applied to the corresponding bit field for DCI format N1_X, or parameter(s) and/or table(s) used to determine the number of bits in the corresponding bit field for DCI format N1_X may be configured separately. For example, The bitwidth for this field is determined as ┌log₂(I)┐ bits, where I is the number of entries in the dedicated higher layer parameter (e.g., PDSCH-TimeDomainResourceAllocationList-ForDCIformatN1_X) if the dedicated higher layer parameter is configured, or I is the number of entries in the common higher layer parameter (e.g., PDSCH-TimeDomainResourceAllocationList) if the common higher layer parameter (e.g., PDSCH-TimeDomainResourceAllocationList) is configured and the dedicated higher layer parameter (e.g., PDSCH-TimeDomainResourceAllocationList-ForDCIformatN1_X) is not configured; otherwise I is the number of entries in the default table. The selection of parameter(s), table(s) and/or set(s) for time domain resource assignment may be determined by a mechanism for disabling/enabling HARQ feedback. For example, if HARQ feedback is disabled for a HARQ process(es) (by RRC configuration), a new table (e.g., PUSCH-TimeDomainResourceAllocationList-ForDCIformatN1_X) is used/assumed for the scheduling DCI format (current DCI format or new DCI format) of the corresponding HARQ process(es).
   DCI format N1_X may include a resource assignment. The number of bits in this bit field may be 0-6 bits. This field may indicate time domain resource and/or frequency domain resource. A set of time domain resources and/or frequency domain resources may be provided/configured by a RRC message/signaling and this DCI field may indicated one of the resource from the set. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of RBGs, resource allocation type, granularity by high layer (e.g., RRC configuration). Any of the high layer parameters (e.g., configured number of RBGs, resource allocation type, granularity) used to determine the number of bits in this field may be commonly configured for DCI format N1_X and other DCI formats, or separately configured for DCI format N1_X. In other words, parameter(s) (e.g., number of RBGs, resource allocation type, granularity) configured for other DCI format(s) field size determination may be also applied to the corresponding bit field for DCI format N1_X, or parameter(s) and/or table(s) used to determine the number of bits in the corresponding bit field for DCI format N1_X may be configured separately. For example, the bitwidth for this field is determined by higher layer parameters number of RBGs, resource allocation type, granularity (e.g., ResourceAllocationType1-granularity-ForDCIFormatN1_X). The selection of parameter(s) and/or table(s) for frequency domain resource assignment may be determined by a mechanism for disabling/enabling HARQ feedback. For example, if HARQ feedback is disabled for a HARQ process(es) (by RRC configuration), an NTN frequency domain resource assignment table/set/parameter (e.g., a fine or coarse granularity) is used/assumed for the scheduling DCI format (current DCI format or new DCI format) of the corresponding HARQ process(es).
DCI format N1_X may include PDSCH-to-HARQ_feedback timing indicator. The number of bits in this bit field may be 0-3 bits, 4 bits (in case that up to 16 PDSCH-to-HARQ_feedback timing K3 values are supported or RRC configured), or larger number of bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of K3 (i.e., delay between PDSCH reception and HARQ-ACK feedback) values configured in the higher layer parameter and/or any other related high layer parameters. Any of the high layer parameters used to determine the number of bits in this field may be commonly configured for DCI format N1_X and other DCI formats, or separately configured for DCI format N1_X. In other words, parameter(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the bitwidth for this field is determined as ┌log₂(I)┐ bits, where I is the number of entries in the higher layer parameter dl-DataToUL-ACK-ForDCIFormatN1_X If HARQ feedback is disabled for a HARQ process(es) (by RRC configuration), the PDSCH-to-HARQ_feedback timing indicator field may be 0 bit or absent for the scheduling DCI format (current DCI format or new DCI format) of the corresponding HARQ process(es). Bit(s) or part of bits of the PDSCH-to-HARQ_feedback timing indicator field for the scheduling DCI format (current DCI format or new DCI format) may be reused/reinterpreted to indicated HARQ process number with the HARQ process number field, e.g., 1 bit of PDSCH-to-HARQ_feedback timing indicator field and 1 bit of HARQ process field can be used to indicate up to 4 HARQ processes.
   DCI format N1_X may include NPUCCH resource indicator. The number of bits in this bit field may be 0-3 bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. Any of the high layer parameters used to determine the number of bits in this field may be commonly configured for DCI format N1_X and other DCI formats, or separately configured for DCI format N1_X. In other words, parameter(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the bitwidth for this field may be 0 or 1 or 2 or 3 bits determined by higher layer parameter Numberofbits-forPUCCHresourceindicator-ForDCIFormatN1_X. If HARQ feedback is disabled for a HARQ process(es) (by RRC configuration), the PUCCH resource indicator field may be 0 bit or absent for the scheduling DCI format (current DCI format or new DCI format) of the corresponding HARQ process(es). Bit(s) or part of bits of the PUCCH resource indicator field for the scheduling DCI format (current DCI format or new DCI format) may be reused/reinterpreted to indicated HARQ process number with the HARQ process number field, e.g., 1 bit of PUCCH resource indicator field and 1 bit of HARQ process field can be used to indicate up to 4 HARQ processes.

DCI format N1_X may include a HARQ process number. The number of bits in this bit field may be 0-5 bits, or 6 bits (in case that up to 64 HARQ processes are supported), 7 bits (in case that up to 128 HARQ processes are supported), or larger number of bits. The number of bits in this bit field may be determined by higher layer (e.g., RRC configuration, an explicit high layer parameter). The number of bits in this bit field may be fixed as 1 or 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of HARQ processes (or HARQ processes with enabled HARQ feedback, or HARQ processes with disabled HARQ feedback). For example, if the number of HARQ processes (or HARQ processes with enabled HARQ feedback, or HARQ processes with disabled HARQ feedback) is larger than 16, the number of bits in this field may be 5. Any of the high layer parameters used to determine the number of bits in this field may be commonly configured for DCI format 1_3 and other DCI formats, or separately configured for DCI format N1_X. In other words, parameter(s) and/or table(s) configured for other DCI format(s) (e.g., DCI format N0 and/or DCI format N1 and/or DCI format N2) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5 bits, or 6, 7 bits, or larger number of bits) determined by higher layer parameter (e.g., ProcessNumberSizeForDCI-ForDCIFormatN1_X).

DCI format N1_X may include downlink assignment index (DAI). The number of bits in this bit field may be 0-6 bits. The number of bits in this bit field may be determined by higher layer (e.g., RRC configuration, an explicit high layer parameter). The number of bits in this bit field may be determined by configured waveform (e.g., whether transform precoder is enabled or not). The number of bits in this bit field may be determined by the satellite type and/or network type (i.e. TN or NTN). The number of bits in this bit field may be determined by a mechanism for disabling/enabling HARQ feedback. The number of bits in this bit field may be determined by DMRS type, HARQ-ACK codebook (e.g., whether it is semi-static HARQ-ACK codebook or dynamic HARQ-ACK codebook, whether the dynamic HARQ-ACK codebook is with two HARQ-ACK sub-codebooks), rank, codebook and/or any other related high layer parameters. Any of the high layer parameters used to determine the number of bits in this field may be commonly configured for DCI format N1_X and other DCI formats, or separately configured for DCI format N1_X. In other words, parameter(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field may be 0 bit if a higher layer parameter (e.g., downlinkAssignmentIndexForDCI-Format1-3) is not configured. If the higher layer parameter (e.g., AntennaPorts-FieldPresence-ForDCIFormatN1_X) is configured, the field size may be a value (e.g., 1, 2, 4) defined in the spec, or determined by other higher layer parameters, e.g., transform precoder enabler, DMRS type, HARQ-ACK codebook (e.g., whether it is semi-static HARQ-ACK codebook or dynamic HARQ-ACK codebook, whether the dynamic HARQ-ACK codebook is with two HARQ-ACK sub-codebooks), max length, codebook, mapping type (e.g., dmrs-UplinkForPUSCH-MappingTypeA-ForDCIFormatN1_X and/or dmrs-UplinkForPUSCH-MappingTypeB-ForDCIFormatN1_X). If HARQ feedback is disabled for a HARQ process(es) (by RRC configuration), the DAI field may be 0 bit or absent for the scheduling DCI format (current DCI format or new DCI format) of the corresponding HARQ process(es). Bit(s) or part of bits of the DAI field for the scheduling DCI format (current DCI format or new DCI format) may be reused/reinterpreted to indicated HARQ process number with the HARQ process number field, e.g., 1 bit of DAI field and 1 bit of HARQ process field can be used to indicate up to 4 HARQ processes.

DCI format N1_X may include a Scheduling delay. The number of bits in this bit field may be 0-5 bits, or more bits to overcome the large RTT in NTN. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of scheduling delays. For example, if the number of scheduling delays is larger than 4, the number of bits in this field may be 3. Any of the high layer parameters used to determine the number of bits in this field may be commonly configured for DCI format N1_X and other DCI formats (e.g. DCI format N0), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5 bits, or 6, 7 bits, or larger number of bits) determined by higher layer parameter (e.g., ScheculingDelaySizeForDCI-ForDCIFormatN1_X).

DCI format N1_X may include a Scheduling delay offset. The number of bits in this bit field may be 0-5 bits, or more bits to overcome the large RTT in NTN. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of scheduling delays. For example, if the number of scheduling delays is larger than 4, the number of bits in this field may be 3. Any of the high layer parameters used to determine the number of bits in this field may be commonly configured for DCI format N1_X and other DCI formats (e.g. DCI format N0), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5 bits, or 6, 7 bits, or larger number of bits) determined by higher layer parameter (e.g., ScheculingDelayOffsetSizeForDCI-ForDCIFormatN1_X). The scheduling delay offset and the scheduling delay may be combined to determine the start time of NPDSCH transmission. In case that UE detects the DCI format N1_X and this field provides scheduling delay, UE performs the first scheduled NPDSCH transmission(s) according to information from this field and the scheduling delay.

DCI format N1_X may include a Starting number of NPRACH repetitions. The number of bits in this bit field may be 0-2 bits, or more bits to overcome the large RTT in NTN. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of scheduling delays. For example, if the number of scheduling delays is larger than 4, the number of bits in this field may be 3. Any of the high layer parameters used to determine the number of bits in this field may be commonly configured for DCI format N1_X and other DCI formats (e.g. DCI format N0), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5 bits, or 6, 7 bits, or larger number of bits) determined by higher layer parameter. In case that NPDCCH order indicator indicates a PDCCH order (e.g. is set to ‘1’), this field may be used to indicate Starting number of NPRACH repetitions.

DCI format N1_X may include a Starting offset of NPRACH repetitions. The number of bits in this bit field may be 0-2 bits, or more bits to overcome the large RTT in NTN. The number of bits in this bit field may be determined by higher layer (e.g., RRC configuration, an explicit high layer parameter). The number of bits in this bit field may be fixed as 2. The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured number of scheduling delays. For example, if the number of scheduling delays is larger than 4, the number of bits in this field may be 3. Any of the high layer parameters used to determine the number of bits in this field may be commonly configured for DCI format N1_X and other DCI formats (e.g. DCI format N0), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. For example, the field size may be a value (e.g., 0, 1, 2, 3, 4, 5 bits, or 6, 7 bits, or larger number of bits) determined by higher layer parameter. The start offset and the Starting number of NPRACH repetitions may be combined to determine the start time of NPRACH transmission. In case that UE detects the DCI format N1_X and this field provides Starting offset of NPRACH repetitions and/or NPDCCH order indicator indicates a PDCCH order (e.g. is set to ‘1’), UE performs the first scheduled NPRACH transmission(s) according to information from this field and the Starting number of NPRACH repetitions.

DCI format N1_X may include a Resource reservation. The number of bits in this bit field may be 0-6 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N1_X and other DCI formats (e.g. DCI format N1), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. This field may only be present if higher layer parameter resourceReservationConfigDL is configured and the DCI is mapped onto the UE-specific search space given by C-RNTI.

DCI format N1_X may include a Number of scheduled TB for SC-MTCH. The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N1_X and other DCI formats (e.g. DCI format N1), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. This field may be only present if multiple TBs for SC-MTCH are enabled/supported (e.g., higher layer parameter scmtch-InfoListMultiTB-r17 is enabled) and the CRC of the DCI is scrambled by G-RNTI.

DCI format N1_X may include a Number of scheduled TB for Unicast. The number of bits in this bit field may be 0-3 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N1_X and other DCI formats (e.g. DCI format N1), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. This field may be only present if multiple TBs for unicast are enabled/supported (e.g., higher layer parameter npdsch-MultiTB-Config is enabled) and the corresponding DCI is mapped onto the UE specific search space given by the C-RNTI.

DCI format N1_X may include an Information for SC-MCCH change notification. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N1_X and other DCI formats (e.g. DCI format N1), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately. The field may be only present if the DCI format N1_X CRC is scrambled by a G-RNTI.

DCI format N1_X may include a HARQ-ACK resource. The number of bits in this bit field may be 0-4 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N1_X and other DCI formats (e.g. DCI format N1), or separately configured for DCI format N1_X. In other words, parameter(s) and/or table(s) configured for other DCI format(s) field size determination may be also used to determine the number of bits in the corresponding bit field for DCI format N1_X, or parameter(s) used to determine the number of bits in the corresponding bit field for DCI format N1_X may be configured separately.

In yet another implementation, a new DL DCI format may not be introduced, but modifications and/or enhancements of current DCI format(s) may be needed to schedule PDSCH for NTN. Reinterpretation of field(s) in current DCI format (e.g., DCI format N1 or DCI format N2) may be applied to provide necessary information to schedule PDSCH for NTN.

Bit(s) or subset of bits of one or more bit fields (e.g., flag for NTN/non-NTN differentiation, validity timer, segmented repetitions, HARQ/ACK enabler, NPUSCH repetition adjustment, Scheduling delay, Scheduling delay offset, frequency domain resource assignment, time domain resource assignment, VRB-to-PRB mapping, modulation and coding scheme, new data indicator, redundancy version, HARQ process number, downlink assignment index, TPC command for scheduled PUCCH, PUCCH resource indicator, PDSCH-to-HARQ_feedback timing indicator, other fields as mentioned above, etc.) in DCI format N1 (or DCI format N0 or DCI format N2) may be reinterpreted/reused as a different bit field(s) (e.g., flag for NTN/non-NTN differentiation, validity timer, segmented repetitions, HARQ/ACK enabler, NPUSCH repetition adjustment, Scheduling delay, Scheduling delay offset, antenna port(s), transmission configuration indication, PRB bundling size indicator, carrier indicator, rate matching indicator, ZP CSI-RS trigger, SRS request, repetition factor, priority indication, HARQ process number, other fields as mentioned above, etc.) if the reinterpretation is RRC configured, indicated explicitly or implicitly.

Existing DCI formats (e.g., DCI format N0, DCI format N1, DCI format N2) may be used to schedule NPDSCH for NTN. The field size of each field in the existing DCI format(s) may be determined by separate RRC parameter dedicated for NTN as mentioned above (DCI field determination for DCI format N1_X). The DCI format N1_X described above may be renamed from the existing DCI format (e.g., DCI format N0, DCI format N1, DCI format N2) or alias of the existing DCI format (e.g., DCI format N0, DCI format N1, DCI format N2).

If existing DCI formats (e.g., DCI format N0, DCI format N1, DCI format N2) is used to schedule PDSCH for NTN, procedures/methods/mechanism for determination of DCI fields mentioned above (for new DCI format) may be applied to the existing DCI formats.

For NTN, the current DCI format (e.g., DCI format N2) may not be supportive/suitable. One or more DCI fields may be necessary to be updated/modified in DCI (e.g., flag for NTN/non-NTN differentiation, validity timer, segmented repetitions, HARQ/ACK enabler, NPUSCH repetition adjustment, Scheduling delay, scheduling delay offset, antenna port(s), transmission configuration indication, rate matching indicator, SRS request, PRB bundling size indicator, carrier indicator, CSI request, ZP CSI-RS triggering, beta offset indicator, SRS resource indicator, repetition factor, priority indication, HARQ process number and so on). To overcome the large RTT in NTN, a new DCI format and/or current DCI format with modifications and/or enhancements may be introduced. In addition, repetitions may be splitted into two (or more) segmented transmissions due to the switch of service satellites and/or validity timer expiration. a new DCI format and/or current DCI format with modifications and/or enhancements may be needed.

For downlink and/or paging, to support NTN, similarly, a new DCI format and/or current DCI format with modifications and/or enhancements may be also introduced. The DL DCI may use the same and/or a common structure and/or implementation as the UL DCI and/or DCI format N1_X mentioned above, or the DL DCI may be implemented separately.

In an implementation, a new DCI format (e.g., DCI format N2_X, specifications may use a different name) may be introduced. DCI format N2_X may be used for paging, direct indication, scheduling of one NPDSCH codeword carrying SC-MCCH in one cell, and notifying SC-MCCH change. The following information may be transmitted by means of the DCI format N2_X.

DCI format N2_X may include an identifier for DCI formats. The value of this field may be set to a predefined and/or defaulted value (e.g., 0 or 1), indicating a new/different DCI format (comparing to DCI format N0 and/or DCI format N1 and/or DCI format N2) for NTN.

DCI format N2_X may include an identifier for paging/direct indication differentiation. The value of this field may be set to a predefined and/or defaulted value (e.g., 0 or 1), indicating paging or Direct Indication.

DCI format N2_X may include an identifier for UL/DL DCI formats. The value of this field may be set to a predefined and/or defaulted value (e.g., 0 or 1), indicating an DL DCI format.

DCI format N2_X may include an identifier for disabling/enabling segmentation. The value of this field may be set to a predefined and/or defaulted value (e.g., 0 or 1), indicating a segmentation of long transmissions/repetitions happens or not. The repetitions may be splitted into two (or more) segmented transmissions due to the switch of service satellites and/or validity timer expiration. This field may indicate whether segmentation will happen during the long transmissions/repetitions or not. If this field is absent or this field indicates no segmentations, some DCI fields related to segmentation described below (e.g., first segmented repetition number, second segmented repetition number, fraction factor) may not be applied/configured/provided.

DCI format N2_X may include a validity timer (a DCI field to identify a timer). The repetitions/transmission(s) may be splitted into two (or more) segmented transmissions (e.g., first segmented repetitions and second segmented repetitions) due to the switch of service satellites and/or validity timer expiration. This DCI field may indicate a time window/period when information/parameters are valid and/or unchanged. The validity timer may indicate a start time, end time and/or a duration (e.g., the time window/period is determined by the start time and the end time provided by the DCI filed, or the time window/period is determined by the start time and the duration the DCI filed, or the DCI filed only indicates an end time). The validity timer may be measured/given in unit of slot, subframe, frame, sub-slot, mini-slot, ms, second, and so on. A set of validity timers may be provided/configured by a RRC message/signalling and this filed indicated one from the set. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of validity timer. For example, if dynamic indication of validity time is not enabled and/or segmentation is not enabled/applied, configured and/or supported, the number of bits in this field is 0 or this bit field is absent in DCI. If dynamic indication of validity timer is enabled, configured and/or supported, and/or the number of validity timer in the configured and/or predefined set is 4 (e.g., {1 s, 2 s, 4 s, 8 s}, {512 slots, 1024 slots, 2048 slots, 4096 slots}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N2_X and this field provides validity timer, UE performs the first segmented repetitions (and/or the second segmented repetitions) receptions according to information from this field (e.g., last slot/subframe used for the first segmented repetitions is indicated/derived by/from the DCI field, validity timer; start slot/subframe used for the second segmented repetitions is indicated/derived by/from the DCI field, validity timer) and information/parameters provided/configured for the first segmented repetitions, e.g., current information/parameters (provided by L1 signaling, e.g., PDCCH, and/or L2 signaling, e.g., MAC CE, and/or higher layer configuration, e.g., RRC message) for transmissions before satellite switching and/or validity timer expiration (or information/parameters provided/configured for the second segmented repetitions, e.g., updated information/parameters (provided by L1 signaling, e.g., PDCCH, and/or L2 signaling, e.g., MAC CE, and/or higher layer configuration, e.g., RRC message) for transmissions after satellite switching and/or validity timer expiration).

DCI format N2_X may include an identifier for disabling/enabling HARQ feedback. The value of this field may be set to a predefined and/or defaulted value (e.g., 0 or 1), indicating a disabling of HARQ feedback or enabling of HARQ feedback.

DCI format N2_X may include modulation and coding scheme (MCS) field. The bitwidth of the MCS filed may be 5 bits or a reduced size (e.g., 1, 2, 3, 4 bits) or a larger size (e.g., 6 bits). The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by configured MCS table (e.g., higher layer parameter mcs-Table). Any of the high layer parameters used to determine the number of bits in this field may be commonly configured for DCI format N2_X and other DCI formats, or separately configured for DCI format N2_X. In other words, parameter(s) configured for other DCI format(s) (e.g., DCI format N0 and/or DCI format N1 and/or DCI format N2) field size determination may be also used to determine the number of bits in the corresponding bit field for DCI format N2_X, or parameter(s) used to determine the number of bits in the corresponding bit field for DCI format N2_X may be configured separately. Existing MCS tables for current DCI formats (e.g., DCI format N0, DCI format N1, DCI format N2) may be reused/provided for DCI format N2_X, e.g., qam256 table, qam64 table or qam64LowSE table. A new MCS table may be configured/provided for DCI format N2_X separately, e.g., a new MCS table with 16 (or less than 16) rows or a new MCS table with 16 (or more than 16) rows. In yet another implementation, a truncated existing MCS table(s) may be used/configured/provided for DCI format N2_X. Namely, some of rows in the existing MCS table(s) for current DCI formats may be configured/provided for DCI format N2_X. The selection of MCS table may be determined by a mechanism for disabling/enabling HARQ feedback. For example, if HARQ feedback is disabled for a HARQ process(es) (by RRC configuration), the new MCS table (or qam256 table, qam64 table or qam64LowSE table) is used/assumed for the scheduling DCI format (current DCI format or new DCI format) of the corresponding HARQ process(es).

DCI format N2_X may include a repetition factor (repetition number). The number of bits in this bit field may be 0-4 bits. (repetition number) The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors. For example, if dynamic indication of repetition factor is not enabled, configured and/or supported, the number of bits in this field is 0 or this bit field is absent in DCI. If dynamic indication of repetition factor is enabled, configured and/or supported, and/or the number of repetition factors in the configured and/or predefined set is 4 (e.g., {1, 2, 4, 8}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es).

DCI format N2_X may include a DL repetition adjustment. The number of bits in this bit field may be 0-4 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors. For example, if dynamic indication of repetition number/factor is not enabled, configured and/or supported, the number of bits in this field is 0 or this bit field is absent in DCI. If dynamic indication of repetition number/factor is enabled, configured and/or supported, and/or the number of repetition number/factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). This field may provide a updated repetition number when information/parameters for the transmissions may be changed. In case that UE detects the DCI format N2_X and this field provides NPDSCH repetition adjustment, UE performs the repetitions receptions according to information from this field.

DCI format N2_X may include a DCI subframe repetition number. The number of bits in this bit field may be 0-2 bits or larger. This field may indicate reptitions of NPDCCH/DCI. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition number/factors. For example, if dynamic indication of repetition number/factor is not enabled, configured and/or supported, the number of bits in this field is 0 or this bit field is absent in DCI. If dynamic indication of repetition number/factor is enabled, configured and/or supported, and/or the number of repetition number/factors in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es).

DCI format N2_X may include a first segmented repetition number (DCI format to indicate a number of first segmented repetitions). The repetitions may be splitted into two (or more) segmented transmissions (e.g., first segmented repetitions and second segmented repetitions) due to the switch of service satellites and/or validity timer expiration. This DCI field may indicate the number of the first segmented repetitions. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors/numbers. For example, if dynamic indication of segmented repetition number is not enabled and/or segmentation is not enabled/applied, configured and/or supported, the number of bits in this field is 0 or this bit field is absent in DCI. If dynamic indication of segmented repetition number is enabled, configured and/or supported, and/or the number of segmented repetition factors/number in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N2_X and this field provides first segmented repetition number, UE performs the first segmented repetitions receptions according to information from this field (e.g., the number of the first segmented repetitions is given the DCI field, first segmented repetition number) and information/parameters provided/configured for the first segmented repetitions, e.g., current information/parameters (provided by L1 signaling, e.g., PDCCH, and/or L2 signaling, e.g., MAC CE, and/or higher layer configuration, e.g., RRC message) for transmissions before satellite switching and/or validity timer expiration.

DCI format N2_X may include a second segmented repetition number (DCI format to indicate a number of second segmented repetitions). The repetitions may be splitted into two (or more) segmented transmissions (e.g., first segmented repetitions and second segmented repetitions) due to the switch of service satellites and/or validity timer expiration. This DCI field may indicate the number of the second segmented repetitions. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of repetition factors/numbers. For example, if dynamic indication of segmented repetition number is not enabled and/or segmentation is not enabled/applied, configured and/or supported, the number of bits in this field is 0 or this bit field is absent in DCI. If dynamic indication of segmented repetition number is enabled, configured and/or supported, and/or the number of segmented repetition factors/number in the configured and/or predefined set is 4 (e.g., {1, 2, 4, 8}, {512, 1024, 2048, 4096}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In yet another design, this field may not be presented/configured/provided, and the second segmented repetition number is determined by the repetition factor (repetition number) and the first segmented repetition number, e.g. the second segmented repetition number equals the repetition factor-(repetition number) minus the first segmented repetition number. In case that UE detects the DCI format N2_X and this field provides second segmented repetition number, or UE calculates second segmented repetition number as mentioned above, the UE performs the second segmented repetitions receptions according to information from this field (or derived from the repetition factor (repetition number) and the first segmented repetition number) and information/parameters provided/configured for the second segmented repetitions, e.g., updated information/parameters (provided by L1 signaling, e.g., PDCCH, and/or L2 signaling, e.g., MAC CE, and/or higher layer configuration, e.g., RRC message) for transmissions after satellite switching and/or validity timer expiration.

DCI format N2_X may include a fraction factor (DCI field to indicate a fraction factor). The repetitions may be splitted into two (or more) segmented transmissions due to the switch of service satellites and/or validity timer expiration. This DCI field, the fraction factor, may indicate a fraction of repetitions (e.g., a percentage or a subset of the repetitions), e.g., the first segmented repetitions (or second segmented repetitions). The number of the first (or second) segmented repetitions may be calculated based on the repetition factor (repetition number) and the fraction factor. The number of bits in this bit field may be 0-2 bits or larger. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of fraction factors. For example, if dynamic indication of fraction factor and/or segmented repetition number is not enabled and/or segmentation is not enabled/applied, configured and/or supported, the number of bits in this field is 0 or this bit field is absent in DCI. If dynamic indication of fraction factor and/or segmentation is enabled, configured and/or supported, and/or the number of fraction factors in the configured and/or predefined set is 4 (e.g., {⅛, ¼, ½, ¾}), the number of bits in this field may be 2. Any of the high layer parameters, sets and/or tables used to determine the number of bits in this field may be commonly configured for DCI format N2_X and other DCI formats, or separately configured for DCI format N2_X. In other words, parameter(s), table(s) and/or set(s) configured for other DCI format(s) field size determination may be also used to determine the number of bits in the corresponding bit field for DCI format N2_X, or parameter(s), table(s) and/or set(s) used to determine the number of bits in the corresponding bit field for DCI format N2_X may be configured separately. The selection of parameter(s), table(s) and/or set(s) for repetition factor may be determined by a mechanism for disabling/enabling HARQ feedback. For example, if HARQ feedback is disabled for a HARQ process(es) (by RRC configuration), an NTN repetition table/set/parameter (e.g., a set of large repetition factors, or a large repetition factor) is used/assumed for the scheduling DCI format (current DCI format or new DCI format) of the corresponding HARQ process(es). In case that UE detects the DCI format N2_X and this field provides fraction fractor, UE performs the first segmented repetitions (and/or the second segmented repetitions) receptions according to information from this field and information/parameters provided/configured for the first segmented repetitions, e.g., current information/parameters before satellite switching and/or validity timer expiration (or information/parameters provided/configured for the second segmented repetitions, e.g., updated information/parameters after satellite switching and/or validity timer expiration).

DCI format N2_X may include a frequency domain resource assignment. The number of bits in this bit field may be 0-6 bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of RBGs, resource allocation type, granularity by high layer (e.g., RRC configuration). Any of the high layer parameters (e.g., configured number of RBGs, resource allocation type, granularity) used to determine the number of bits in this field may be commonly configured for DCI format N2_X and other DCI formats, or separately configured for DCI format N2_X. In other words, parameter(s) (e.g., number of RBGs, resource allocation type, granularity) configured for other DCI format(s) field size determination may be also applied to the corresponding bit field for DCI format N2_X, or parameter(s) and/or table(s) used to determine the number of bits in the corresponding bit field for DCI format N2_X may be configured separately. For example, The bitwidth for this field is determined by higher layer parameters number of RBGs, resource allocation type, granularity (e.g., ResourceAllocationType1-granularity-ForDCIFormatN2_X). The selection of parameter(s) and/or table(s) for frequency domain resource assignment may be determined by a mechanism for disabling/enabling HARQ feedback. For example, if HARQ feedback is disabled for a HARQ process(es) (by RRC configuration), an NTN frequency domain resource assignment table/set/parameter (e.g., a fine or coarse granularity) is used/assumed for the scheduling DCI format (current DCI format or new DCI format) of the corresponding HARQ process(es).
DCI format N2_X may include a time domain resource assignment. The number of bits in this bit field may be 0-6 bits. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of entries in the time domain resource assignment table configured by high layer (e.g., RRC configuration) or a defaulted time domain resource assignment table. Any of the high layer parameters (e.g., configured time domain resource assignment table, defaulted and/or predefined time domain resource assignment table) used to determine the number of bits in this field may be commonly configured for DCI format N2_X and other DCI formats, or separately configured for DCI format N2_X. In other words, parameter(s) (e.g., time domain resource assignment table configured by high layer) configured for other DCI format(s) field size determination may be also applied to the corresponding bit field for DCI format N2_X, or parameter(s) and/or table(s) used to determine the number of bits in the corresponding bit field for DCI format N2_X may be configured separately. For example, The bitwidth for this field is determined as ┌log₂(I)┐ bits, where I is the number of entries in the dedicated higher layer parameter (e.g., PDSCH-TimeDomainResourceAllocationList-ForDCIformatN2_X) if the dedicated higher layer parameter is configured, or I is the number of entries in the common higher layer parameter (e.g., PDSCH-TimeDomainResourceAllocationList) if the common higher layer parameter (e.g., PDSCH-TimeDomainResourceAllocationList) is configured and the dedicated higher layer parameter (e.g., PDSCH-TimeDomainResourceAllocationList-ForDCIformatN2_X) is not configured; otherwise I is the number of entries in the default table. The selection of parameter(s), table(s) and/or set(s) for time domain resource assignment may be determined by a mechanism for disabling/enabling HARQ feedback. For example, if HARQ feedback is disabled for a HARQ process(es) (by RRC configuration), a new table (e.g., PUSCH-TimeDomainResourceAllocationList-ForDCIformatN2_X) is used/assumed for the scheduling DCI format (current DCI format or new DCI format) of the corresponding HARQ process(es).
   DCI format N2_X may include a resource assignment. The number of bits in this bit field may be 0-6 bits. This field may indicate time domain resource and/or frequency domain resource. A set of time domain resources and/or frequency domain resources may be provided/configured by a RRC message/signaling and this DCI field may indicated one of the resource from the set. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by the number of RBGs, resource allocation type, granularity by high layer (e.g., RRC configuration). Any of the high layer parameters (e.g., configured number of RBGs, resource allocation type, granularity) used to determine the number of bits in this field may be commonly configured for DCI format N2_X and other DCI formats, or separately configured for DCI format N2_X. In other words, parameter(s) (e.g., number of RBGs, resource allocation type, granularity) configured for other DCI format(s) field size determination may be also applied to the corresponding bit field for DCI format N2_X, or parameter(s) and/or table(s) used to determine the number of bits in the corresponding bit field for DCI format N2_X may be configured separately. For example, the bitwidth for this field is determined by higher layer parameters number of RBGs, resource allocation type, granularity (e.g., ResourceAllocationType1-granularity-ForDCIFormatN2_X). The selection of parameter(s) and/or table(s) for frequency domain resource assignment may be determined by a mechanism for disabling/enabling HARQ feedback. For example, if HARQ feedback is disabled for a HARQ process(es) (by RRC configuration), an NTN frequency domain resource assignment table/set/parameter (e.g., a fine or coarse granularity) is used/assumed for the scheduling DCI format (current DCI format or new DCI format) of the corresponding HARQ process(es).

DCI format N2_X may include an Information for SC-MCCH change notification. The number of bits in this bit field may be 0-2 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N2_X and other DCI formats (e.g. DCI format N1), or separately configured for DCI format N2_X. In other words, parameter(s) and/or table(s) configured for other DCI format(s) field size determination may be also used to determine the number of bits in the corresponding bit field for DCI format N2_X, or parameter(s) used to determine the number of bits in the corresponding bit field for DCI format N2_X may be configured separately. The field may be only present if the DCI format N2_X CRC is scrambled by a SC-RNTI.

DCI format N2_X may include an Direct Indication information (DCI field to indicate information for Direct Indication). The number of bits in this bit field may be 0-8 bits. The number of bits in this bit field may be fixed in spec. The number of bits in this bit field may be determined by higher layer (e.g., RRC configuration, an explicit high layer parameter). The number of bits in this bit field may be determined by the satellite type and/or network type (i.e. TN or NTN). The number of bits in this bit field may be determined by a mechanism for disabling/enabling HARQ feedback. The number of bits in this bit field may be determined by a configured and/or predefined set of values/levels. Any of the high layer parameters and/or DCI fields used to determine the number of bits in this field may be commonly configured for DCI format N2_X and other DCI formats (e.g. DCI format N1), or separately configured for DCI format N2_X. In other words, parameter(s) and/or table(s) configured for other DCI format(s) field size determination may be also used to determine the number of bits in the corresponding bit field for DCI format N2_X, or parameter(s) used to determine the number of bits in the corresponding bit field for DCI format N2_X may be configured separately. The field may be only present if the DCI format N2_X CRC is scrambled by a P-RNTI and Flag for paging/direct indication differentiation indicates a direct information (e.g., Flag=0). This field may provide direct indication of system information update and other fields.

In yet another implementation, a new DL DCI format may not be introduced, but modifications and/or enhancements of current DCI format(s) may be needed to schedule PDSCH for NTN. Reinterpretation of field(s) in current DCI format (e.g., DCI format N1 or DCI format N2) may be applied to provide necessary information to schedule PDSCH for NTN.

Bit(s) or subset of bits of one or more bit fields (e.g., flag for NTN/non-NTN differentiation, validity timer, segmented repetitions, HARQ/ACK enabler, NPUSCH repetition adjustment, Scheduling delay, Scheduling delay offset, frequency domain resource assignment, time domain resource assignment, VRB-to-PRB mapping, modulation and coding scheme, new data indicator, redundancy version, HARQ process number, downlink assignment index, TPC command for scheduled PUCCH, PUCCH resource indicator, PDSCH-to-HARQ_feedback timing indicator, other fields as mentioned above, etc.) in DCI format N1 (or DCI format N0 or DCI format N2) may be reinterpreted as a different bit field(s) (e.g., flag for NTN/non-NTN differentiation, validity timer, segmented repetitions, HARQ/ACK enabler, NPUSCH repetition adjustment, Scheduling delay, Scheduling delay offset, antenna port(s), transmission configuration indication, PRB bundling size indicator, carrier indicator, rate matching indicator, ZP CSI-RS trigger, SRS request, repetition factor, priority indication, HARQ process number, other fields as mentioned above, etc.) if the reinterpretation is RRC configured, indicated explicitly or implicitly.

Existing DCI formats (e.g., DCI format N0, DCI format N1, DCI format N2) may be used to schedule NPDSCH for NTN. The field size of each field in the existing DCI format(s) may be determined by separate RRC parameter dedicated for NTN as mentioned above (DCI field determination (e.g., number of DCI field bits is determined by a specific high layer parameter) for DCI format N2_X). The DCI format N2_X described above may be renamed from the existing DCI format (e.g., DCI format N0, DCI format N1, DCI format N2) or alias of the existing DCI format (e.g., DCI format N0, DCI format N1, DCI format N2).

If existing DCI formats (e.g., DCI format N0, DCI format N1, DCI format N2) is used to schedule PDSCH for NTN, procedures/methods/mechanism for determination of DCI fields mentioned above (for new DCI format) may be applied to the existing DCI formats.

A time offset K_offset may be configured for IoT over NTN. The time offset K_offset is an offset in addition to IoT scheduling/transmission timing relationships (e.g., NPDCCH to NPUSCH format 1, RAR grant to NPUSCH format 1, NPDSCH to HARQ-ACK on NPUSCH format 2, NPDCCH order to NPRACH, Timing advance command activation and other NB-IoT timing relationships) to enhance DL-UL timing interaction with the impact of large transmission delay in NTN. The time offset K_offset may be configured by a dedicated RRC message, a common RRC message, System information, or provided by L1/L2 signalling, e.g., DCI carried by NPDCCH or MAC CE. The time offset K_offset may be provided/configured cell-specific and/or beam-specific.
In TN, when the UE is scheduled to transmit NPUSCH format 1 by a DCI carried by NPDCCH, the DCI indicates the scheduling delay (or start time), e.g., K1, among other things. The subframe/slot allocated for the NPUSCH format 1 is given by the DCI. For example, the subframe/slot allocated for the NPUSCH is n+K1, where n is the subframe/slot with the scheduling DCI. In NTN, for the transmission timing of DCI scheduled NPUSCH format 1, the subframe/slot allocated for the NPUSCH can be modified to be n+K₁+K_{offset}.
In TN, when the UE is scheduled to transmit NPUSCH format 1 by a RAR grant, the RAR grant indicates the scheduling delay (or start time), e.g., K2, among other things. The subframe/slot allocated for the NPUSCH format 1 is given by the RAR grant. For example, the subframe/slot allocated for the NPUSCH is n+K2, where n is the subframe/slot with the RAR grant. In NTN, for the transmission timing of RAR granted NPUSCH format 1, the subframe/slot allocated for the NPUSCH can be modified to be n+K₂+K_{offset}.
In TN, when the UE is scheduled/configured to transmit HARQ-ACK on NPUSCH format 2 after a reception of NPDSCH, the scheduling delay (or start time), e.g., K3, may be configured/fixed. The subframe/slot allocated for the NPUSCH format 2 is given by the NPDSCH timing and K3. For example, the subframe/slot allocated for the NPUSCH is n+K3, where n is the subframe/slot with the NPDSCH. In NTN, for the transmission timing of HARQ-ACK on NPUSCH format 2 after a reception of NPDSCH, the subframe/slot allocated for the NPUSCH can be modified to be n+K₃+K_{offset}.
In TN, when the UE is scheduled to transmit NPRACH by a NPDCCH order, the NPDCCH indicates the scheduling delay (or start time), e.g., K4, among other things. The subframe/slot allocated for the NPRACH is given by the NPDCCH order. For example, the subframe/slot allocated for the NPRACH is n+K4, where n is the subframe/slot with the NPDCCH order. In NTN, for the transmission timing of PDCCH order scheduled NPRACH, the subframe/slot allocated for the NPRACH can be modified to be n+K₄+K_{offset}.
In TN, when the UE is triggered to adjust TA by a DCI, the DCI indicates a timing advance adjustment, e.g., K5. In NTN, timing advance adjustment can be modified to be K5+K_{offset}.
   The time offset K_offset (IoT-specific time offset) may be independently/separately configured for IoT over NTN (e.g., a higher layer parameter NTNTimeOffset configured in IoTConfig information element). The time offset K_offset (NTN general time offset) may be also provided for general NTN transmission (e.g., a higher layer parameter NTNTimeOffset configured in a dedicated/common RRC message and/or system information (general information element for NTN like BWP, BWP_common, BWP_NTN, BWP-uplink, PUSCH-config, PUSCH-configcommon)). In the case that a IoT-specific time offset is not configured/provided and NTN general time offset is configured/provided, NTN general time offset may be applied to IoT. In the case that IoT-specific time offset is configured/provided and NTN general time offset is not configured/provided, IoT-specific time offset may be applied to IoT. In the case that both IoT-specific time offset and NTN general time offset are configured/provided, NTN general time offset may be applied to IoT (i.e., NTN general time offset overrides IoT-specific time offset for IoT). In yet another approach, in the case that both IoT-specific time offset and NTN general time offset are configured/provided, IoT-specific time offset may be applied to IoT (i.e., IoT-specific time offset may override NTN general time offset for IoT).

Additionally or alternatively, a beam specific K_offset may be configured/provided for NTN IoT (e.g., higher layer parameter configured in a dedicated/common RRC message and/or system information).

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include a gNB scheduling module 194. The gNB scheduling module 194 may perform operations for resource allocation of enhanced uplink transmissions as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

The gNB operations module 182 may provide information 190 to the one or more receivers 178. For example, the gNB operations module 182 may inform the receiver(s) 178 when to receive transmissions.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

URLLC may coexist with other services (e.g., eMBB). Due to the latency requirement, URLLC may have a highest priority in some approaches. Some examples of URLLC coexistence with other services are given herein (e.g., in one or more of the following Figure descriptions).

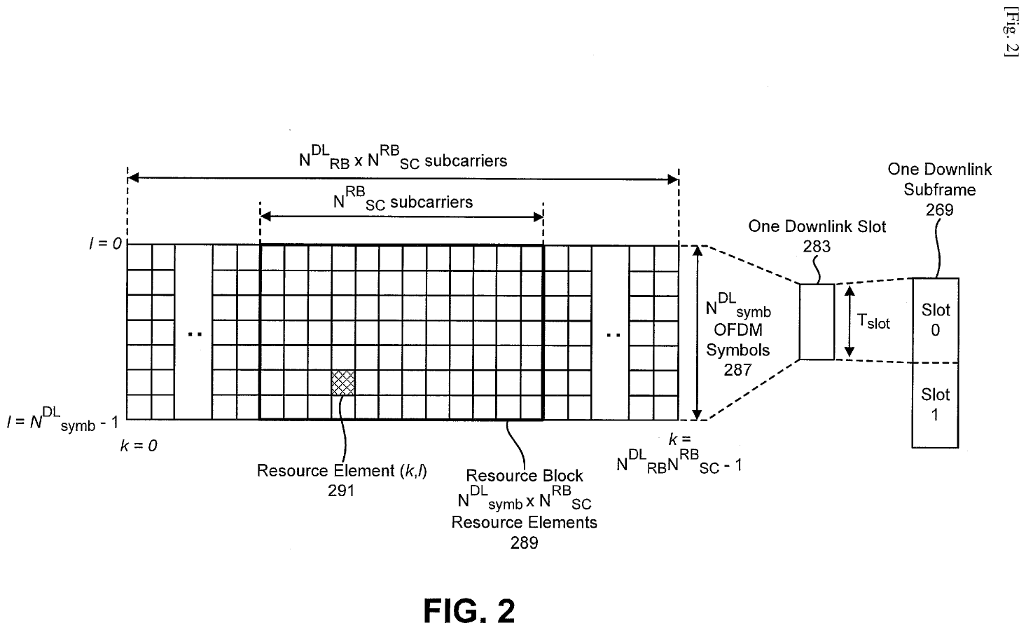

FIG. 2 is a diagram illustrating one example of a resource grid for the downlink. The resource grid illustrated in FIG. 2 may be utilized in some implementations of the systems and methods disclosed herein. More detail regarding the resource grid is given in connection with FIG. 1.

In FIG. 2, one downlink subframe 269 may include two downlink slots 283. N^{DL}_{RB} is downlink bandwidth configuration of the serving cell, expressed in multiples of N^{RB}_{sc}, where N^{RB}_{sc} is a resource block 289 size in the frequency domain expressed as a number of subcarriers, and N^{DL}_{symb} is the number of OFDM symbols 287 in a downlink slot 283. A resource block 289 may include a number of resource elements (RE) 291.

For a PCell, N^{DL}_{RB} is broadcast as a part of system information. For a SCell (including a Licensed Assisted Access (LAA) SCell), N^{DL}_{RB} is configured by a RRC message dedicated to a UE 102. For PDSCH mapping, the available RE 291 may be the RE 291 whose index l fulfils l≥l_{data,start} and/or l_{data,end}≥l in a subframe.

In the downlink, the OFDM access scheme with cyclic prefix (CP) may be employed, which may be also referred to as CP-OFDM. In the downlink, PDCCH, enhanced PDCCH (EPDCCH), PDSCH and the like may be transmitted. A downlink radio frame may include multiple pairs of downlink resource blocks (RBs) which is also referred to as physical resource blocks (PRBs). The downlink RB pair is a unit for assigning downlink radio resources, defined by a predetermined bandwidth (RB bandwidth) and a time slot. The downlink RB pair includes two downlink RBs that are continuous in the time domain.

The downlink RB includes twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) and is uniquely identified by the index pair (k,l) in a slot, where k and l are indices in the frequency and time domains, respectively. While downlink subframes in one component carrier (CC) are discussed herein, downlink subframes are defined for each CC and downlink subframes are substantially in synchronization with each other among CCs.

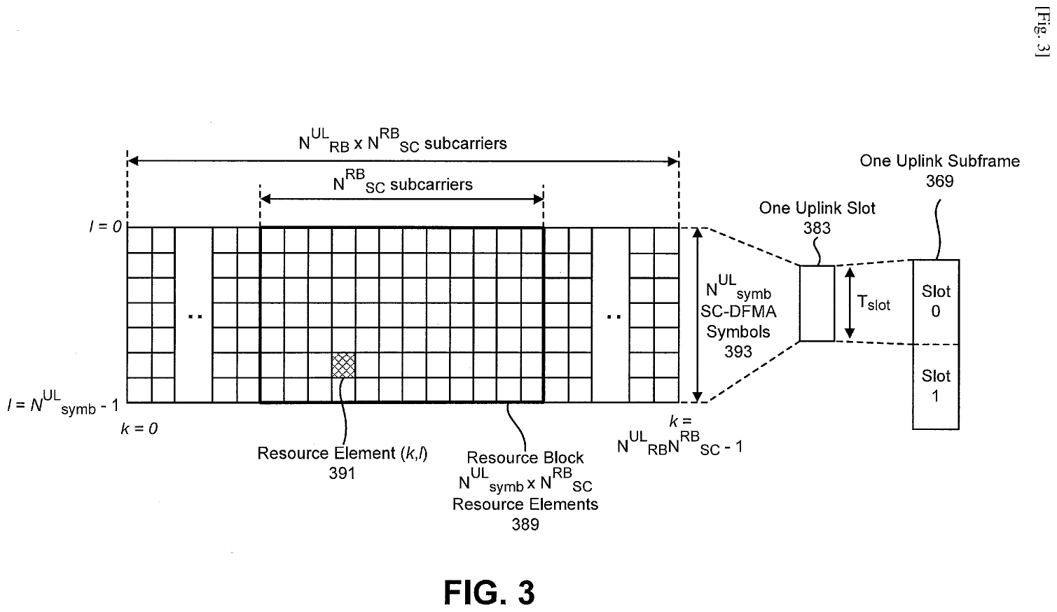

FIG. 3 is a diagram illustrating one example of a resource grid for the uplink. The resource grid illustrated in FIG. 3 may be utilized in some implementations of the systems and methods disclosed herein. More detail regarding the resource grid is given in connection with FIG. 1.

In FIG. 3, one uplink subframe 369 may include two uplink slots 383. N^{UL}_{RB} is uplink bandwidth configuration of the serving cell, expressed in multiples of N^{RB}_{sc}, where N^{RB}_{sc} is a resource block 389 size in the frequency domain expressed as a number of subcarriers, and N^{UL}_{symb} is the number of SC-FDMA symbols 393 in an uplink slot 383. A resource block 389 may include a number of resource elements (RE) 391.

For a PCell, N^{UL}_{RB} is broadcast as a part of system information. For a SCell (including an LAA SCell), N^{UL}_{RB} is configured by a RRC message dedicated to a UE 102.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PUSCH, PRACH and the like may be transmitted. An uplink radio frame may include multiple pairs of uplink resource blocks. The uplink RB pair is a unit for assigning uplink radio resources, defined by a predetermined bandwidth (RB bandwidth) and a time slot. The uplink RB pair includes two uplink RBs that are continuous in the time domain.

The uplink RB may include twelve sub-carriers in frequency domain and seven (for normal CP) or six (for extended CP) OFDM and/or DFT-S-OFDM symbols in time domain. A region defined by one sub-carrier in the frequency domain and one OFDM and/or DFT-S-OFDM symbol in the time domain is referred to as a RE and is uniquely identified by the index pair (k,l) in a slot, where k and l are indices in the frequency and time domains respectively. While uplink subframes in one component carrier (CC) are discussed herein, uplink subframes are defined for each CC.

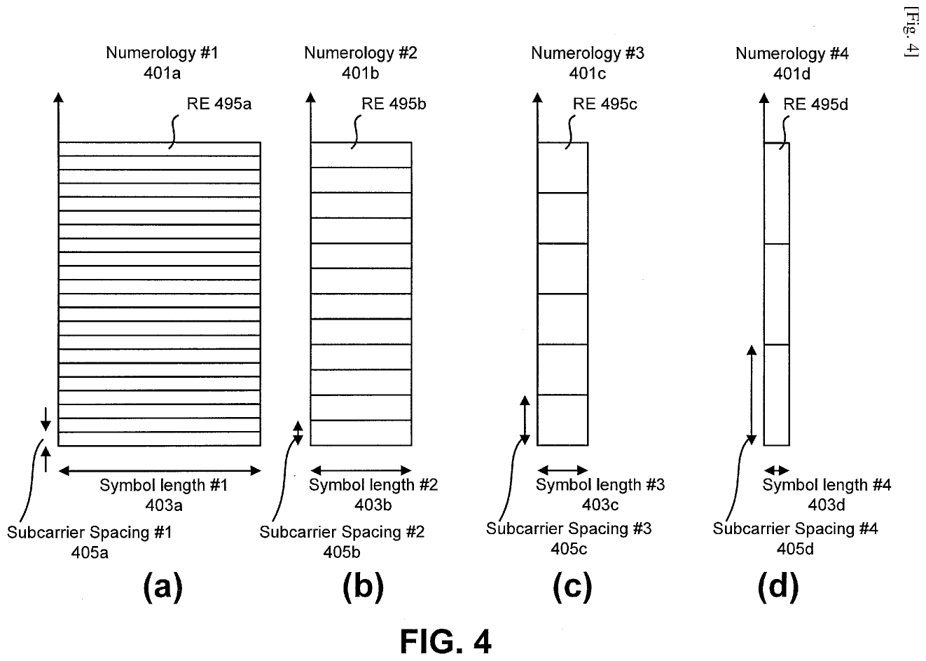

FIG. 4 shows examples of several numerologies 401. The numerology #1 401a may be a basic numerology (e.g., a reference numerology). For example, a RE 495a of the basic numerology 401a may be defined with subcarrier spacing 405a of 15 kHz in frequency domain and 2048 Ts+CP length (e.g., 160 Ts or 144 Ts) in time domain (i.e., symbol length #1 403a), where Ts denotes a baseband sampling time unit defined as 1/(15000*2048) seconds. For the i-th numerology, the subcarrier spacing 405 may be equal to 15*2ⁱ and the effective OFDM symbol length 2048*2⁻ⁱ*Ts. It may cause the symbol length is 2048*2⁻ⁱ*Ts+CP length (e.g., 160*2⁻ⁱ*Ts or 144*2⁻ⁱ*Ts). In other words, the subcarrier spacing of the i+1-th numerology is a double of the one for the i-th numerology, and the symbol length of the i+1-th numerology is a half of the one for the i-th numerology. FIG. 4 shows four numerologies, but the system may support another number of numerologies. Furthermore, the system does not have to support all of the 0-th to the I-th numerologies, i=0, 1, . . . , I.

For example, the first UL transmission on the first SPS resource as above mentioned may be performed only on the numerology #1 (e.g., a subcarrier spacing of 15 kHz). In some examples, the UE 102 may acquire (detect) the numerology #1 based on a synchronization signal. Also, the UE 102 may receive a dedicated RRC signal including information (e.g., a handover command) configuring the numerology #1. The dedicated RRC signal may be a UE-specific signal. In some examples, the first UL transmission on the first SPS resource may be performed on the numerology #1, the numerology #2 (a subcarrier spacing of 30 kHz), and/or the numerology #3 (a subcarrier spacing of 60 kHz).

Also, the second UL transmission on the second SPS resource as above mentioned may be performed only on the numerology #3. In some examples, the UE 102 may receive System Information (e.g., Master Information Block (MIB) and/or System Information Block (SIB)) including information configuring the numerology #2 and/or the numerology #3.

Also, the UE 102 may receive the dedicated RRC signal including information (e.g., the handover command) configuring the numerology #2 and/or the numerology #3. The System Information (e.g., MIB) may be transmitted on BCH (Broadcast Channel) and/or the dedicated RRC signal. The System Information (e.g., SIB) may contain information relevant when evaluating if a UE 102 is allowed to access a cell and/or defines the scheduling of other system information. The System Information (SIB) may contain radio resource configuration information that is common for multiple UEs 102. For instance, the dedicated RRC signal may include each of multiple numerology configurations (the first numerology, the second numerology, and/or the third numerology) for each of UL transmissions (e.g., each of UL-SCH transmissions, each of PUSCH transmissions). Also, the dedicated RRC signal may include each of multiple numerology configurations (the first numerology, the second numerology, and/or the third numerology) for each of DL transmissions (each of PDCCH transmissions).

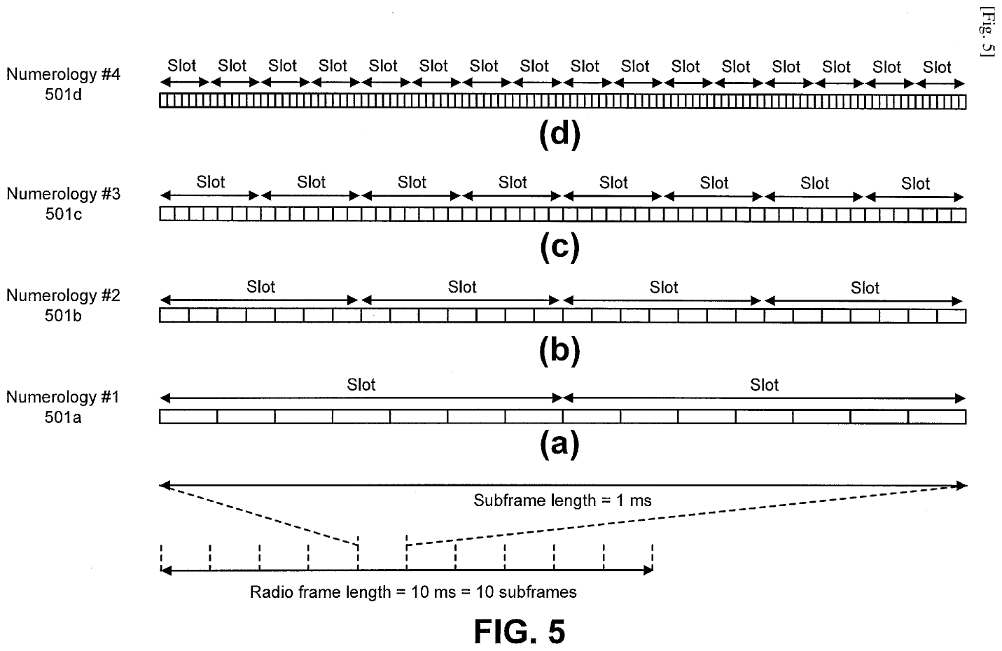

FIG. 5 shows examples of subframe structures for the numerologies 501 that are shown in FIG. 4. Given that a slot 283 includes N^{DL}_{symb} (or N^{UL}_{symb})=7 symbols, the slot length of the i+1-th numerology 501 is a half of the one for the i-th numerology 501, and eventually the number of slots 283 in a subframe (i.e., 1 ms) becomes double. It may be noted that a radio frame may include 10 subframes, and the radio frame length may be equal to 10 ms.

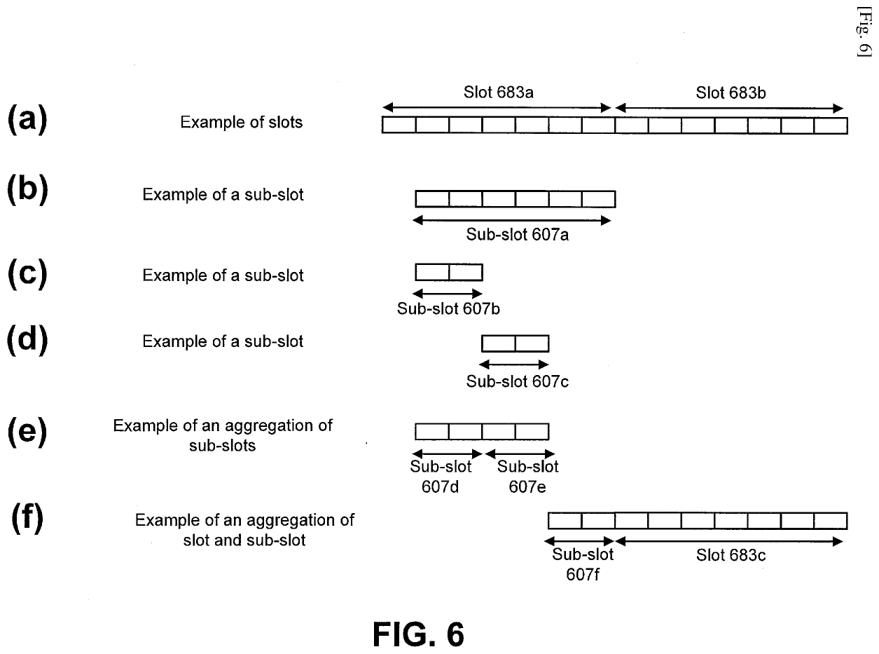

FIG. 6 shows examples of slots 683 and sub-slots 607. If a sub-slot 607 is not configured by higher layer, the UE 102 and the eNB and/or gNB 160 may only use a slot 683 as a scheduling unit. More specifically, a given transport block may be allocated to a slot 683. If the sub-slot 607 is configured by higher layer, the UE 102 and the eNB and/or gNB 160 may use the sub-slot 607 as well as the slot 683. The sub-slot 607 may include one or more OFDM symbols. The maximum number of OFDM symbols that constitute the sub-slot 607 may be N^{DL}_{symb}−1 (or N^{UL}_{symb}−1).

The sub-slot length may be configured by higher layer signaling. Alternatively, the sub-slot length may be indicated by a physical layer control channel (e.g., by DCI format).

The sub-slot 607 may start at any symbol within a slot 683 unless it collides with a control channel. There could be restrictions of mini-slot length based on restrictions on starting position. For example, the sub-slot 607 with the length of N^{DL}_{symb}−1 (or N^{UL}_{symb}−1) may start at the second symbol in a slot 683. The starting position of a sub-slot 607 may be indicated by a physical layer control channel (e.g., by DCI format). Alternatively, the starting position of a sub-slot 607 may be derived from information (e.g., search space index, blind decoding candidate index, frequency and/or time resource indices, PRB index, a control channel element index, control channel element aggregation level, an antenna port index, etc.) of the physical layer control channel which schedules the data in the concerned sub-slot 607.

In cases when the sub-slot 607 is configured, a given transport block may be allocated to either a slot 683, a sub-slot 607, aggregated sub-slots 607 or aggregated sub-slot(s) 607 and slot 683. This unit may also be a unit for HARQ-ACK bit generation.

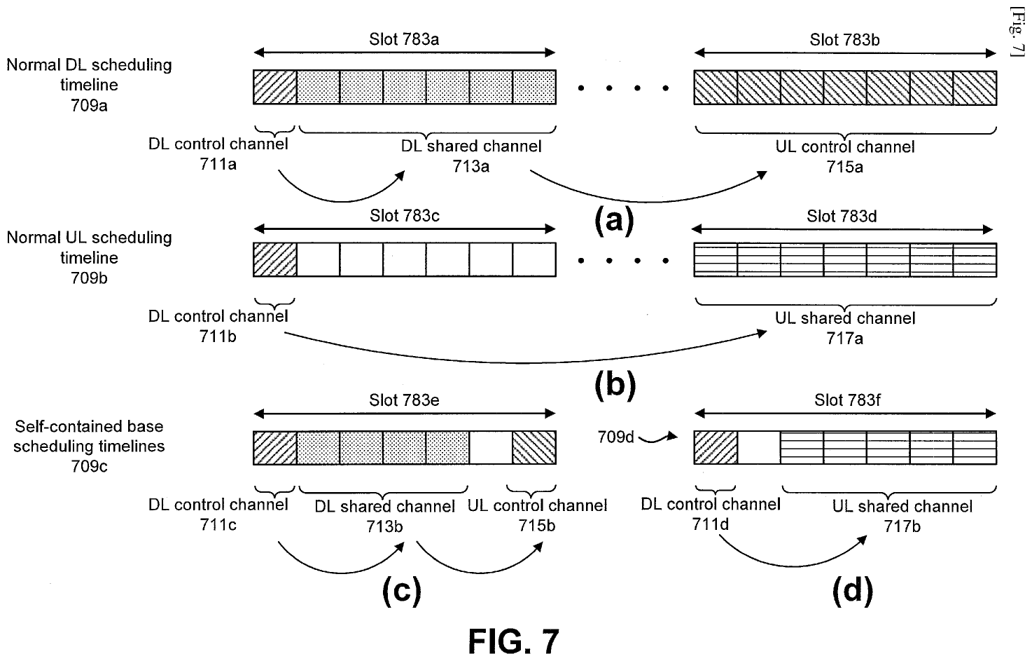

FIG. 7 shows examples of scheduling timelines 709. For a normal DL scheduling timeline 709a, DL control channels are mapped the initial part of a slot 783a. The DL control channels 711 schedule DL shared channels 713a in the same slot 783a. HARQ-ACKs for the DL shared channels 713a (i.e., HARQ-ACKs each of which indicates whether or not transport block in each DL shared channel 713a is detected successfully) are reported via UL control channels 715a in a later slot 783b. In this instance, a given slot 783 may contain either one of DL transmission and UL transmission.

For a normal UL scheduling timeline 709b, DL control channels 711b are mapped the initial part of a slot 783c. The DL control channels 711b schedule UL shared channels 717a in a later slot 783d. For these cases, the association timing (time shift) between the DL slot 783c and the UL slot 783d may be fixed or configured by higher layer signaling. Alternatively, it may be indicated by a physical layer control channel (e.g., the DL assignment DCI format, the UL grant DCI format, or another DCI format such as UE-common signaling DCI format which may be monitored in common search space).

For a self-contained base DL scheduling timeline 709c, DL control channels 711c are mapped to the initial part of a slot 783e. The DL control channels 711c schedule DL shared channels 713b in the same slot 783e. HARQ-ACKs for the DL shared channels 713b are reported in UL control channels 715b, which are mapped at the ending part of the slot 783e.

For a self-contained base UL scheduling timeline 709d, DL control channels 711d are mapped to the initial part of a slot 783f. The DL control channels 711d schedule UL shared channels 717b in the same slot 783f. For these cases, the slot 783f may contain DL and UL portions, and there may be a guard period between the DL and UL transmissions.

The use of a self-contained slot may be upon a configuration of self-contained slot. Alternatively, the use of a self-contained slot may be upon a configuration of the sub-slot. Yet alternatively, the use of a self-contained slot may be upon a configuration of shortened physical channel (e.g., PDSCH, PUSCH, PUCCH, etc.).

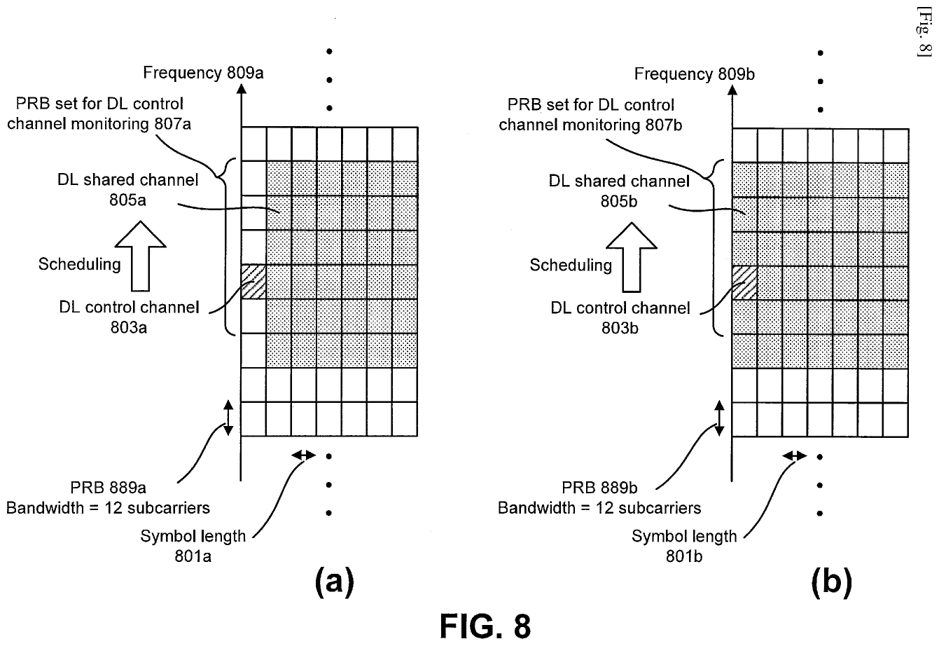

FIG. 8 shows examples of DL control channel monitoring regions. One or more sets of PRB(s) may be configured for DL control channel monitoring. In other words, a control resource set is, in the frequency domain, a set of PRBs within which the UE 102 attempts to blindly decode downlink control information, where the PRBs may or may not be frequency contiguous, a UE 102 may have one or more control resource sets, and one DCI message may be located within one control resource set. In the frequency-domain, a PRB is the resource unit size (which may or may not include Demodulation reference signals (DMRS)) for a control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of resources in the control resource sets for data for the same or a different UE 102, at least in the frequency domain may be supported.

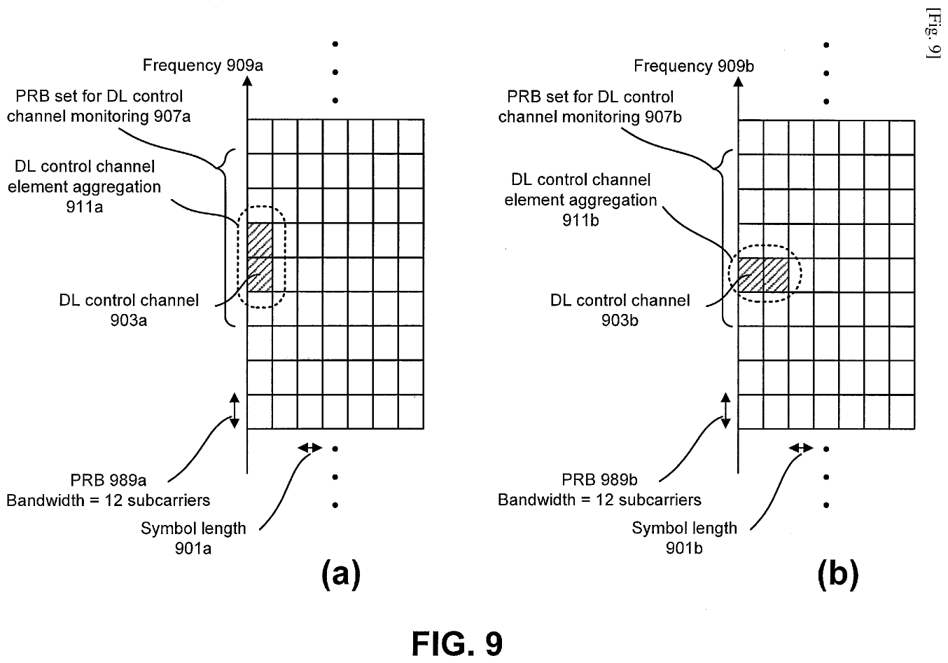

FIG. 9 shows examples of DL control channel which includes more than one control channel elements. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, for instance multiple DL control channel elements within an OFDM symbol are aggregated. Otherwise, DL control channel elements in different OFDM symbols can be aggregated.

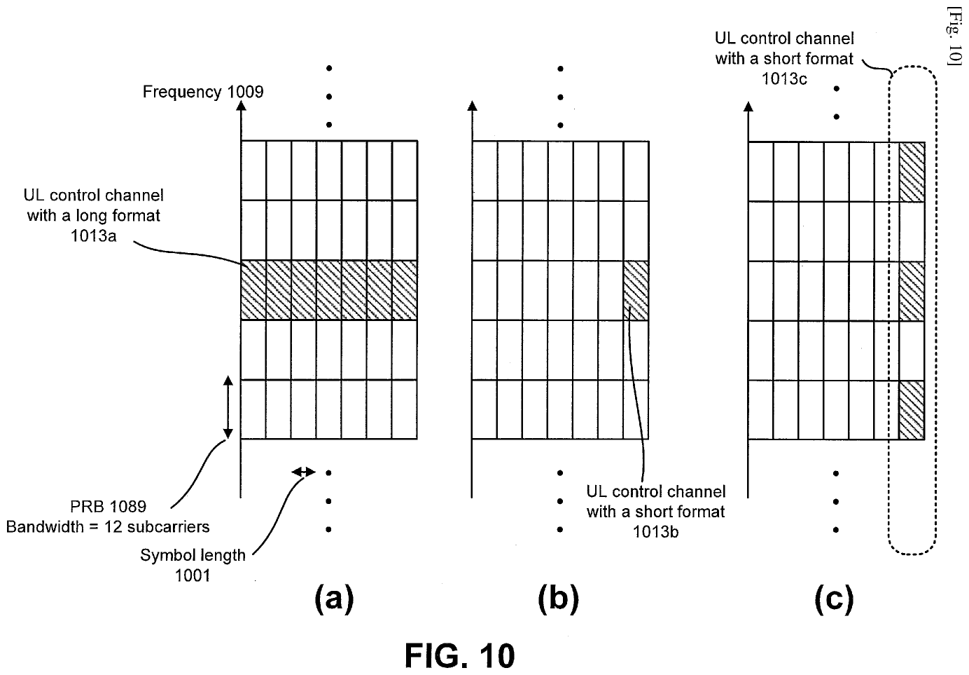

FIG. 10 shows examples of UL control channel structures. UL control channel may be mapped on REs which are defined a PRB and a slot in frequency and time domains, respectively. This UL control channel may be referred to as a long format (or just the 1st format). UL control channels may be mapped on REs on a limited OFDM symbols in time domain. This may be referred to as a short format (or just the 2nd format). The UL control channels with a short format may be mapped on REs within a single PRB. Alternatively, the UL control channels with a short format may be mapped on REs within multiple PRBs. For example, interlaced mapping may be applied, for instance the UL control channel may be mapped to every N PRBs (e.g., 5 or 10) within a system bandwidth.

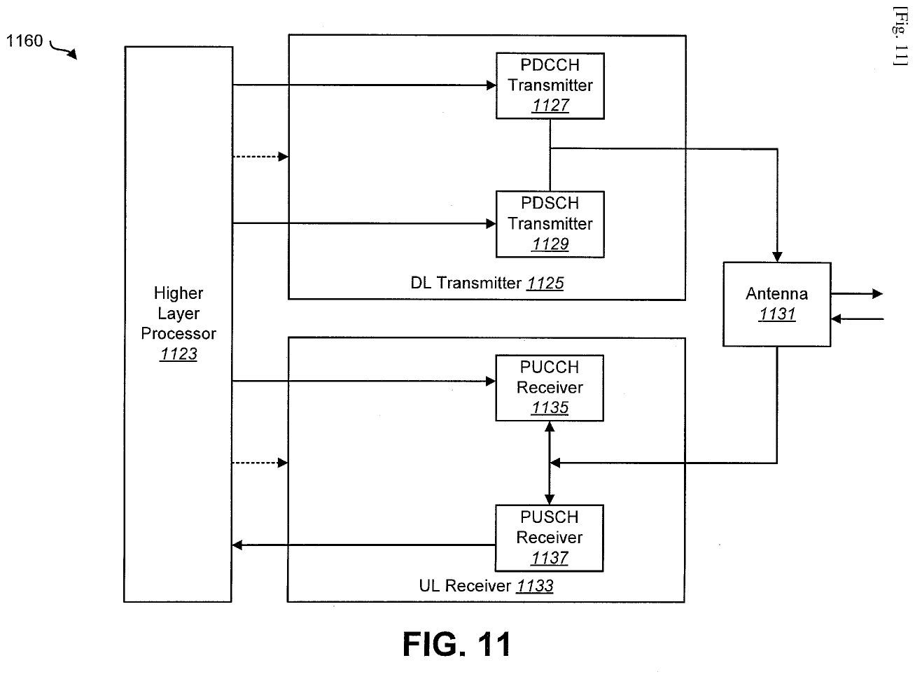

FIG. 11 is a block diagram illustrating one implementation of a gNB 1160. The gNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send and/or acquire higher layer messages such as an RRC message and MAC message to and/or from a UE's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 UCI. The PUSCH receiver 1137 may provide the higher layer processor 1123 received transport blocks.

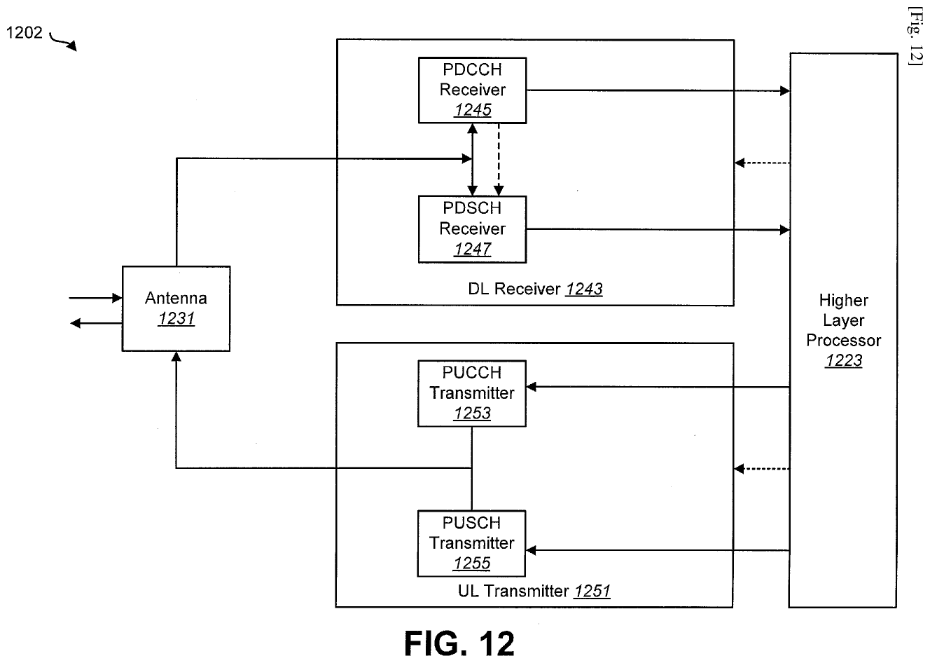

FIG. 12 is a block diagram illustrating one implementation of a UE 1202. The UE 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send and/or acquire higher layer messages such as an RRC message and MAC message to and/or from a UE's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI. The PDSCH receiver 1247 may provide the higher layer processor 1223 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

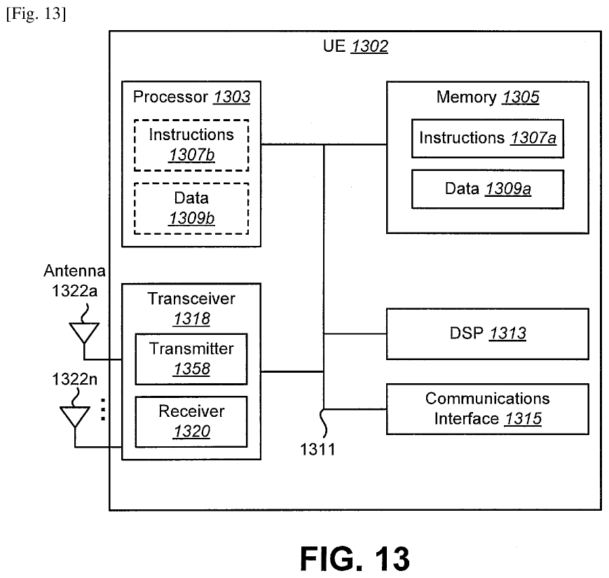

FIG. 13 illustrates various components that may be utilized in a UE 1302. The UE 1302 described in connection with FIG. 13 may be implemented in accordance with the UE 102 described in connection with FIG. 1. The UE 1302 includes a processor 1303 that controls operation of the UE 1302. The processor 1303 may also be referred to as a central processing unit (CPU). Memory 1305, which may include read-only memory (ROM), random access memory (RAM), a combination of the two or any type of device that may store information, provides instructions 1307a and data 1309a to the processor 1303. A portion of the memory 1305 may also include non-volatile random-access memory (NVRAM). Instructions 1307b and data 1309b may also reside in the processor 1303. Instructions 1307b and/or data 1309b loaded into the processor 1303 may also include instructions 1307a and/or data 1309a from memory 1305 that were loaded for execution or processing by the processor 1303. The instructions 1307b may be executed by the processor 1303 to implement the methods described above.

The UE 1302 may also include a housing that contains one or more transmitters 1358 and one or more receivers 1320 to allow transmission and reception of data. The transmitter(s) 1358 and receiver(s) 1320 may be combined into one or more transceivers 1318. One or more antennas 1322a-n are attached to the housing and electrically coupled to the transceiver 1318.

The various components of the UE 1302 are coupled together by a bus system 1311, which may include a power bus, a control signal bus and a status signal bus, in addition to a data bus. However, for the sake of clarity, the various buses are illustrated in FIG. 13 as the bus system 1311. The UE 1302 may also include a digital signal processor (DSP) 1313 for use in processing signals. The UE 1302 may also include a communications interface 1315 that provides user access to the functions of the UE 1302. The UE 1302 illustrated in FIG. 13 is a functional block diagram rather than a listing of specific components.

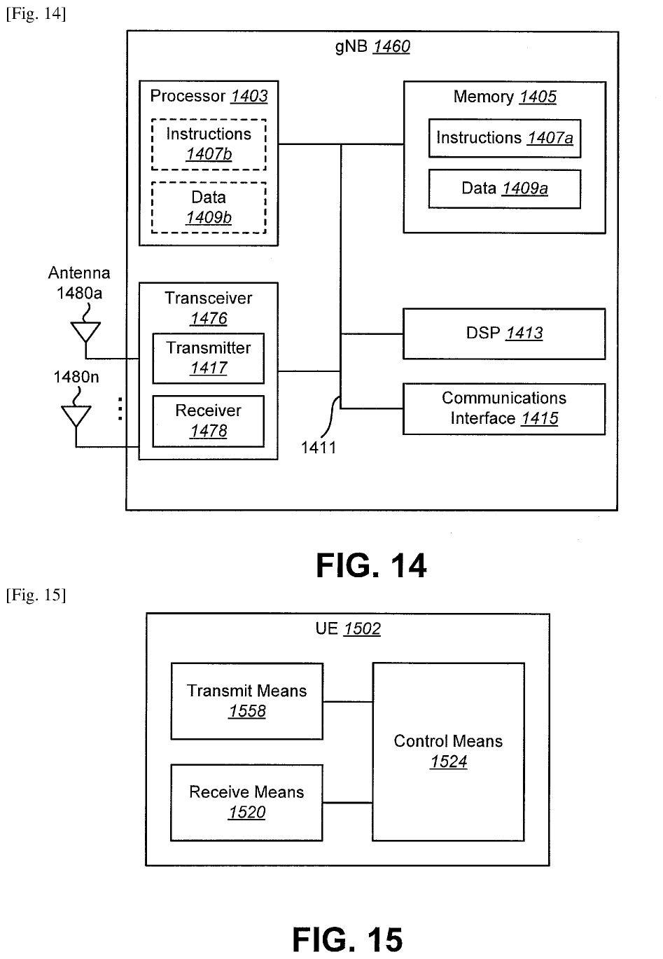

FIG. 14 illustrates various components that may be utilized in a gNB 1460. The gNB 1460 described in connection with FIG. 14 may be implemented in accordance with the gNB 160 described in connection with FIG. 1. The gNB 1460 includes a processor 1403 that controls operation of the gNB 1460. The processor 1403 may also be referred to as a central processing unit (CPU). Memory 1405, which may include read-only memory (ROM), random access memory (RAM), a combination of the two or any type of device that may store information, provides instructions 1407a and data 1409a to the processor 1403. A portion of the memory 1405 may also include non-volatile random-access memory (NVRAM). Instructions 1407b and data 1409b may also reside in the processor 1403. Instructions 1407b and/or data 1409b loaded into the processor 1403 may also include instructions 1407a and/or data 1409a from memory 1405 that were loaded for execution or processing by the processor 1403. The instructions 1407b may be executed by the processor 1403 to implement the methods described above.

The gNB 1460 may also include a housing that contains one or more transmitters 1417 and one or more receivers 1478 to allow transmission and reception of data. The transmitter(s) 1417 and receiver(s) 1478 may be combined into one or more transceivers 1476. One or more antennas 1480a-n are attached to the housing and electrically coupled to the transceiver 1476.

The various components of the gNB 1460 are coupled together by a bus system 1411, which may include a power bus, a control signal bus and a status signal bus, in addition to a data bus. However, for the sake of clarity, the various buses are illustrated in FIG. 14 as the bus system 1411. The gNB 1460 may also include a digital signal processor (DSP) 1413 for use in processing signals. The gNB 1460 may also include a communications interface 1415 that provides user access to the functions of the gNB 1460. The gNB 1460 illustrated in FIG. 14 is a functional block diagram rather than a listing of specific components.

FIG. 15 is a block diagram illustrating one implementation of a UE 1502 in which systems and methods for resource allocations of enhanced uplink transmissions may be implemented. The UE 1502 includes transmit means 1558, receive means 1520 and control means 1524. The transmit means 1558, receive means 1520 and control means 1524 may be configured to perform one or more of the functions described in connection with FIG. 1 above. FIG. 13 above illustrates one example of a concrete apparatus structure of FIG. 15. Other various structures may be implemented to realize one or more of the functions of FIG. 1. For example, a DSP may be realized by software.

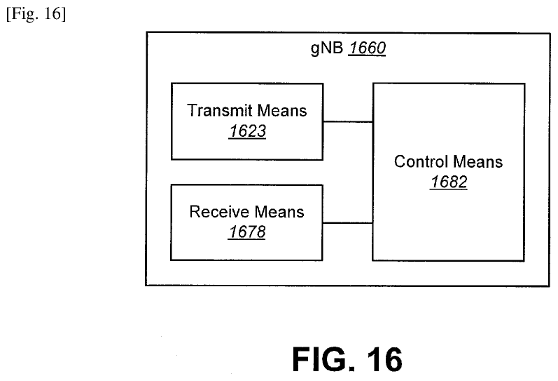

FIG. 16 is a block diagram illustrating one implementation of a gNB 1660 in which systems and methods for resource allocations of enhanced uplink transmissions may be implemented. The gNB 1660 includes transmit means 1623, receive means 1678 and control means 1682. The transmit means 1623, receive means 1678 and control means 1682 may be configured to perform one or more of the functions described in connection with FIG. 1 above. FIG. 14 above illustrates one example of a concrete apparatus structure of FIG. 16. Other various structures may be implemented to realize one or more of the functions of FIG. 1. For example, a DSP may be realized by software.

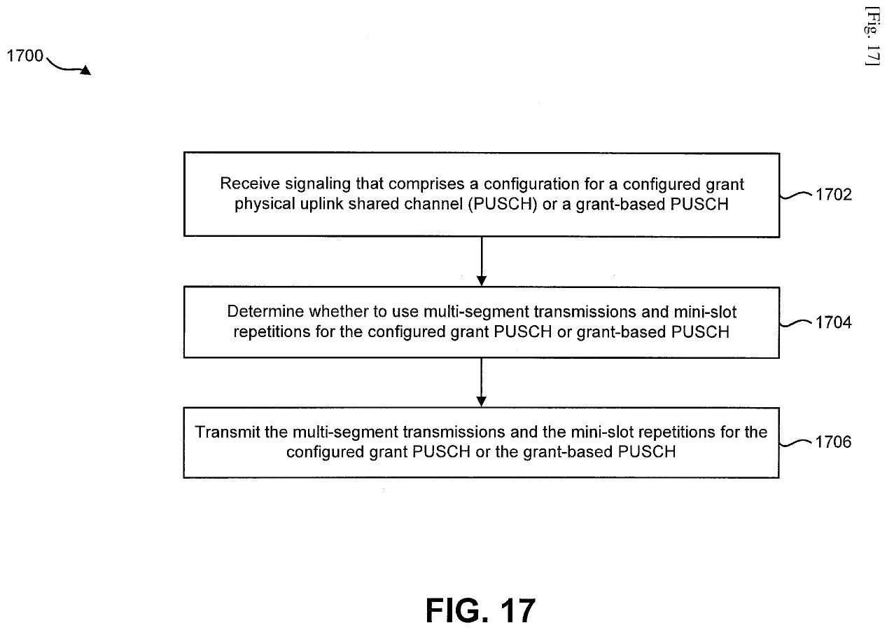

FIG. 17 is a flow diagram illustrating a method 1700 by a user equipment (UE) 102. The UE 102 may receive 1702 signaling that comprises a configuration for a configured grant physical uplink shared channel (PUSCH) or a grant-based PUSCH. The UE 102 may determine 1704 whether to use multi-segment transmissions and mini-slot repetitions for the configured grant PUSCH or grant-based PUSCH. The UE 102 may transmit 1706 the multi-segment transmissions and the mini-slot repetitions for the configured grant PUSCH or the grant-based PUSCH.

In one approach, one or more actual PUSCH repetitions in one slot, or two or more actual PUSCH repetitions across slot boundary in consecutive available slots, are supported using one uplink (UL) grant for the grant-based PUSCH and one configured grant configuration for the configured grant PUSCH.

In another approach, one or more PUSCH repetitions in one slot, or two or more PUSCH repetitions across slot boundary in consecutive available slots, are supported using one UL grant for the grant-based PUSCH and one configured grant configuration for the configured grant PUSCH.

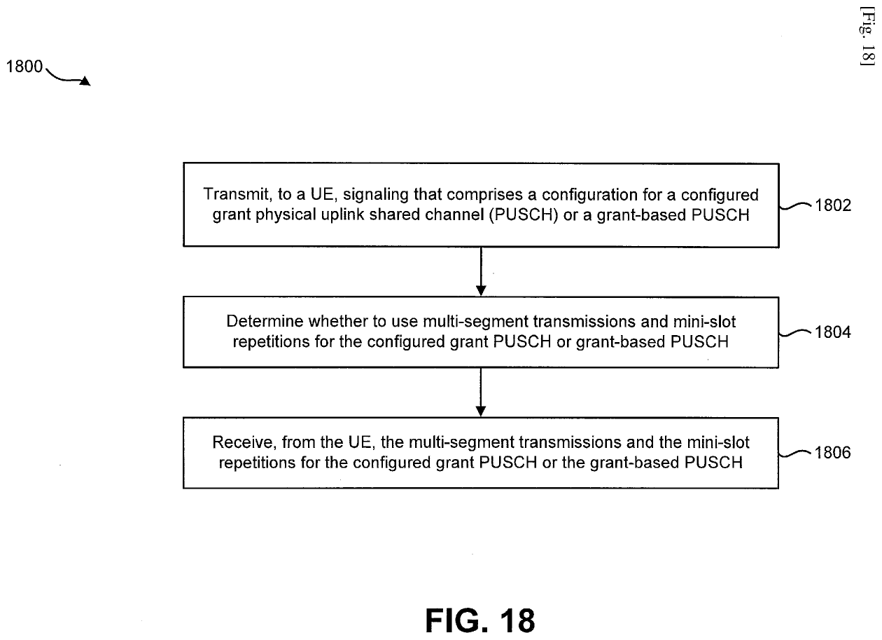

FIG. 18 is a flow diagram illustrating a method 1800 by a base station (gNB) 160. The gNB 160 may transmit 1802, to a user equipment (UE) 102, signaling that comprises a configuration for a configured grant physical uplink shared channel (PUSCH) or a grant-based PUSCH. The gNB 160 may determine 1804 determine whether to use multi-segment transmissions and mini-slot repetitions for the configured grant PUSCH or the grant-based PUSCH. The gNB 160 may receive 1806 the multi-segment transmissions and the mini-slot repetitions for the configured grant PUSCH or the grant-based PUSCH.

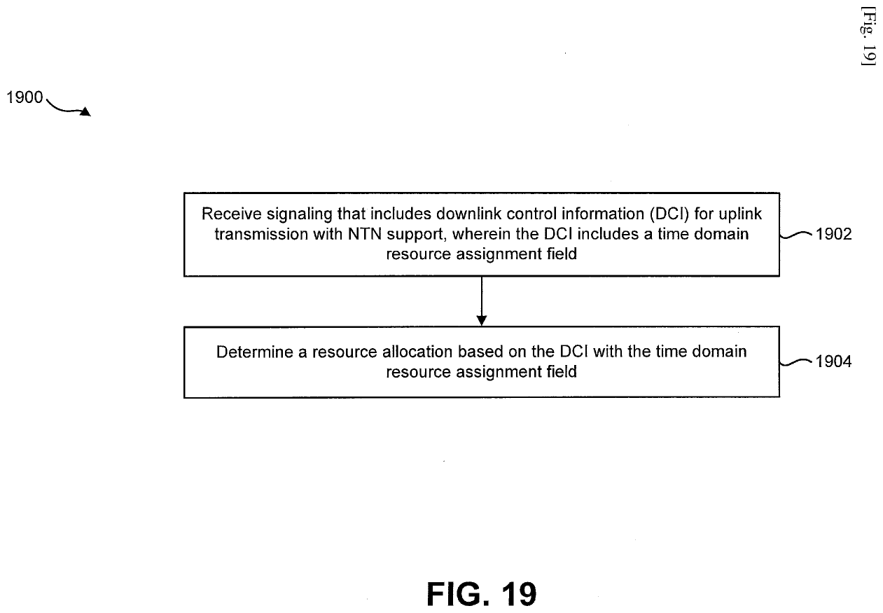

FIG. 19 is a flow diagram illustrating a method 1900 by a user equipment (UE) 102. The UE 102 may receive 1902 downlink control information (DCI) for uplink transmission with reduced capability. The DCI may include a time domain resource assignment field. The UE 102 may determine 1904 a resource allocation based on the DCI with the time domain resource assignment field.

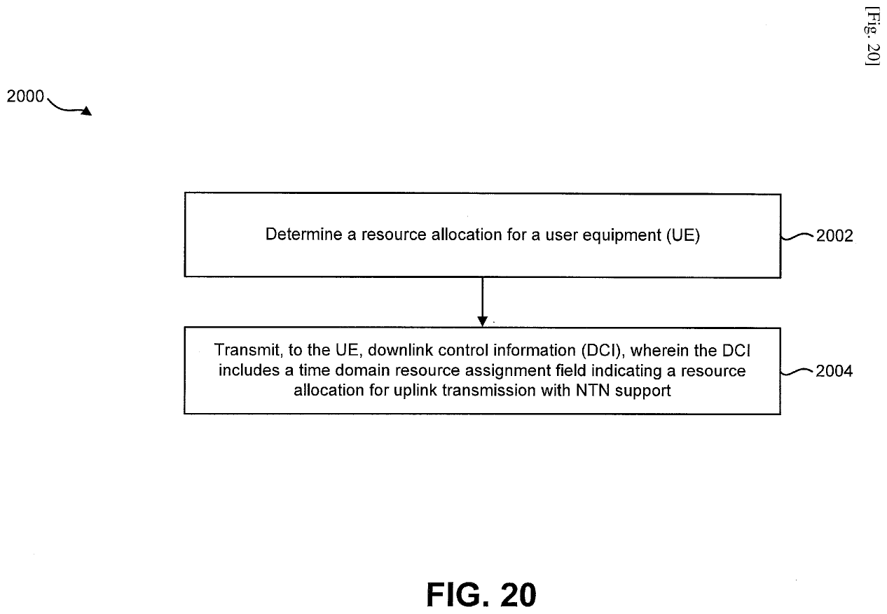

FIG. 20 is a flow diagram illustrating a method 2000 by a base station (gNB) 160. The gNB 160 may determine 2002 a resource allocation for a user equipment (UE) 102. The gNB 160 may transmit 2004, to the UE 102, downlink control information (DCI). The DCI may include a time domain resource assignment field indicating a resource allocation for uplink transmission with reduced capability.

FIG. 21 is a block diagram illustrating an example of a non-terrestrial network (NTN) 2100 with a single satellite (or UAS platform) 2160. One or several sat-gateways 2105 may connect the Non-Terrestrial Network 2100 to a public data network 2107. For example, a GEO satellite 2160 may be fed by one or several sat-gateways 2105, which are deployed across the satellite targeted coverage (e.g., regional or even continental coverage). It may be assumed that a UE 2102 in a cell may be served by only one sat-gateway 2105. A Non-GEO satellite (or UAS platform) 2160 may be served successively by one or several sat-gateways 2105 at a time. The system ensures service and continuity of a feeder link 2103 between the successive serving sat-gateways 2105 with sufficient time duration to proceed with mobility anchoring and hand-over.

The NTN 2100 may include a feeder link 2103 (e.g., a radio link) between a sat-gateway 2105 and the satellite (or UAS platform) 2160. The NTN 2100 may also include a service link 2101 (e.g., a radio link) between a user equipment 2102 and the satellite (or UAS platform) 2160. Additionally, the satellite (or UAS platform) 2160 may generate several beams over a given service area bounded by its field of view 2111. The footprints 2109 of the beams are typically of elliptic shape. The field of view 2111 of a satellite (or UAS platform) 2160 depends on the onboard antenna diagram and min elevation angle. For a transparent payload, radio frequency filtering, frequency conversion and amplification may be applied. Hence, the waveform signal repeated by the payload is un-changed.

FIG. 22 is a block diagram illustrating an example of a non-terrestrial network (NTN) 2200 with a constellation of satellites (or UAS platforms) 2260a-b. One or several sat-gateways 2205 may connect the Non-Terrestrial Network 2200 to a public data network 2207. For example, a first satellite (or UAS platform) 2260a may be fed by a first feeder link 2203a. A second satellite (or UAS platform) 2260b may be fed by a second feeder link 2203b.

Inter-satellite links (ISL) 2213 may provide a communication link between the constellation of satellites (or UAS platforms) 2260a-b. The ISL 2213 may use regenerative payloads onboard the satellites. ISL 2213 may operate in RF frequency or optical bands.

The NTN 2200 may also include a service link 2201 (e.g., a radio link) between a user equipment 2202 and a satellite (or UAS platform) 2260a. Additionally, the satellite (or UAS platform) 2260a may generate several beams over a given service area bounded by its field of view 2211. The footprints 2209 of the beams are typically of elliptic shape. For a regenerative payload, radio frequency filtering, frequency conversion and amplification as well as demodulation/decoding, switch and/or routing, coding/modulation may be applied.

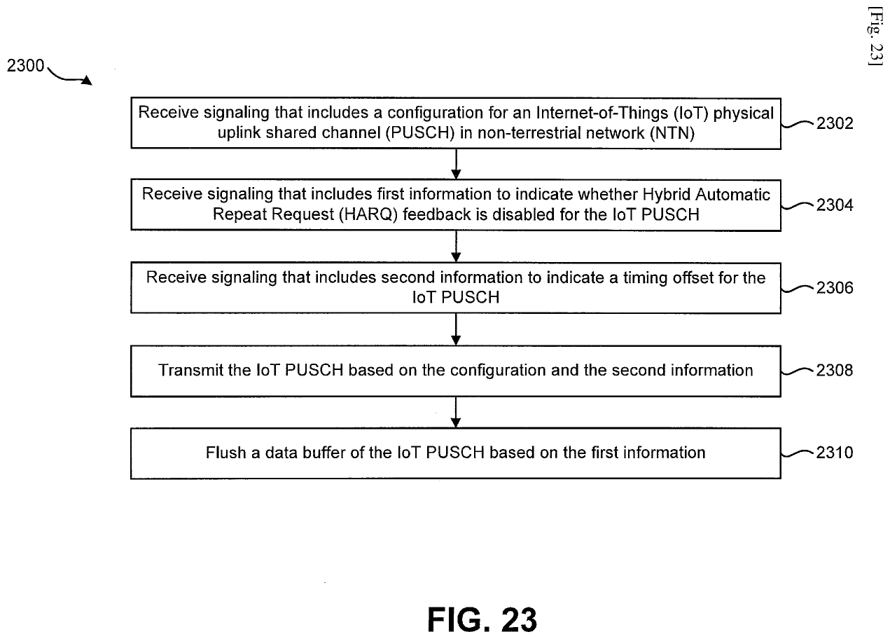

FIG. 23 is a flow diagram illustrating a method 2300 for uplink of narrow-band Internet-of-Things (IoT) over NTNs. A UE may receive 2302 signaling that includes a configuration for an Internet-of-Things (IoT) physical uplink shared channel (PUSCH) in a non-terrestrial network (NTN). The UE may receive 2304 signaling that includes first information to indicate whether Hybrid Automatic Repeat Request (HARQ) feedback is disabled for the IoT PUSCH. The UE may receive 2306 signaling that includes second information to indicate a timing offset for the IoT PUSCH. The UE may transmit 2308 the IoT PUSCH based on the configuration and the second information. The UE may flush 2310 a data buffer of the IoT PUSCH based on the first information.

In some examples, the UE may receive a Physical Downlink Control Channel (PDCCH) carrying a downlink control information (DCI) with Cyclic Redundancy Check (CRC) scrambled by a Radio Network Temporary Identifier (RNTI) which is different from a Cell-RNTI (C-RNTI), a Configured Scheduling-RNTI (CS-RNTI) and a Semi-Persistent Scheduling C-RNTI (SPS-C-RNTI). The term different means not the same as.

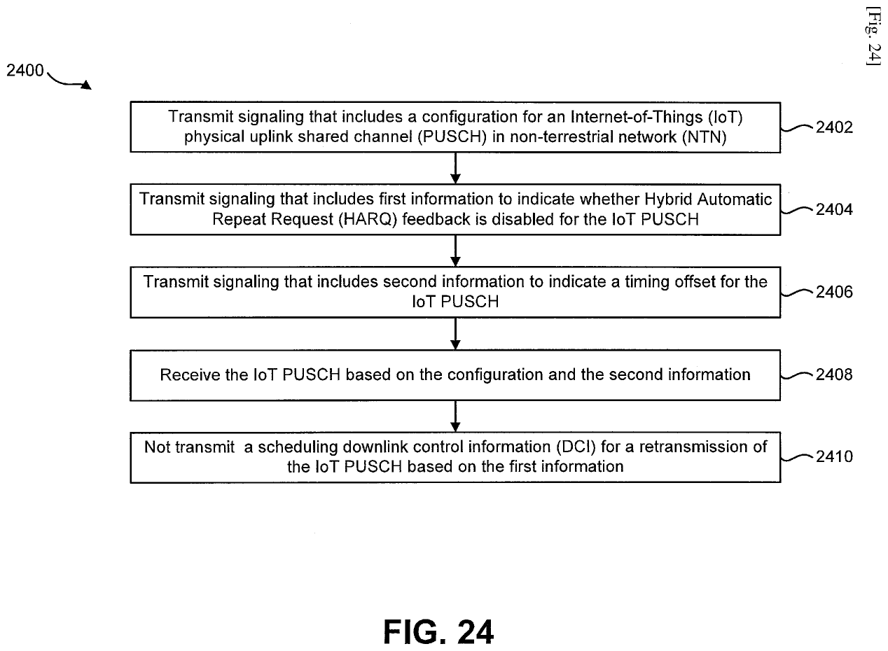

FIG. 24 is a flow diagram illustrating a method 2400 for uplink of narrow-band IoT over NTNs. A gNB may transmit 2402 signaling that includes a configuration for an IoT physical uplink shared channel (PUSCH) in a non-terrestrial network (NTN). The gNB may transmit 2304 signaling that includes first information to indicate whether Hybrid Automatic Repeat Request (HARQ) feedback is disabled for the IoT PUSCH. The gNB may transmit 2306 signaling that includes second information to indicate a timing offset for the IoT PUSCH. The gNB may receive 2308 the IoT PUSCH based on the configuration and the second information. The gNB may not transmit a scheduling downlink control information (DCI) for a retransmission of the IoT PUSCH based on the first information.

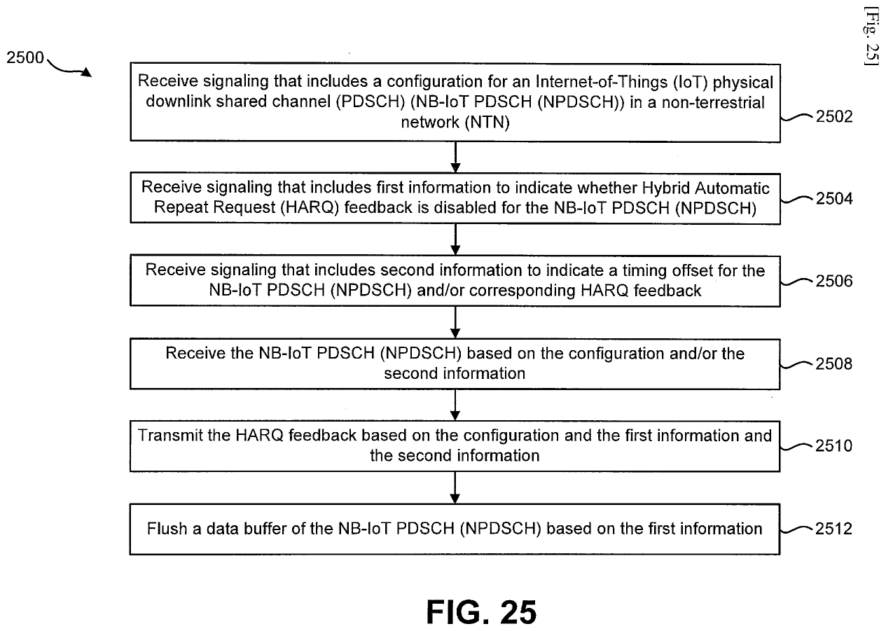

FIG. 25 is a flow diagram illustrating a method 2500 for downlink of narrow-band Internet-of-Things (IoT) over NTNs. The method includes receiving 2502 signaling that includes a configuration for an IoT PDSCH in a NTN. The method also includes receiving 2504 signaling that includes first information to indicate whether HARQ feedback is disabled for the IoT PDSCH. The method further includes receiving 2506 signaling that includes second information to indicate a timing offset for the IoT PDSCH and/or corresponding HARQ feedback. The method additionally includes receiving 2508 the IoT PDSCH based on the configuration and/or the second information. The method may further include transmitting 2510 the HARQ feedback based on the configuration and the first information and the second information. The method also includes flushing 2512 a data buffer of the IoT PDSCH based on the first information.

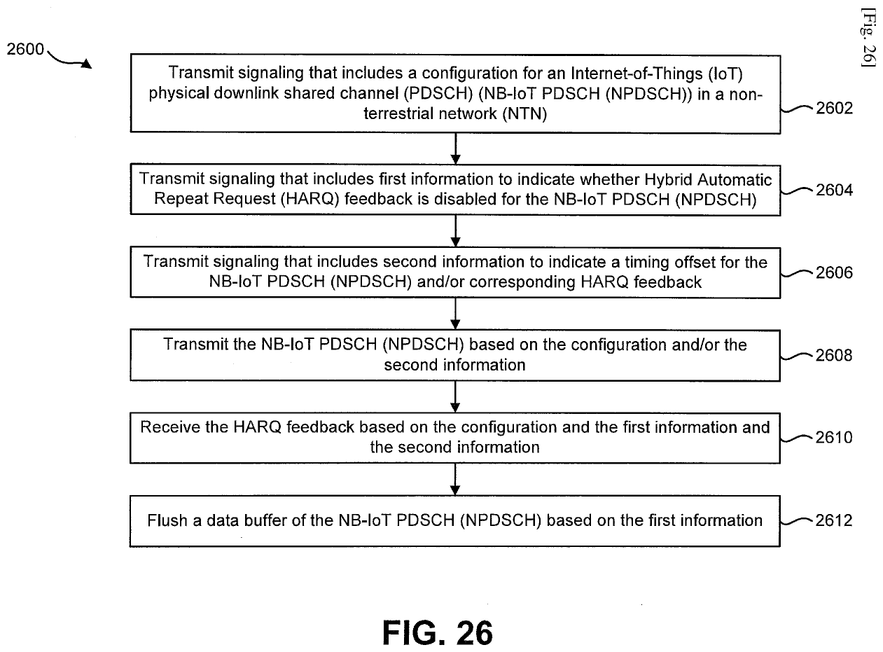

FIG. 26 is a flow diagram illustrating a method 2600 for downlink of narrow-band Internet-of-Things (IoT) over NTNs. The method includes transmitting 2602 signaling that includes a configuration for an IoT PDSCH in an NTN. The method also includes transmitting 2604 signaling that includes first information to indicate whether HARQ feedback is disabled for the IoT PDSCH. The method further includes transmitting 2606 signaling that includes second information to indicate a timing offset for the IoT PDSCH and/or corresponding HARQ feedback. The method additionally includes transmitting 2608 the IoT PDSCH based on the configuration/or and the second information. The method may also receive 2610 the HARQ feedback based on the configuration and the first information and the second information. The method may further include flushing 2612 a data buffer of the IoT PDSCH based on the first information.
The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers.
   It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

### CROSS REFERENCE

This Nonprovisional application claims priority under 35 U.S.C. § 119 on provisional Application No. 63/217,237 on Jun. 30, 2021, the entire contents of which are hereby incorporated by reference.

What is claimed is:

1. A user equipment (UE), comprising:
receiving circuitry configured to receive signaling that comprises a configuration for an Internet-of-Things (IoT) physical uplink shared channel (PUSCH) (NB-IoT PUSCH (NPUSCH)) in a non-terrestrial network (NTN);
the receiving circuitry configured to receive signaling that comprises first information to indicate whether Hybrid Automatic Repeat Request (HARQ) feedback is disabled for the NB-IoT PUSCH (NPUSCH);
the receiving circuitry configured to receive signaling that comprises second information to indicate a timing offset for the NB-IoT PUSCH (NPUSCH);
transmitting circuitry configured to transmit the NB-IoT PUSCH (NPUSCH) based on the configuration and the second information; and
a processor configured to flush a data buffer of the NB-IoT PUSCH (NPUSCH) based on the first information.

2. The UE of claim 1, wherein the receiving circuitry is configured to receive a Physical Downlink Control Channel (PDCCH) carrying a downlink control information (DCI) with Cyclic Redundancy Check (CRC) scrambled by a Radio Network Temporary Identifier (RNTI) which is different from a Cell-RNTI (C-RNTI), a Configured Scheduling-RNTI (CS-RNTI), a Semi-Persistent Scheduling C-RNTI (SPS-C-RNTI), a System Information RNTI (SI-RNTI), a Preconfigured Uplink Resource RNTI (PUR-RNTI), a GERAN RNTI (G-RNTI), a Single Cell RNTI (SC-RNTI), a Paging RNTI (P-RNTI) and a Random Access RNTI (RA-RNTI).

3. A base station (gNB), comprising:
transmitting circuitry configured to transmit signaling that comprises a configuration for an Internet-of-Things (IoT) physical uplink shared channel (PUSCH) (NB-IoT PUSCH (NPUSCH)) in a non-terrestrial network (NTN);
the transmitting circuitry configured to transmit signaling that comprises first information to indicate whether Hybrid Automatic Repeat Request (HARQ) feedback is disabled for the NB-IoT PUSCH (NPUSCH);
the transmitting circuitry configured to transmit signaling that comprises second information to indicate a timing offset for the NB-IoT PUSCH (NPUSCH);
receiving circuitry configured to receive the NB-IoT PUSCH (NPUSCH) based on the configuration and the second information; and
the transmitting circuitry configured not to transmit a scheduling downlink control information (DCI) for a retransmission of the NB-IoT PUSCH (NPUSCH) based on the first information.

4. The gNB of claim 3, wherein the transmitting circuitry is configured to transmit a Physical Downlink Control Channel (PDCCH) carrying a downlink control information (DCI) with Cyclic Redundancy Check (CRC) scrambled by a Radio Network Temporary Identifier (RNTI) which is different from a Cell-RNTI (C-RNTI), a Configured Scheduling-RNTI (CS-RNTI), a Semi-Persistent Scheduling C-RNTI (SPS-C-RNTI), a System Information RNTI (SI-RNTI), a Preconfigured Uplink Resource RNTI (PUR-RNTI), a GERAN RNTI (G-RNTI), a Single Cell RNTI (SC-RNTI), a Paging RNTI (P-RNTI) and a Random Access RNTI (RA-RNTI).

5. A method by a user equipment (UE), comprising:
receiving signaling that comprises a configuration for an Internet-of-Things (IoT) physical uplink shared channel (PUSCH) (NB-IoT PUSCH (NPUSCH)) in a non-terrestrial network (NTN);
receiving signaling that comprises first information to indicate whether Hybrid Automatic Repeat Request (HARQ) feedback is disabled for the NB-IoT PUSCH (NPUSCH);
receiving signaling that comprises second information to indicate a timing offset for the NB-IoT PUSCH (NPUSCH);
transmitting the NB-IoT PUSCH (NPUSCH) based on the configuration and the second information; and
flushing a data buffer of the NB-IoT PUSCH (NPUSCH) based on the first information.
